(19) United States
(12) Patent Application Publication
(10) Pub. No.: US 2003/0180672 A1
(43) Pub. Date: Sep. 25, 2003

(54) Solid dispersion, method of storing the same and photothermographic material

(76) Inventors: Satoru Toda, Kanagawa (JP); Minoru Sakai, Kanagawa (JP)

Correspondence Address: Sheldon Moss, c/o Yumi Yerks, Apartment #412-North, 2111 Jefferson Davis Highway, Arlington, VA, 22202, US

(21) Appl. No.: 10/302,913

(22) Filed: Nov. 25, 2002

(30) Foreign Application Priority Data
Nov. 28, 2001 (JP) 2001-362755

(51) Int. Cl. G03C 1/498; G03C 1/34; G03C 1/38

(52) U.S. Cl. 430/546; 430/531; 430/607; 430/619; 430/631

(57) ABSTRACT

A solid dispersion of a compound for use in photography, the dispersion comprising a dispersoid including an organic compound and a dispersion medium, wherein the average settling velocity (v₂₅) of the dispersoid at 25° C., which velocity is represented by the following equation (1), is no more than 5.0×10⁻⁶ mm/sec:

v₂₅=2r²g(ρs₂₅−ρ₂₅)/9η₂₅ Equation (1)

wherein r represents the median diameter of the dispersoid, g represents the gravitational acceleration, ρs₂₅ represents the specific gravity of the dispersoid at 25° C., ρ₂₅ represents the specific gravity of the dispersion medium at 25° C. and η₂₅ represents the viscosity of the solid dispersion at 25° C. Also disclosed is a method of storing the solid dispersion. Moreover, a photothermographic material using the solid dispersion is disclosed.

### BACKGROUND OF THE INVENTION

1. Field of the Invention

The present invention relates to a solid dispersion, a method of storing the solid dispersion and a photothermographic material (hereinafter sometimes referred to as “photosensitive material”), and, particularly, to a solid dispersion of a compound for use in photography which dispersion is highly stable over time, a method of storing the solid dispersion and a photothermographic material using the solid dispersion which material is preferably applied to medical diagnosis, industrial photography, printing and COM.

2. Description of the Related Art

In recent years, it has been desired in medical fields to decrease the amount of a processing waste solution from the viewpoint of environmental conservation and space saving. Technologies are needed concerning photosensitive heat developing photographic materials (photothermographic materials) used for medical diagnosis and photographic technologies which materials can expose efficiently by a laser image setter or a laser imager and form a clear black image having high resolution and vividness. These photosensitive heat developing photographic materials (photothermographic materials) make it possible to do away with the use of solvent type processing chemicals and to supply a heat developing process system, which is simpler and does not damage the environment, to customers.

There are the same needs in the field of general image forming materials. An image for medical use, in particular, must have high image qualities such as high vividness and granularity because fine depiction is required and a cold black tone is desired from the viewpoint of facilitating diagnosis. A variety of hard copy systems, such as ink jet printers and electrophotographs, utilizing pigments and dyes are currently wipe-spread as general image forming systems. However, there is no system, which is satisfactory as the output system of an image for medical use.

In response to the above-described needs, thermal image forming systems making use of an organic silver salt are described in, for example, U.S. Pat. No. 3,152,904, U.S. Pat. No. 3,457,075 and B. Shely “Thermally Processed Silver Systems” (Imaging Processes and Materials) Neblette, Eighth edition, edited by Sturge, V. Walworth and A. Shepp, page 2, 1996. Particularly, the photothermographic materials are generally provided with a photosensitive layer in which a catalytically active amount of a photocatalyst (e.g., a silver halide), a reducing agent, a reducible silver salt (e.g., an organic silver salt) and if necessary, a tinting agent for controlling the color tone of silver are dispersed in a binder matrix. The photothermographic material forms a black silver image based on a redox reaction between a silver halide or a reducible silver salt (which functions as an oxidant) and a reducing agent by heating it at high temperatures (e.g., 80° C. or more) after image exposure. The redox reaction is promoted by the catalytic action of a latent image of a silver halide generated by exposure. Therefore, the black silver image is formed in the exposed region.

The foregoing technologies are disclosed in many documents including U.S. Pat. No. 2,910,377 and Japanese Patent Application Publication (JP-B) No. 43-4924. Moreover, Fuji Medical Dry Imager FM-DP L is being sold as a system for forming an image for medical use by using a photothermographic material.

Meanwhile, as methods of introducing the additives, such as reducing agents, tinting agents or antifoggants, required for the photothermographic material, there are various methods in which these additives are introduced in the form of an aqueous solution, emulsion, solid dispersion or the like. In all of these cases, these forms must be kept in a physically stable state when they are stored.

However, in the case where these additives are made into an emulsion or a solid dispersion, there is a problem that a change in particle size and the generation of a precipitate are occasionally caused by aggregation and aging over time during storing. The solid dispersion may be subjected to filtration to remove these aggregates, products changed in particle size or precipitates. However, there is the case where the filterability may be impaired, giving rise to a problem wherein filter clogging may occur during the production of the photothermographic material and the production aptitude is thereby impaired. Also, when such a solid dispersion is used without carrying out filtration in advance, the coating surface condition of the photothermographic material is impaired, causing the problem of irregularities concerning dispersions in photographic sensitivity and density. It is therefore necessary to impart sufficient physical stability with regard to the stability of the solid dispersion with time.

### SUMMARY OF THE INVENTION

It is an object of the present invention to solve the above conventional problem and to achieve the following objects. Specifically, the invention has the object of providing a solid dispersion of a compound for use in photography which dispersion has high stability over time, a method of storing the dispersion and a photothermographic material having a superb coating surface condition and high photographic sensitivity and density.

The above objects are attained by the following measures.

A first embodiment of the present invention is a solid dispersion of a compound for use in photography, the dispersion comprising: a dispersoid including an organic compound; and a dispersion medium, wherein the average settling velocity (v₂₅) of the dispersoid at 25° C., which velocity is represented by the following equation (1), is no more than 5.0×10⁻⁶ mm/sec:

v₂₅=2r²g(ρs₂₅−ρ₂₅)/9η₂₅ Equation (1)

wherein r represents the median diameter of the dispersoid, g represents the gravitational acceleration, ρs₂₅ represents the specific gravity of the dispersoid at 25° C., ρ₂₅ represents the specific gravity of the dispersion medium at 25° C. and η₂₅ represents the viscosity of the solid dispersion at 25° C.

A second embodiment of the present invention is the solid dispersion of a compound for use in photography, according to the first embodiment, wherein the specific gravity (ρs₂₅) of the dispersoid in equation (1) is at least 1.1.

A third embodiment of the present invention is the solid dispersion of a compound for use in photography, according to the first embodiment, wherein the median diameter (r) in equation (1) is no more than 1.5 μm.

A fourth embodiment of the present invention is the solid dispersion of a compound for use in photography, according to the first embodiment, wherein the specific gravity (ρ²⁵) of the dispersion medium is at least 0.8 and no more than 1.2 and the specific gravity (ρs²⁵) of the dispersoid is no less than the specific gravity (ρ²⁵) of the dispersion medium in equation (1).

A fifth embodiment of the present invention is the solid dispersion of a compound for use in photography, according to the first embodiment, wherein the viscosity η₂₅ of the solid dispersion in equation (1) is at least 0.05 Pa·s.

A sixth embodiment of the present invention is the solid dispersion of a compound for use in photography, according to the first embodiment, wherein the organic compound is a polyhalogen compound.

A seventh embodiment of the present invention is a method of storing a solid dispersion of a compound for use in photography, the method comprising: storing the solid dispersion of a compound for use in photography at ambient temperature, wherein the dispersion comprises a dispersoid including an organic compound, and a dispersion medium, and the average settling velocity (v₂₅) of the dispersoid at 25° C., which velocity is represented by the following equation (1), is no more than 5.0×10⁻⁶ mm/sec:

v₂₅=2r²g(ρs₂₅−ρ₂₅)/9η₂₅ Equation (1)

wherein r represents the median diameter of the dispersoid, g represents the gravitational acceleration, ρs²⁵ represents the specific gravity of the dispersoid at 25° C., ρ²⁵ represents the specific gravity of the dispersion medium at 25° C. and η₂₅ represents the viscosity of the solid dispersion at 25° C.

An eighth embodiment of the present invention is a solid dispersion of a compound for use in photography, the dispersion comprising: a dispersoid including an organic compound; and a dispersion medium, wherein the average settling velocity (v₁₀) of the dispersoid at 10° C., which velocity is represented by the following equation (2), is 2.5×10⁻⁶ mm/sec or less:

v₁₀=2r²g(ρs₁₀−ρ₁₀)/9η₁₀ Equation (2)

wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

A ninth embodiment of the present invention is the solid dispersion of a compound for use in photography, according to the eighth embodiment, wherein the specific gravity (ρs₁₀) of the dispersoid in equation (2) is at least 1.1.

A tenth embodiment of the present invention is the solid dispersion of a compound for use in photography, according to the eighth embodiment, wherein the median diameter (r) in equation (2) is no more than 1.5 μm.

An eleventh embodiment of the present invention is the solid dispersion of a compound for use in photography, according to the eighth embodiment, wherein the specific gravity (ρ₁₀) of the dispersion medium is at least 0.8 and no more than 1.2, and the specific gravity (ρs₁₀) of the dispersoid is no less than the specific gravity (ρ₁₀) of the dispersion medium in equation (2).

A twelfth embodiment of the present invention is the solid dispersion of a compound for use in photography, according to the eighth embodiment, wherein the viscosity η₁₀ of the solid dispersion in equation (2) is at least 0.1 Pa·s.

A thirteenth embodiment of the present invention is the solid dispersion of a compound for use in photography, according to the eighth embodiment, wherein the organic compound is a polyhalogen compound.

A fourteenth embodiment of the present invention is a method of storing a solid dispersion of a compound for use in photography, the method comprising: storing the solid dispersion of a compound for use in photography under a refrigerated condition, wherein the dispersion comprises a dispersoid including an organic compound and a dispersion medium, and the average settling velocity (v₁₀) of the dispersoid at 10° C., which velocity is represented by the following equation (2), is no more than 2.5×10⁻⁶ mm/sec:

v₁₀=2r²g(ρs₁₀−ρ₁₀)/9η₁₀ Equation (2)

wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

A fifteenth embodiment of the present invention is a photothermographic material comprising: a support; and at least one layer disposed on the support and containing at least a photosensitive silver halide, a nonphotosensitive organic silver salt, a reducing agent for reducing a silver ion and a binder, wherein at least one layer disposed on the support is formed by applying and drying a coating solution containing at least one solid dispersion of a compound for use in photography containing a dispersoid, which includes an organic compound, and a dispersion medium, and the average settling velocity (v₂₅) of the dispersoid at 25° C., which velocity is represented by the following equation (1), is no more than 5.0×10⁻⁶ mm/sec:

v₂₅=2r²g(ρs₂₅−ρ₂₅)/9η₂₅ Equation (1)

wherein r represents the median diameter of the dispersoid, g represents the gravitational acceleration, ρs²⁵ represents the specific gravity of the dispersoid at 25° C., ρ²⁵ represents the specific gravity of the dispersion medium at 25° C. and η₂₅ represents the viscosity of the solid dispersion at 25° C.

A sixteenth embodiment of the present invention is the photothermographic material, according to the fifteenth embodiment, wherein the specific gravity (ρs₂₅) of the dispersoid in equation (1) is at least 1.1.

A seventeenth embodiment of the present invention is the photothermographic material, according to the fifteenth embodiment, wherein the organic compound is a polyhalogen compound.

An eighteenth embodiment of the present invention is the photothermographic material, according to the fifteenth embodiment, wherein the binder is a latex and the coating solution is an aqueous type coating solution.

A ninteenth embodiment of the present invention is a photothermographic material comprising: a support, and at least one layer disposed on the support and containing at least a photosensitive silver halide, a nonphotosensitive organic silver salt, a reducing agent for reducing a silver ion and a binder, wherein at least one layer disposed on the support is formed by applying and drying a coating solution containing at least one solid dispersion of a compound for use in photography containing a dispersoid, which includes an organic compound, and a dispersion medium, and the average settling velocity (v₁₀) of the dispersoid at 10° C., which velocity is represented by the following equation (2), is no more than 2.5×10⁻⁶ mm/sec:

v₁₀=2r²g(ρs₁₀−ρ₁₀)/9η₁₀ Equation (2)

wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

A twentieth embodiment of the present invention is the photothermographic material, according to the ninteenth embodiment, wherein the specific gravity (ρs₁₀) of the dispersoid in equation (2) is at least 1.1.

A twenty-first embodiment of the present invention is a photothermographic material, according to the ninteenth embodiment, wherein the organic compound is a polyhalogen compound.

A twenty-second embodiment of the present invention is the photothermographic material, according to the ninteenth embodiment, wherein the binder is a latex and the coating solution is a water-type coating solution.

### DESCRIPTION OF THE PREFERRED EMBODIMENTS

The present invention will be explained in detail hereinbelow.

<Solid Dispersion and Method of Storing the Solid Dispersion>

A solid dispersion according to the invention is a solid dispersion of a compound for use in photography (hereinafter sometimes referred to simply as “solid dispersion”), the dispersion comprising: a dispersoid including an organic compound; and a dispersion medium, wherein the average settling velocity (v₂₅) of the dispersoid at 25° C., which velocity is represented by the following equation (1), is no more than 5.0×10⁻⁶ mm/sec:

v₂₅=2r²g(ρs₂₅−ρ₂₅)/9η₂₅ Equation (1)

wherein r represents the median diameter of the dispersoid, g represents the gravitational acceleration, ρs²⁵ represents the specific gravity of the dispersoid at 25° C., ρ²⁵ represents the specific gravity of the dispersion medium at 25° C. and η₂₅ represents the viscosity of the solid dispersion at 25° C.

The average settling velocity (v₂₅) of the dispersoid contained in the solid dispersion of the invention at 25° C., which velocity is represented by the above equation (1), is no more than 5.0×10⁻⁶ mm/sec and preferably no more than 3.0×10⁻⁶ mm/sec.

It is to be noted that a solid dispersion according to the invention, wherein the average settling velocity (v₂₅) of the dispersoid contained in the solid dispersion which velocity is represented by the above equation (1) is no more than 5.0×10⁻⁶ mm/sec is preferably stored at ambient temperature. In this specification, the storing at ambient temperature means that the dispersion is allowed to stand under an undefined temperature condition. However, the dispersion is more preferably stored at a temperature ranging from 15 to 35° C.

Also, the solid dispersion according to the invention is a solid dispersion of a compound for use in photography, the dispersion comprising a dispersoid including an organic compound and a dispersion medium, wherein the average settling velocity (v₁₀) of the dispersoid at 10° C., which velocity is represented by the following equation (2), is no more than 2.5×10⁻⁶ mm/sec:

v₁₀=2r²g(ρs₁₀−ρ₁₀)/9η₁₀ Equation (2)

wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the dispersion at 10° C.

The average settling velocity (v₁₀) of the solid dispersion of the invention at 10° C., which velocity is represented by the above equation (2), is no more than 2.5×10⁻⁶ mm/sec and preferably no more than 1.0×10⁻⁶ mm/sec.

It is to be noted that a solid dispersion according to the invention, wherein the average settling velocity (v₁₀) of the dispersoid contained in the solid dispersion which velocity is represented by the above equation (2) is no more than 2.5×10⁻⁶ mm/sec is preferably stored under a refrigerated condition. In this specification, the storing under a refrigerated condition means that the dispersion is stored at no more than 15° C. and more preferably at a temperature range from 4 to 10° C.

When the average settling velocity (v₂₅) of the dispersoid contained in the solid dispersion of the invention is 5.0×10⁻⁶ mm/sec or more and/or the average settling velocity (v₁₀) of the dispersoid is 2.5×10⁻⁶ mm/sec or more, there is the case where problems arise concerning the stability of the solid dispersion with time, particularly precipitation characteristics. Specifically, there are cases where the concentration at the upper potion of a storing container is lowered and a precipitate is generated on the bottom of the storing container after a certain period of time.

The details of the median diameter (r) of the dispersoid, the specific gravity (ρs) of the dispersoid, the specific gravity (ρ) of the dispersion medium and the viscosity (η) of the solid dispersion or the solid dispersion of the invention will be explained hereinbelow.

-Median Diameter (r)-

The median diameter (r) may be measured by various methods (for example, measurement of grain distribution by light scattering (e.g., LA-920, manufactured by Horiba, Ltd.), measurement of grain distribution by ultrasonic wave or electromagnetic wave (e.g., Ultrasonic-type Grain Distribution Measuring Device DT-1200, manufactured by Nihon Rufuto Co., Ltd. and Microtrack UPA manufactured by Nikkiso Co., Ltd.), grain distribution measuring method utilizing centrifugal force (e.g., Disk Centrifuge-type Grain Distribution Measuring Device CPS, manufactured by Nihon Rufuto Co., Ltd.), measurement of grain distribution by utilizing electric resistance (Resistance type Grain Distribution Measuring Device, manufactured by Sysmex Corporation), measurement of grain distribution utilizing a particle image (Particle Image Analyzer, manufacture by Central Scientific Commerce, Inc.) and measurement of grain distribution utilizing turbidity (Tubidity/Particle Diameter Measuring Device, manufactured by Shimadzu Corporation)). As the median diameter (r) in the invention, a median diameter measured by a Light Scattering Type Grain Distribution Measuring Device SALD-2000 manufactured by Shimadzu Corporation (Parameter of refractive index is designed to be 1.70 to 0.1i) is used.

As to the range of the median diameter of the dispersoid in the invention, the median diameter is preferably no more than 1.5 μm, more preferably 0.05 μm or more and 1.0 μm or less and still more preferably 0.1 μm or more and 0.7 μm or less.

-Specific Gravity (ρs) of the Dispersoid and Specific Gravity (ρ) of the Dispersion Medium-

The specific gravity (ρs) of the dispersoid is represented by the following equation (3) and calculated by the value calculated from the specific gravity (ρd) of the solid dispersion, the specific gravity (ρb) of a dispersant solution and the composition of the solid dispersion. It is to be noted that, in the invention, ρs²⁵ and ρ²⁵ are used when calculating v₂₅ in the above equation (1) and ρs¹⁰ and ρ₁₀ are used when calculating v₁₀ in the above equation (2). Here, ρs²⁵ and ρs¹⁰ are the specific gravities of the dispersoid at 25° C. and 10° C. respectively and ρ²⁵ and ρ₁₀ are the specific gravities of the dispersion medium at 25° C. and 10° C. respectively.

ρs=Cs/(1/ρd−(1−Cs−Cb)/ρ−Cb/ρb) Equation (3)

where Cs is the concentration of the dispersoid (weight percentage), Cb is the concentration of the dispersant (weight percentage), ρd is the specific gravity of the solid dispersion and ρb is the specific gravity of the dispersant solution.

In the above equation (3), ρb is represented by the following equation (4) and calculated using the value calculated from the specific gravity (ρh) of the dispersant solution, the specific gravity (ρ) of the dispersion medium and the composition of the dispersant.

ρb=Cb/(1/ρh−(1−Cb)/ρ) Equation (4)

where ρh is the specific gravity of the dispersant solution and ρ is the specific gravity of the dispersion medium.

Each specific gravity of the solid dispersion, the dispersant solution and the dispersion medium may be measured by various methods (e.g., measurement using a standard gravimeter, an aerometer type measuring gravimeter and characteristic frequency type density gravimeter). In the invention, the specific gravity measured by a standard gravimeter (manufactured by Nihon Keiki Co., Ltd.) is used.

In the invention, the specific gravity (ρs) of the dispersoid is preferably 1.1 or more, more preferably 1.1 or more and 4.0 or less and still more preferably 1.5 or more and 3.0 or less. Namely, in any of the cases of 25° C. and 10° C., the specific gravity (ρs₂₅ and ρs₁₀) of the dispersoid preferably falls in the above range.

Also, the specific gravity (ρ) of the dispersion medium is preferably 0.8 or more and 1.2 or less, more preferably 0.9 or more and 1.1 or less and still more preferably 0.98 or more and 1.05 or less. Namely, in any of the cases of 25° C. and 10° C., the specific gravity (ρ²⁵ and ρ₁₀) of the dispersion medium preferably falls in the above range.

Moreover, it is preferable that ρs≧ρ.

-Viscosity (η)-

The viscosity (η) of the solid dispersion in the invention may be measured by various methods (e.g., a B-type viscometer, E-type viscometer and oscillation type viscometer). In the invention, as the viscosity (η), the viscosity measured by a B-type viscometer (DV-M-B, manufactured by TOKIMEC Inc.) is used. It is to be noted that, in the invention, η₂₅ is used when calculating v₂₅ in the above equation (1) and η₁₀ is used when calculating v₁₀ in the above equation (2). η₂₅ and η₁₀are viscosities at 25° C. and 10° C. respectively.

η₂₅ of the solid dispersion of the invention is preferably 0.05 Pa·s or more, more preferably 0.08 Pa·s or more and 0.5 Pa·s or less and still more preferably 0.09 Pa·s or more and 0.30 cPa·s or less.

Also, η₁₀ is preferably 0.1 Pa·s or more, more preferably 0.14 Pa·s or more and 0.5 Pa·s or less and still more preferably 0.16 Pa·s or more and 0.30 cPa·s or less.

If bubbles are present in the solid dispersion when measuring the specific gravity and viscosity of the solid dispersion, exact values of the specific gravity and viscosity are not obtained. Therefore, the bubbles in the solid dispersion must be therefore removed. Examples of a method of removing the bubbles include various methods such as ultrasonic defoaming, vacuum defoaming, vacuum ultrasonic defoaming, centrifugal defoaming and a defoaming method utilizing a reduction in viscosity due to a rise in temperature. In the invention, it is preferable to remove the bubbles by a vacuum ultrasonic defoaming method.

The median diameter (r) and the specific gravity (ρs) and viscosity (η) of the dispersoid of the solid dispersion of the invention are arbitrarily set by changing dispersion condition, dispersion time, the concentration of the dispersant and the concentration of the dispersion in the production of the solid dispersion as will be explained later.

As the dispersoid, which is contained in the solid dispersion of the invention, includes an organic compound and has a specific gravity of 1.1 or more, various organic compounds are exemplified. Preferable examples of the dispersoid include reducing agents, developing promoters, hydrogen-bonding compounds, antifoggants, polyhalogen compounds, tinting agents and other photographic compounds. Among these materials, reducing agents, developing promoters, hydrogen-bonding compounds and polyhalogen compounds are preferable for the solid dispersion of the invention and polyhalogen compounds are most preferable. Also, the dispersoid in the invention is preferably a compound which is sparingly soluble in the dispersion medium.

Examples of the dispersion medium contained in the solid dispersion of the invention include water or organic solvents (e.g., methanol, ethanol, isopropyl alcohol, methyl cellosolve, ethyl cellosolve, dimethylformamide and ethyl acetate) or mixtures of these solvents. The dispersion medium in the invention is preferably water containing 30 mass % or less of an organic solvent or water containing no organic solvent, more preferably water containing 10 mass % or less of an organic solvent and most preferably water containing 1 mass % or less of an organic solvent or water containing no organic solvent.

The solid dispersion of the invention may be produced using, for example, a media type dispersing machine which crushes using media, high-speed stirring type dispersing machine having large shearing force or a dispersing machine giving highly intensive ultrasonic energy. For example, a ball mill, colloid mill, sand mill, homogenizer, capillary type emulsifier, liquid siren, electromagnetic strain type ultrasonic generator and emulsifier having a Poleman whistle may be used. Media dispersion using a media type dispersing machine among these apparatuses is preferable and water-type media dispersion is more preferable.

Examples of a method for media dispersion include methods in which a powder of the dispersoid or an organic compound wetted with water or an organic solvent which is called a wet cake is made into an aqueous slurry, which is then mechanically crushed and dispersed by using a known crusher, for example, a ball mill, colloid mill, oscillation ball mill, vertical sand mill, roller mill, pin mill, coball mill, caddy mill, vertical sand mill, horizontal sand mill or attritor in the presence of a dispersion media (e.g., a steal ball, ceramic ball, glass beads, alumina beads, zirconia silicate beads, zirconia beads and Ottawa sand). Among these crushers, a ball mill, colloid mill, vertical sand mill or horizontal sand mill is preferably used and a vertical sand mill or horizontal sane mill is more preferable.

Although there are various types as the vertical sand mill, Ultravisco Mill (UVM; manufactured by I.mecs), Agitator Mill LMK (manufactured by Ajisawa K. K.) and Dynomill (manufactured by Shinmaru Enterprise K. K.) are exemplified. Among these mills, Ultravisco Mill (UVM; manufactured by I.mecs K. K.) is preferable.

As the dispersion media (beads), glass beads, alumina beads, zirconia silicate beads and zirconia beads are preferable and zirconia silicate beads and zirconia beads are more preferable. As to the size of the dispersion media, there are media having various sizes. The average diameter is preferably 0.3 mm to 5 mm, more preferably 0.3 mm to 3 mm and still more preferably 0.3 mm to 2 mm. Media having an average diameter of 0.3 mm, 0.5 mm, 1.0 mm or 2.0 mm are most preferably used.

These dispersion media may be used either independently or by mixing these media. When these media are used by mixing them, the mixing ratio may be arbitrarily set.

In a usual method, the dispersant (protective colloid) is fed in the form of a slurry. It is preferable to make the dispersoid (e.g., a powder of a photographically useful organic compound or a wet-cake like organic compound) and the dispersion medium into a slurry (predispersion) prior to a dispersing operation. As measures for forming a slurry, known measures (e.g., mixing using a propeller blade, a high-speed mixer, homogenizer, high-speed impact mill, Banbury mixer, homomixer, kneader, ball mill, oscillation ball mill, universal ball mill, attritor, sand mill, beads mill, colloid mill, jet mill, roller mill, thoron mill and high-speed stone mill) may be used. Besides the mechanical dispersion, the dispersant may also be micronized by changing the pH in the presence of a dispersing adjuvant. At this time, an organic solvent may be used as the solvent used for rough dispersion and the organic solvent is usually removed after the micronization is finished.

In the invention, a method in which the dispersoid is added gradually to a dispersion medium solution and these components are mixed by a propeller blade.

A surfactant may be used for the media dispersion. As the surfactant, any of nonionic or ionic (anion, cation and betaine) surfactants may be used.

Examples of the nonionic surfactant may include surfactants using polyoxyethylene, polyoxypropylene, polyoxybutylene, polyglycidyl or sorbitan as a nonionic hydrophilic group. Specific examples may include polyoxyethylene alkyl ether, polyoxyethylene alkylphenyl ether, polyoxyethylene-polyoxypropylene glycol, polyhydric alcohol fatty acid partial ester, polyoxyethylene polyhydric alcohol fatty acid partial ester, polyoxyethylene fatty acid ester, polyglycerol fatty acid ester, fatty acid diethanol amide and triethanolamine fatty acid partial ester.

Examples of the anionic surfactant may include carboxylates, sulfates, sulfonates and phosphates. Specific examples of the anionic surfactant may include fatty acid salts, alkylbenzene sulfonates, alkylnaphthalene sulfonates, alkyl sulfonates, α-olefin sulfonates, dialkyl sulfosuccinate, α-sulfonated fatty acid salts, N-methyl-N-oleyltaurine, petroleum sulfonate, alkyl sulfate, sulfated oil and fats, polyoxyethylene alkyl ether sulfate, polyoxyethylene alkyl phenyl ether sulfate, polyoxyethylene styrenated phenyl ether sulfate, alkyl phosphate, polyoxyethylene alkyl ether phosphate and naphthalene sulfonate formaldehyde condensate.

Examples of the cationic surfactant may include amine salts, quaternary ammonium salts and pyridinium salts. Among these salts, primary to tertiary fatty amine salts, quaternary ammonium salts (e.g., tetraalkylammonium salts, trialkylbenzylammonium salts, alkylpyridinium salts and alkylimidazolium salts) are preferable.

Examples of the betaine type surfactant may include carboxybetaine and sulfobetaine. Among these compounds, N-trialkyl-N-carboxymethylammoniumbetaine, N-trialkyl-N-sulfoalkyleneammoniumbetaine are preferable.

These surfactants are described in “Application of Surfactant” (Saiwai Shobo, KARIGOME Takao, published on Sep. 1, 1980).

As the surfactant used in the invention, an anionic surfactant having a sulfonic acid group is particularly preferable.

Although specific examples of the surfactants will be shown below, the surfactant which may be used in the invention is not limited to these examples. (Here, —C₆H₄— represents a phenylene group).

WA-1: Sodium dodecylbenzenesulfonate

WA-2: Sodium tri(isopropyl)naphthalenesulfonate

WA-3: Sodium tri(isobutyl)naphthalenesulfonate

WA-4: Sodium dodecylsulfate

WA-5: α-sulfasuccinic acid di(2-ethylhexyl) ester sodium salt

WA-6: C₈H₁₇—C₆H₄—(CH₂CH₂O)₃(CH₂)₂SO₃K

WA-7: Cetyl trimethylammonium Chloride

WA-8: C₁₁H₂₃CONHCH₂CH₂N^{+l (CH}₃)₂—CH₂COO—

In a dispersing operation, it is desirable to disperse the dispersoid in the presence of a dispersant (protective colloid) soluble in an aqueous solvent. As the dispersant, a hydrophilic colloid may be used. For example, various synthetic hydrophilic polymer materials such as homopolymers and copolymers, e.g., poly-N-vinylpyrrolidone, polyacrylic acid, polymethacrylic acid, polyacrylamide, polyvinylimidazole, maleic acid copolymers, maleic acid monoester copolymers, acrylomethylpropanesulfonic acid copolymers, polyvinylpyrazole, polyethylene glycol and polypropylene glycol, semi-synthetic anionic polymers such as carboxymethyl starch and carboxymethyl cellulose, anionic polymers such as alginic acid and pectic acid, compounds described in Japanese Patent Application Laid-Open (JP-A) No. 7-350753, gelatin derivatives, graft polymers of a gelatin and other polymers, proteins such as albumine and casein, cellulose derivatives such as hydroxyethyl cellulose, carboxymethyl cellulose and cellulose sulfate, sodium alginate, sugar derivatives such as starch derivatives, polyvinyl alcohol, polyvinyl alcohol partial acetal and high molecular compounds, such as gelatin, present in the natural world may be appropriately selected and used.

These dispersants may be used either independently or by mixing two or more types.

As the dispersant in the invention, polyethylene glycol, polypropylene glycol, polyvinyl alcohols and water-soluble cellulose derivatives are preferably used and polyvinyl alcohols are particularly preferable.

As examples of the polyvinyl alcohols (PVA), the following compounds may be given.

Examples of completely saponified products include PVA-105 (content of polyvinyl alcohol (PVA): 94.0 mass % or more, degree of saponification: 98.5±0.5 mol %, content of sodium acetate: 1.5 mass % or less, volatile component: 5.0 mass % or less, viscosity (4 mass %, 20° C.): 5.6±0.4 Pa·s), PVA-110 (content of PVA: 94.0 mass %, degree of saponification: 98.5±0.5 mol %, content of sodium acetate: 1.5 mass %, volatile component: 5.0 mass %, viscosity (4 mass %, 20° C.): 11.0±0.8 Pa·s), PVA-117 (content of PVA: 94.0 mass %, degree of saponification: 98.5±0.5 mol %, content of sodium acetate: 1.0 mass %, volatile component: 5.0 mass %, viscosity (4 mass %, 20° C.): 28.0±3.0 Pa·s), PVA-117H (content of PVA: 93.5 mass %, degree of saponification: 99.6±0.3 mol %, content of sodium acetate: 1.85 mass %, volatile component: 5.0 mass %, viscosity (4 mass %, 20° C.): 29.0±3.0 Pa·s), PVA-120 (content of PVA: 94.0 mass %, degree of saponification: 98.5±0.5 mol %, content of sodium acetate: 1.0 mass %, volatile component: 5.0 mass %, viscosity (4 mass %, 20° C.): 39.5±4.5 Pa·s), PVA-124 (content of PVA: 94.0 mass %, degree of saponification: 98.5±0.5 mol %, content of sodium acetate: 1.0 mass %, volatile component: 5.0 mass %, viscosity (4 mass %, 20° C.): 60.0±6.0 Pa·s), PVA-124H (content of PVA: 93.5 mass %, degree of saponification: 99.6±0.3 mol %, content of sodium acetate: 1.85 mass %, volatile component: 5.0 mass %, viscosity (4 mass %, 20° C.): 61.0±6.0 Pa·s), PVA-CS (content of PVA: 94.0 mass %, degree of saponification: 97.5±0.5 mol %, content of sodium acetate: 1.0 mass %, volatile component: 5.0 mass %, viscosity (4 mass %, 20° C.): 27.5±3.0 Pa·s), PVA-CST (content of PVA: 94.0 mass %, degree of saponification: 96.0±0.5 mol %, content of sodium acetate: 1.0 mass %, volatile component: 5.0 mass %, viscosity (4 mass %, 20° C.): 27.0±3.0 Pa·s) and PVA-HC (content of PVA: 90.0 mass %, degree of saponification: 99.85 mol % or more, content of sodium acetate: 2.5 mass %, volatile component: 8.5 mass %, viscosity (4 mass %, 20° C.): 25.0±3.5 Pa·s) (the above are all trademarks of products manufactured by Kuraray Co., Ltd.).

Examples of partially saponified products include PVA-203 (content of PVA: 94.0 mass %, degree of saponification: 88.0±1.5 mol %, content of sodium acetate: 1.0 mass %, volatile component: 5.0 mass %, viscosity (4 mass %, 20° C.): 3.4±0.2 Pa·s), PVA-204 (content of PVA: 94.0 mass %, degree of saponification: 88.1±1.5 mol %, content of sodium acetate: 1.0 mass %, volatile component: 5.0 mass %, viscosity (4 mass %, 20° C.): 3.9±0.3 Pa·s), PVA-205 (content of PVA: 94.0 mass %, degree of saponification: 88.0±1.5 mol %, content of sodium acetate: 1.0 mass %, volatile component: 5.0 mass %, viscosity (4 mass %, 20° C.): 5.0±0.4 Pa·s), PVA-210 (content of PVA: 94.0 mass %, degree of saponification: 88.0±1.0 mol %, content of sodium acetate: 1.0 mass %, volatile component: 5.0 mass %, viscosity (4 mass %, 20° C.): 9.0±1.0 Pa·s), PVA-217 (content of PVA: 94.0 mass %, degree of saponification: 88.0±1.0 mol %, content of sodium acetate: 1.0 mass %, volatile component: 5.0 mass %, viscosity (4 mass %, 20° C.): 22.5±2.0 Pa·s), PVA-220 (content of PVA: 94.0 mass %, degree of saponification: 88.0±1.0 mol %, content of sodium acetate: 1.0 mass %, volatile component: 5.0 mass %, viscosity (4 mass %, 20° C.): 30.0±3.0 Pa·s), PVA-224 (content of PVA: 94.0 mass %, degree of saponification: 88.0±1.5 mol %, content of sodium acetate: 1.0 mass %, volatile component: 5.0 mass %, viscosity (4 mass %, 20° C.): 44.0±4.0 Pa·s), PVA-228 (content of PVA: 94.0 mass %, degree of saponification: 88.1±1.5 mol %, content of sodium acetate: 1.0 mass %, volatile component: 5.0 mass %, viscosity (4 mass %, 20° C.): 65.0±5.0 Pa·s), PVA-235 (content of PVA: 94.0 mass %, degree of saponification: 88.0±1.5 mol %, content of sodium acetate: 1.0 mass %, volatile component: 5.0 mass %, viscosity (4 mass %, 20° C.): 95.0±15.0 Pa·s), PVA-217EE (content of PVA: 94.0 mass %, degree of saponification: 88.0±1.0 mol %, content of sodium acetate: 1.0 mass %, volatile component: 5.0 mass %, viscosity (4 mass %, 20° C.): 23.0±3.0 Pa·s), PVA-217E (content of PVA: 94.0 mass %, degree of saponification: 88.0±1.0 mol %, content of sodium acetate: 1.0 mass %, volatile component: 5.0 mass %, viscosity (4 mass %, 20° C.): 23.0±3.0 Pa·s), PVA-220E (content of PVA: 94.0 mass %, degree of saponification: 88.0±1.0 mol %, content of sodium acetate: 1.0 mass %, volatile component: 5.0 mass %, viscosity (4 mass %, 20° C.): 31.0±4.0 Pa·s), PVA-224E (content of PVA: 94.0 mass %, degree of saponification: 88.0±1.0 mol %, content of sodium acetate: 1.0 mass %, volatile component: 5.0 mass %, viscosity (4 mass %, 20° C.): 45.0±5.0 Pa·s), PVA-403 (content of PVA: 94.0 mass %, degree of saponification: 80.0±1.5 mol %, content of sodium acetate: 1.0 mass %, volatile component: 5.0 mass %, viscosity (4 mass %, 20° C.): 3.1±0.3 Pa·s), PVA-405 (content of PVA: 94.0 mass %, degree of saponification: 81.5±1.5 mol %, content of sodium acetate: 1.0 mass %, volatile component: 5.0 mass %, viscosity (4 mass %, 20° C.): 4.8±0.4 Pa·s), PVA-420 (content of PVA: 94.0 mass %, degree of saponification: 79.5±1.5 mol %, content of sodium acetate: 1.0 mass %, volatile component: 5.0 mass %), PVA-613 (content of PVA: 94.0 mass %, degree of saponification: 93.5±1.0 mol %, content of sodium acetate: 1.0 mass %, volatile component: 5.0 mass %, viscosity (4 mass %, 20° C.): 16.5±2.0 Pa·s) and L-8 (content of PVA: 96.0 mass %, degree of saponification: 71.0±1.5 mol %, content of sodium acetate: 1.0 mass % (ash content), volatile component: 3.0 mass %, viscosity (4 mass %, 20° C.): 5.4±0.4 Pa·s) (the above are all trademarks of products manufactured by Kuraray Co., Ltd.).

It is to be noted that the above measured values were found according to JIS K-6726-1977.

As the modified polyvinyl alcohol, those described in “Poval” NAGANO Koichi, et. al., issued by Polymer Publishing Association may be used. The modification include modifications by a cation, anion, —SH compound, alkylthio compound and silanol.

Examples of the modified polyvinyl alcohol (modified PVA) include C-118, C-318, C-318-2A and C-506 (all of the above are trademarks of products manufactured by Kuraray Co., Ltd.) as C polymers, HL-12E and HL-1203 (all of the above are trademarks of products manufactured by Kuraray Co., Ltd.) as HL polymers, HM-03 and HM-N-03 (all of the above are trademarks of products manufactured by Kuraray Co., Ltd.) as HM polymers, KL-118, KL-318, KL-506, KM-118T and KM-618 (all of the above are trademarks of products manufactured by Kuraray Co., Ltd.) as K polymers, M-115 (trademark of a product manufactured by Kuraray Co., Ltd.) as M polymers, MP-102, MP-202 and MP-203 (all of the above are trademarks of products manufactured by Kuraray Co., Ltd.) as MP polymers, R-1130, R2105 and R-2130 (all of the above are trademarks of products manufactured by Kuraray Co., Ltd.) as R polymers and V-2250 (trademark of a product manufactured by Kuraray Co., Ltd.) as V polymers.

In the invention, among these modified polyvinyl alcohols, partially saponified polyvinyl alcohols, K polymers and MP polymers are preferable and MP polymers are particularly preferable.

These dispersants are preferably used in combination with the above surfactant. Examples of these combinations include:

sodium dodecylbenzenesulfonate/PVA-203;

sodium dodecylbenzenesulfonate/PVA-205;

sodium dodecylbenzenesulfonate/PVA-217;

sodium dodecylbenzenesulfonate/MP-203;

sodium dodecylbenzenesulfonate/KM-618;

sodium tri(isopropyl)naphthalenesulfonate/PVA-203;

sodium tri(isopropyl)naphthalenesulfonate/PVA-205;

sodium tri(isopropyl)naphthalenesulfonate/PVA-217;

sodium tri(isopropyl)naphthalenesulfonate/MP-203; and

sodium tri(isopropyl)naphthalenesulfonate/MP-103.

Among these compounds;

sodium dodecylbenzenesulfonate/PVA-205;

sodium tri(isopropyl)naphthalenesulfonate/PVA-217; and

sodium tri(isopropyl)naphthalenesulfonate/MP-203 are preferable.

In the method of the production of the solid dispersion of the invention, heating treatment is preferably carried out after the media dispersion as described in Japanese Patent Application No. 2000-240658.

An antifoaming agent may be added to the solid dispersion of the invention for the purpose of facilitating the handling during dispersing.

Examples of the antifoaming agent include higher alcohols, fatty acid esters, phosphates, polypropylene glycol and silicone oil emulsions. Specific examples of the antifoaming agent include Pionin (Takemoto Oil & Fat Co., Ltd.), Nissan Disfoam (Nippon Oil & Fats Co., Ltd.), NUC Silicone (Nippon Unicar Company Limited), Shin-Etsu Kagaku KM series (Shin-Etsu Chemical Co., Ltd.), Pluronic series (Pluronic) and surfynol series (Air Products and Chemicals, Inc.). Also, an organic solvent such as methanol and ethanol may be used in a small amount.

All of these compounds are easily available as commercial products.

Among these compounds, Pluronic series, Surfynol series and methanol are preferable and Surfynol 104E is more preferable.

The amount of the antifoaming agent to be added is preferably 0.1 g to 10 g, more preferably 0.5 g to 5 g and still more preferably 0.5 g to 3 g per 1 kg of the dispersion.

An antiseptic is preferably added to the solid dispersion of the organic compound according to the invention to prevent the proliferation of miscellaneous bacteria during storing.

As specific examples of the antiseptic, compounds represented by the following general formulae (I), (II), (III) and (IV) are given. First, compounds represented by the general formula (I) will be explained.

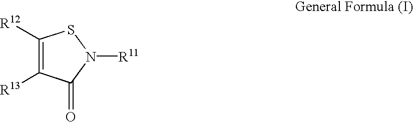

In the general formula (I), R¹² and R¹³ respectively represent a hydrogen atom, an alkyl group, an aryl group, a cyano group, a heterocyclic group, an alkylthio group, an arylthio group, an alkylsulfoxy group or an alkylsulfonyl group. R¹² and R¹³ may be combined with each other to form an aromatic ring. R¹¹ represents a hydrogen atom, a halogen atom, an alkyl group, an alkenyl group, an aralkyl group, an aryl group, a heterocyclic group or a substituent shown below.

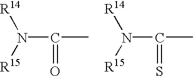

In the foregoing substituent, R¹⁴ and R¹⁵ respectively represent a hydrogen atom, an alkyl group, an aryl group or an aralkyl group.

Next, compounds represented by the general formula (II) will be explained. The general formula (II) shows an embodiment of the general formula (I) in which R¹² and R¹³ are combined with each other to form an aromatic ring.

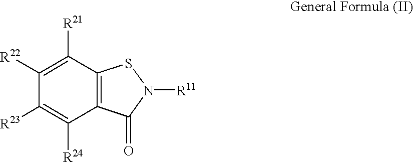

In the general formula (II), R²¹, R²², R²³ and R²⁴ respectively represent a hydrogen atom, a halogen atom or an alkyl group. R¹¹ has the same meaning as R¹¹ in the above general formula (I).

The compounds represented by the general formulae (I) and (II) may be made into sodium salts, ammonium salts or the like by combining them with salts such as NaCl and ammonium chloride. Compounds represented by the general formulae (I) and (II) will be shown below. However, the antiseptic used in the invention is not limited to these compounds.

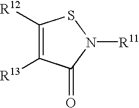

| Com- | | | | |
|---|---|---|---|---|
| pound | | | | |
| No. | R¹¹ | R¹² | R¹³ | Salt |
| I-1 | —H | —H | —H | None |
| I-2 | —H | —H | —H | Sodium Salt |
| I-3 | —H | —H | —H | Ammonium |
| | | | | Salt |
| I-4 | —H | —H | —CH₃ | None |
| I-5 | —H | —H | —CH₃ | Sodium Salt |
| I-6 | —H | —H | —CH₃ | Ammonium |
| | | | | Salt |
| I-7 | —Cl | —H | —CH₃ | None |
| I-8 | —Cl | —H | —CH₃ | Sodium Salt |
| I-9 | —H | —H | —CONHCH₃ | None |
| I-10 | —H | —H | —CONHCH₃ | Sodium Salt |
| I-11 | —SCH₃ | —H | —CH₃ | None |
| I-12 | —SCH₃ | —H | —CH₃ | Sodium Salt |
| I-13 | —SOCH₃ | —H | —C₂H₅ | None |
| I-14 | —SOCH₃ | —H | —C₂H₅ | Ammonium |
| | | | | Salt |
| I-15 | —CH₃ | —H | 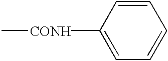 | None |
| I-16 | —CH₃ | —H | 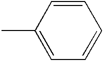 | Sodium Salt |

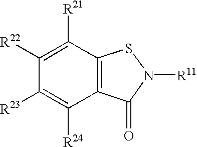

| Compound | | | | | | |
|---|---|---|---|---|---|---|
| No. | R²¹ | R²² | R²³ | R²⁴ | R¹¹ | Salt |
| II-1 | —H | —H | —H | —H | —H | None |
| II-2 | —H | —H | —H | —H | —H | Sodium Salt |
| II-3 | —H | —H | —H | —H | —H | Ammonium Salt |
| II-4 | —H | —H | —Cl | —H | —H | None |
| II-5 | —H | —H | —Cl | —H | —H | Sodium Salt |
| II-6 | —H | —H | —Cl | —H | —H | Ammonium Salt |
| II-7 | —H | —Cl | —H | —CH₃ | —H | None |
| II-8 | —H | —Cl | —H | —CH₃ | —H | Sodium Salt |
| II-9 | —H | —H | —H | —H | 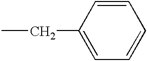 | None |
| II-10 | —H | —H | —H | —H | 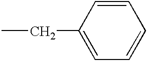 | Ammonium Salt |

Next, compounds represented by the general formula (III) will be explained.

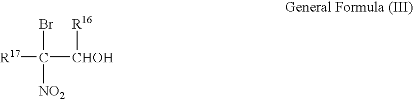

In the foregoing general formula (III), R¹⁶ represents a hydrogen atom or a lower alkyl group. R¹⁷ represents a hydrogen atom, a hydroxy group, a lower alkyl group or a hydroxymethyl group. Typical examples of the compounds represented by the general formula (III) will be shown hereinbelow. However, the antiseptic in the invention is not limited to these examples.

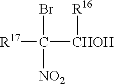

| Compound | | |
|---|---|---|
| No. | R¹⁶ | R¹⁷ |
| III-1 | —H | —OH |
| III-2 | —CH₃ | —H |
| III-3 | —CH₃ | —OH |
| III-4 | —H | 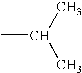 |
| III-5 | —CH₃ | —C₅H₁₁ |

Next, compounds represented by the general formula (IV) will be explained.

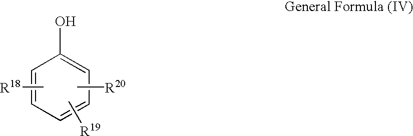

In the general formula (IV), R¹⁸, R¹⁹ and R²⁰, which may be the same or different, respectively represent a hydrogen atom, a lower alkyl group, a hydroxy group, a carbonic acid or its ester, a halogen atom, a lower acyl group, an aryl group or a sulfinyl group. Typical examples of the compounds represented by the general formula (IV) will be shown hereinbelow. However, these examples are not intended to be limiting of the invention.

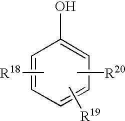

| Compound | | | |
|---|---|---|---|
| No. | R¹⁸ | R¹⁹ | R²⁰ |
| IV-1 | —H | —H | —COOCH₃ |
| IV-2 | —H | —H | 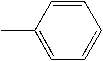 |
| IV-3 | —H | 4-C₃H₇ | —OH |
| IV-4 | —H | —H | —SOCH₃ |
| IV-5 | 3-CH₃ | 4-Cl | 5-OH |

All of the aforementioned antiseptics are available as commercial products.

Also, among the aforementioned antiseptics, a benzoisothiazolinone sodium salt is preferable.

The amount of the antiseptic to be added is preferably 0.1 mg to 5000 mg, more preferably 1 mg to 1000 mg and still more preferably 10 mg to 200 mg per 1 kg of the dispersion.

The storage or transportation of the solid dispersion of the invention since after it is produced till it is used are preferably made in a refrigerated condition or at ambient temperature. Also, the storage or the transportation may be made under either a bright room or dark room condition. <Photothermographic Material>

The photothermographic material of the invention will be explained hereinbelow.

Specifically, the photothermographic material of the invention comprises a support; and at least one layer disposed on the support and containing at least a photosensitive silver halide, a nonphotosensitive organic silver salt, a reducing agent for reducing a silver ion and a binder, wherein at least one layer disposed on the support is formed by applying and drying a coating solution containing at least one solid dispersion of a compound for use in photography containing a dispersoid, which includes an organic compound, and a dispersion medium, and the average settling velocity (v₂₅) of the dispersoid at 25° C., which velocity is represented by the following equation (1), is no more than 5.0×10⁻⁶ mm/sec:

v₂₅ =2r²g(ρs₂₅−ρ₂₅)/9η₂₅ Equation (1)

wherein r represents the median diameter of the dispersion, g represents the gravitational acceleration, ρs₂₅ represents the specific gravity of the dispersoid at 25° C., ρ₂₅ represents the specific gravity of the dispersion medium at 25° C. and η₂₅ represents the viscosity of the dispersion at 25° C.

Also, the photothermographic material of the invention comprises a support, and at least one layer disposed on the support and containing at least a photosensitive silver halide, a nonphotosensitive organic silver salt, a reducing agent for reducing a silver ion and a binder, wherein at least one layer disposed on the support is formed by applying and drying a coating solution containing at least one solid dispersion of a compound for use in photography containing a dispersoid, which includes an organic compound, and a dispersion medium, and the average settling velocity (v₁₀) of the dispersoid at 10° C., which velocity is represented by the following equation (2), is no more than 2.5×10⁻⁶ mm/sec:

v₁₀ =2r²g(ρs₁₀−ρ₁₀)/9η₁₀ Equation (2)

wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the dispersion at 10° C.

In the invention, a photothermographic material having a superb coating surface condition can be obtained by using a coating solution containing at least one of the aforementioned solid dispersions of the invention.

Examples of the organic compound to be contained as the solid dispersion in the coating solution include, though not particularly limited to, a reducing agent, developing promoter, hydrogen-bonding compound, antifoggant, polyhalogen compound and tinting agent. Among these materials, a reducing agent, developing promoter, hydrogen-bonding compound and polyhalogen compound are preferable and a polyhalogen compound is most preferable as the solid dispersion of the invention. The details of each compound will be described later.

Each element constituting the photothermographic material of the invention will be explained hereinbelow.

(Explanation of a Nonphotosensitive Organic Silver Salt)

The nonphotosensitive organic silver salt (hereinafter referred to simply as “organic silver salt” as the case may be) which may be used in the invention is a silver salt which is relatively stable against light, but forms a silver image when heated to 80° C. or more in the presence of an exposed photocatalyst (e.g., a latent image of a photosensitive silver halide) and a reducing agent. The organic silver salt may be an optional organic material containing a source capable of reducing a silver ion. Such a nonphotosensitive organic silver salt is described in JP-A No. 10-62899, Paragraphs No. 0048 to No. 0049, European Patent Application (Laid-Open) No. 0803764A1, page 18, line 24 to page 19, line 37, European Patent Application (Laid-Open) No. 0962812A1, JP-A Nos. 11-349591, 2000-7683 and 2000-72711.

As the organic silver salt in the invention, silver salts of organic acids, particularly, silver salts of long-chain aliphatic carboxylic acids (having 10 to 30 and preferably 15 to 28 carbon atoms) are preferable. Examples of the fatty acid silver salt include silver behenate, silver arachidate, silver stearate, silver oleate, silver laurate, silver caprate, silver myristate, silver palmitate and mixtures of these salts. In the invention, it is preferable to use fatty acid silver in which the content of silver behenate among these fatty acids is preferably 50 mol % or more, more preferably 80 mol % or more and still more preferably 90 mol % or more.

There is no particular limitation to the shape of the organic silver salt which may be used in the invention and the organic silver salt may have any of a needle form, bar form, tabular form and scale form. However, in the invention, an organic silver salt having a scale form is preferable.

Also, particles having an undefined form, such as a short needle form, rectangular parallelepiped form, cubic form or potato-like form, having a major axis/minor axis ratio of 5 or less are preferably used. These organic silver particles have the characteristics that they are more reduced in fogging during heat developing than long-needle particles having a major axis/minor axis ratio of 5 or more.

In this specification, the organic silver salt having a scale form is defined as follows. The organic acid silver salt is observed by an electron microscope and the shape of the organic acid silver salt particle is closely resembled to a rectangular parallelepiped form. Then, when each length of the sides of the rectangular parallelepiped are designated as a, b and c (c may be the same as b) from the shortest side, x is found by calculating from the lengths a and b of the shorter sides according to the following equation.

x=b/a

Each x of about 200 particles is found in this manner. When an average of xs is designated as x (average), those satisfying the relation x (average) ≧1.5 are defined as particles having a scale form. The x (average) preferably satisfies the relation 30≧x (average)≧1.5 and more preferably the relation 20≧x (average)≧2.0. Incidentally, in the case of a needle form, the relation 1≦x (average)<1.5 is established.

In a scale particle, a is regarded as the thickness of a tabular particle having a primary plane with sides b and c in length. The average of a is preferably 0.01 μm or more and 0.23 μm or less and more preferably 0.1 μm or more and 0.20 μm or less. The average of c/b is preferably 1 or more and 6 or less, more preferably 1.05 or more and 4 or less, still more preferably 1.1 or more and 3 or less and particularly preferably 1.1 or more and 2 or less.

The distribution of particle size of the organic silver salt is preferably monodispersion. The monodispersion means that the percentage of a value obtained by dividing the standard deviations of each length of the minor axis and major axis by each length of the minor axis and major axis respectively is preferably 100% or less, more preferably 80% or less and still more preferably 50% or less. As to a method of measuring the shape of the organic silver salt, the shape can be found from an image thereof obtained by a transmission type electron microscope. As another method of measuring monodispersion, there is a method of finding the standard deviation of the volumetric weighted average diameter of the organic silver salt. In the case of using this method, the percentage (coefficient of variation) of a value obtained by dividing the standard deviation by the volumetric weighted average diameter is preferably 100% or less, more preferably 80% or less and still more preferably 50% or less. As to the measuring method, for example, an organic silver salt dispersed in a liquid is irradiated with laser light to find an autocorrelation function of the fluctuation of the scattered light to a change in time. The monodispersibility can be found from the particle size (volumetric weighted average diameter) calculated from the autocorrelation function.

As a method of producing and dispersing the organic silver salt used in the invention, known methods and the like may be applied. The aforementioned JP-A No. 10-62899, European Patent Application Laid-Open Nos. 0803763A1, 0962812A1, JP-A Nos. 11-349591, 2000-7683, 2000-72711, Japanese Patent Application No. 11-348228 to 11-348230, 11-203413, 2000-90093, 2000-195621, 2000-191226, 2000- 213813, 2000-214155 and 2000-191226.

It is to be noted that when a photosensitive silver salt is allowed to coexist during the dispersing of the organic silver salt, fogging is increased and the sensitivity is remarkable lowered and it is therefore more preferable to substantially exclude the photosensitive silver salt during dispersing. In the invention, the amount of the photosensitive silver salt in a water dispersion solution in which it is to be dispersed is preferably 1 mol % or less and more preferably 0.1 mol % or less based on 1 mol of the organic silver salt in the solution. It is still more preferable that the photosensitive silver salt be not added positively.

In the invention, it is possible to produce a photosensitive material by mixing a water dispersion solution of an organic silver salt with a water dispersion solution of a photosensitive silver salt. The mixing ratio of the organic silver salt to the photosensitive silver salt may be selected according to the purpose. The ratio of the photosensitive silver salt to the organic silver salt is in a range from preferably 1 to 30 mol %, more preferably 2 to 20 mol % and particularly preferably 3 to 15 mol %. A method in which two or more water dispersion solutions of the organic silver salt are mixed with two or more water dispersion solutions of the photosensitive silver salt is desirably used to control photographic characteristics.

Although the organic silver salt may be used in a desired amount, the amount of the organic silver salt is preferably 0.1 to 5 g/m², more preferably 0.3 to 3 g/m² and still more preferably 0.5 to 2 g/m² as the amount of silver.

(Explanation of the Reducing Agent)

The photothermographic material of the invention contains a thermal developer which is a reducing agent (hereinafter referred to simply as “reducing agent”) for reducing a silver ion. The reducing agent for a silver ion may be an optional material (preferably an organic material) which reduces a silver ion into metal silver. Examples of such a reducing agent are described in JP-A No. 11-65021, Paragraphs No. 0043 to No. 0045 and European Patent Application Laid-Open No. 0803764A1, page 7, line 34 to page 18, line 12.

As the reducing agent in the invention, a hindered phenol type or bisphenol type reducing agent having a substituent at the ortho position of the phenolic hydroxyl group is preferable and compounds represented by the following general formula (R) is more preferable.

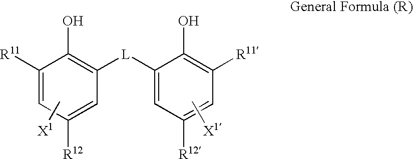

In the general formula (R), R¹¹ and R^{11′} respectively represent an alkyl group having 1 to 20 carbon atoms. R¹² and R^{12′} respectively represent a hydrogen atom or a substituent with which a benzene ring can be substituted. L represents a —S— group or a —CHR¹³— group. R¹³ represents a hydrogen atom or an alkyl group having 1 to 20 carbon atoms. X¹ and X^{1′} respectively represent a hydrogen atom or a group with which a benzene ring can be substituted.

The general formula (R) will be explained in detail.

In the general formula (R), R¹¹ and R^{11′} respectively represent a substituted or unsubstituted alkyl group having 1 to 20 carbon atoms. Although no particular limitation is imposed on the substituent of the alkyl group, preferable examples of the substituent include an aryl group, hydroxy group, alkoxy group, aryloxy group, alkylthio group, arylthio group, acylamino group, sulfonamide group, sulfonyl group, phosphoryl group, acyl group, carbamoyl group, ester group, ureide group, urethane group and halogen atom.

R¹¹ and R^{11′} are preferably secondary or tertiary alkyl groups having 3 to 15 carbon atoms. Specific examples of the alkyl group include an isopropyl group, isobutyl group, t-butyl group, t-amyl group, t-octyl group, cyclohexyl group, cyclopentyl group, 1-methylcyclohexyl group and 1-methylcyclopropyl group. Tertiary alkyl groups having 4 to 12 carbon atoms are more preferable. Among these groups, a t-butyl group, t-amyl group and 1-methylcyclohexyl group are more preferable and t-butyl group is most preferable.

In the general formula (R), R¹² and R^{12′} respectively represent a hydrogen atom or a substituent with which a benzene ring can be substituted.

R¹² and R^{12′} are alkyl groups having 1 to 20 carbon atoms. Specific examples of the alkyl group include a methyl group, ethyl group, propyl group, butyl group, isopropyl group, t-butyl group, t-amyl group, cyclohexyl group, 1-methylcyclohexyl group, benzyl group, methoxymethyl group and methoxyethyl group. Among these groups, a methyl group, ethyl group, propyl group, isopropyl group and t-butyl group are more preferable.

In the general formula (R), X¹ and X^{1′} respectively represent a hydrogen atom or a group with which a benzene ring can be substituted. Examples of the group with which a benzene ring can be substituted include an alkyl group, aryl group, halogen atom, alkoxy group and acylamino group.

X¹ and X^{1′} are respectively preferably a hydrogen atom, halogen atom or alkyl group and more preferably a hydrogen atom.

In the general formula (R), L is a —S— group or a —CHR¹³— group and preferably a —CHR¹³— group.

R¹³ represents a hydrogen atom or an alkyl group having 1 to 20 carbon atoms, in which the alkyl group may have a substituent. Specific examples of the unsubstituted alkyl group represented by R¹³ include a methyl group, ethyl group, propyl group, butyl group, heptyl group, undecyl group, isopropyl group, 1-ethylpentyl group and 2,4,4-trimethylpentyl group. Specific examples of the substituent of the alkyl group represented by R¹³ include the same groups as those exemplified as the substituent of the aforementioned R¹¹ and R^{11′}.

R¹³ is preferably a hydrogen atom or an alkyl group having 1 to 15 carbon atoms. As the alkyl group, a methyl group, ethyl group, propyl group, isopropyl group and 2,4,4-trimethylpentyl group are preferable. R¹³ is most preferably a hydrogen atom, methyl group, ethyl group, propyl group or isopropyl group.

When R¹³ is a hydrogen atom, R¹² and R^{12′} are respectively preferably an alkyl group having 2 to 5 carbon atoms, more preferably an ethyl group and propyl group and most preferably an ethyl group.

When R¹³ is a primary or secondary alkyl group having 1 to 8 carbon atoms, R¹² and R^{12′} are respectively preferably a methyl group. As the primary or secondary alkyl group having 1 to 8 carbon atoms which group is represented by R¹³, a methyl group, ethyl group, propyl group and isopropyl group are more preferable and a methyl group, ethyl group and propyl group are still more preferable.

When R¹¹, R^{11′}, R¹² and R^{12′} are all methyl groups, R¹³ is preferably a secondary alkyl group, more preferably an isopropyl group, isobutyl group and 1-ethylpentyl group and particularly preferably an isopropyl group.

The reducing agent differs in heat developing ability and in the developed silver tone depending on the combinations of R¹¹, R^{11′}, R¹² and R^{12′} and R¹³. Because these characteristics can be controlled by combining two or more reducing agents, a combination of two or more reducing agents is preferably used though this depends on the purpose.

Specific examples (exemplified compounds R-1 to R-34) of the reducing agent including the compounds represented by the general formula (R) in the invention will be shown below. The compound which can be used in the invention is not limited to these examples.

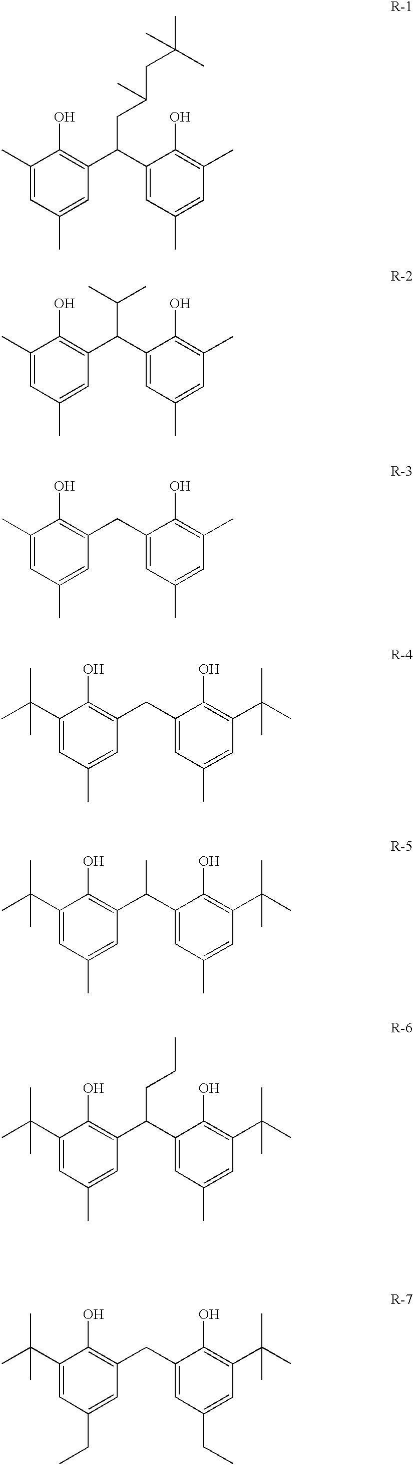

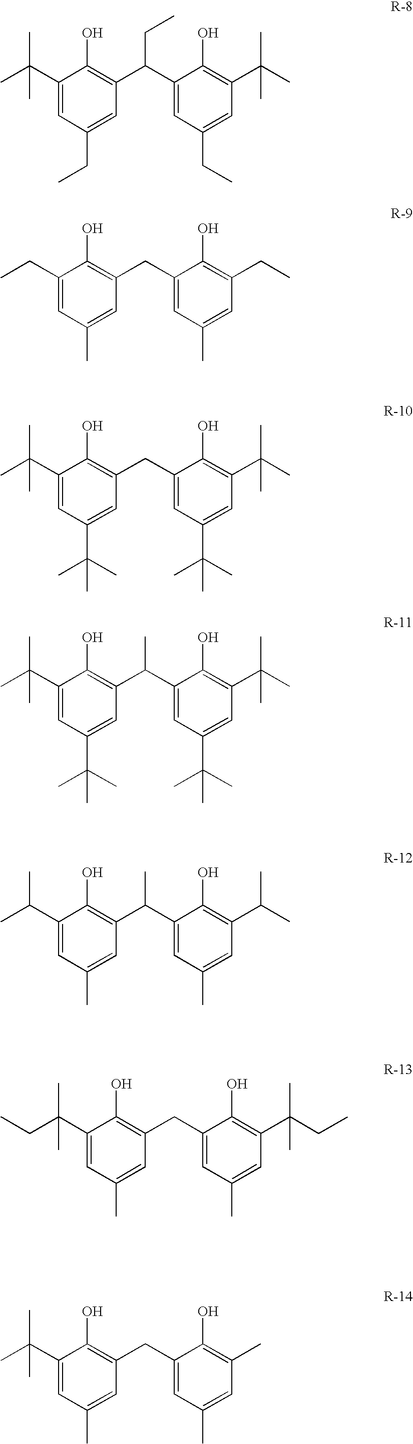

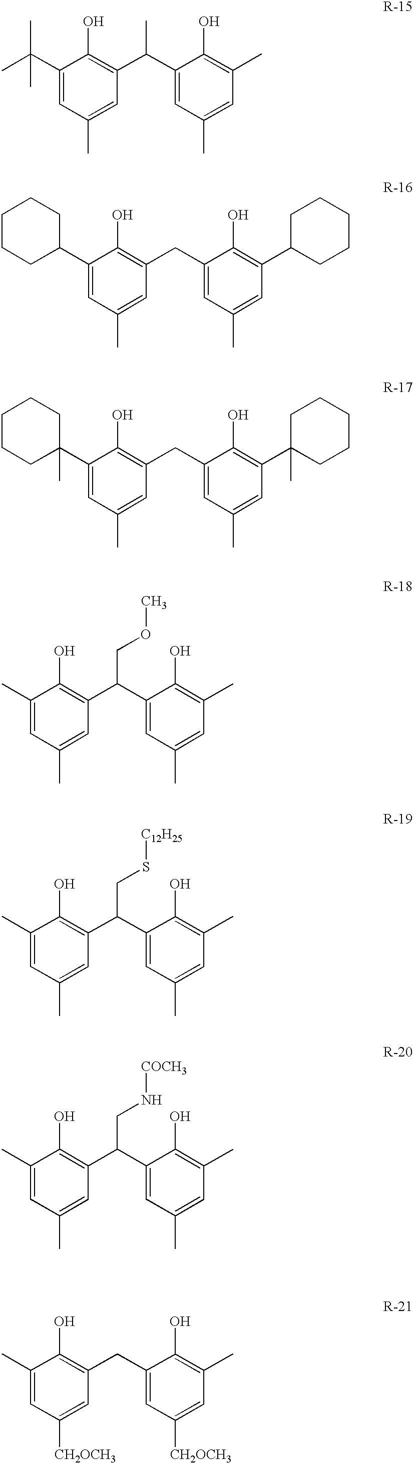

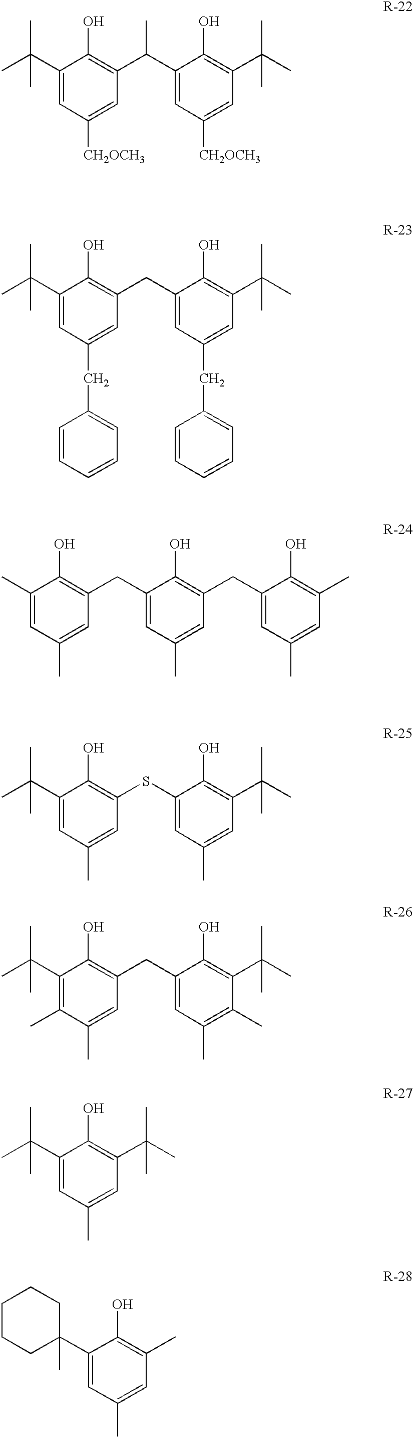

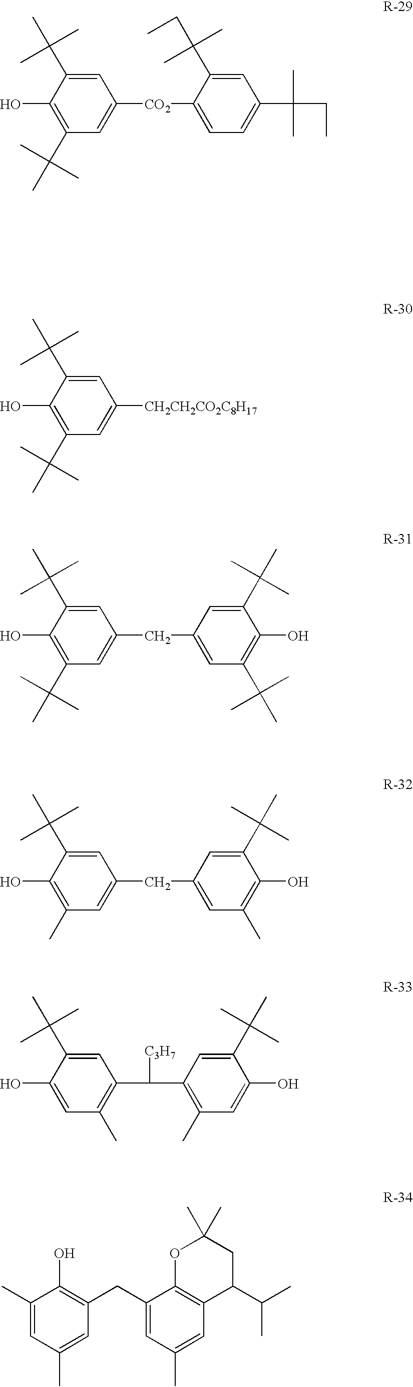

The amount of the reducing agent to be added in the invention is preferably 0.1 to 3.0 g/m², more preferably 0.2 to 1.5 g/m² and still more preferably 0.3 to 1.0 g/m². The reducing agent is contained in an amount of preferably 5 to 50% mol, more preferably 8 to 30 mol % and still more preferably 10 to 20 mol % based on 1 mol of silver of the surface provided with the image forming layer. The reducing agent is preferably contained in an image forming layer.

Although the reducing agent may be contained in the coating solution by using any method as to the state thereof, for example, a solution state, emulsion dispersion state and solid dispersion state, it is preferably contained as the solid dispersion of the invention.

As a well known emulsion dispersion method, a method is exemplified in which the reducing agent is dissolved using an oil such as dibutyl phthalate, tricresyl phosphate, glyceryl triacetate or diethyl phthalate or an auxiliary solvent such as ethyl acetate or cyclohexanone to produce an emulsion dispersion mechanically.

Also, as a method of producing a solid microparticle dispersion, a method is exemplified in which a powder of the reducing agent is dispersed in a proper solvent such as water by using a ball mill, colloid mill, oscillation ball mill, sand mill, jet mill, roller mill or ultrasonic wave to produce a solid dispersion. At this time, a protective colloid (e.g., polyvinyl alcohol) and a surfactant (e.g., an anionic surfactant such as sodium triisopropylnaphthalene sulfonate (a mixture of three types differing in the substituted positions of an isopropyl group)) may be used. Beads such as zirconia are usually used as the dispersion medium in the above mills and there is the case where Zr and the like eluted from these beads are mingled in the dispersion. The content of the beads is preferably in a range from 1 ppm to 1000 ppm in general though it depends on dispersing condition. If the content of Zr in the photosensitive material is 0.5 mg or less per 1 g of silver, no practical problem arises.

It is preferable to contain an antiseptic (e.g., a benzoisothiazolinone sodium salt) in the water dispersion.

(Explanation of the Developing Promoter)

The photothermographic material of the invention preferably contains a developing promoter.

As the developing promoter, sulfonamidophenol type compounds represented by the general formula (A) described in JP-A Nos. 2000-267222 and 2000-330234, hindered phenol type compounds represented by the general formula (II) described in JP-A No. 2001-92075, hydrazine type compounds represented by the general formula (I) described in JP-A Nos. 10-62895 and 11-15116 and the general formula (1) described in Japanese Patent Application No. 2001-074278 and phenol type or naphthol type compounds represented by the general formula (2) described in Japanese Patent Application No. 2000-76240 are preferably used.

The amount of these developing promoters to be added is preferably in a range from 0.1 to 20 mol %, more preferably in a range from 0.5 to 10 mol % and still more preferably in a range from 1 to 5 mol %.

As a method of introducing the developing promoter into the photothermographic material, the same method as in the case of the above reducing agent is exemplified. Particularly, it is preferable to add the developing promoter as a solid dispersion or an emulsion dispersion and more preferably as a solid dispersion.

When the developing promoter is added as the solid dispersion, the solid dispersion is preferably the solid dispersion of the invention.

When the developing promoter is added as the emulsion dispersion, it is preferably added as an emulsion dispersion prepared by dispersing it by using a high-boiling point solvent which is a solid at ambient temperature and a low-boiling point auxiliary solvent or as a so-called oilless emulsion dispersion using no high-boiling point solvent.

(Explanation of the Hydrogen-Bonding Compound)

The photothermographic material of the invention preferably contains the hydrogen-bonding compound.

When the reducing agent in the invention has an aromatic hydroxyl group (—OH) and particularly in the case of the aforementioned bisphenols, it is preferable to use the reducing agent in combination with a non-reducing compound having a group capable of forming a hydrogen bond with these groups. Examples of the group capable of forming a hydrogen bond with a hydroxyl group or an amino group include a phosphoryl group, sulfoxide group, sulfonyl group, carbonyl group, amide group, ester group, urethane group, ureide group, tertiary amino group and nitrogen-containing aromatic group. Compounds having a phosphory group, sulfoxide group, amide group (provided that this group has no >N—H group and is blocked as shown by >N—Ra (Ra is a substituent other than H)), urethane group (provided that this group has no >N—H group and is blocked as shown by >N—Ra (Ra is a substituent other than H)) and ureide group (provided that this group has no >N—H group and is blocked as shown by >N—Ra (Ra is a substituent other than H)) among these groups are preferable.

As particularly preferable examples of the hydrogen-bonding compound in the invention, compounds represented by the following general formula (D) are given.

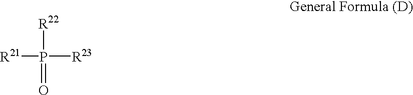

In the general formula (D), R²¹, R²² and R²³ respectively represent an alkyl group, an aryl group, an alkoxy group, an aryloxy group, an amino group or a heterocyclic group and these groups may be unsubstituted or may have a substituent.

In the case where R²¹, R²² and R²³ respectively have a substituent, examples of the substituent include a halogen atom, alkyl group, aryl group, alkoxy group, amino group, acyl group, acylamino group, alkylthio group, arylthio group, sulfonamide group, acyloxy group, oxycarbonyl group, carbamoyl group, sulfamoyl group, sulfonyl group and phosphoryl group and preferably an alkyl group or aryl group. Specific examples include a methyl group, ethyl group, isopropyl group, t-butyl group, t-octyl group, phenyl group, 4-alkoxyphenyl group and 4-acyloxyphenyl group.

Examples of the alkyl group represented by R²¹, R²² and R²³ include a methyl group, ethyl group, butyl group, octyl group, dodecyl group, isopropyl group, t-butyl group, t-amyl group, t-octyl group, cyclohexyl group, 1-methylcyclohexyl group, benzyl group, phenethyl group and 2-phenoxypropyl group.

Examples of the aryl group represented by R²¹, R²² and R²³ include a phenyl group, cresyl group, xylyl group, naphthyl group, 4-t-butylphenyl group, 4-t-octylphenyl group, 4-anicidyl group and 3,5-dichlorophenyl group.

Examples of the alkoxy group represented by R²¹, R²² and R²³ include a methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group and benzyloxy group.

Examples of the aryloxy group represented by R²¹, R²² and R²³ include a phenoxy group, cresyloxy group, isopropylphenoxy group, 4-t-butylphenoxy group, naphthoxy group and biphenyloxy group.

Examples of the amino group represented by R²¹, R²² and R²³ include a dimethylamino group, diethylamino group, dibutylamino group, dioctylamino group, N-methyl-N-hexylamino group, dicyclohexylamino group, diphenylamino group and N-methyl-N-phenylamino group.

Examples of the heterocyclic group represented by R²¹, R²² and R²³ include an imidazole cyclic group, pyridine cyclic group, pyrrole cyclic group, thiophene cyclic group, thiazole cyclic group, oxazole cyclic group, pyran cyclic group, pyrazoline cyclic group, piperidine cyclic group, piperazine cyclic group, morpholine cyclic ring, indole cyclic ring and quinoline cyclic ring.

As R²¹, R²² and R²³, an alkyl group, aryl group, alkoxy group and aryloxy group are preferable. It is preferable that at least one or more of R²¹, R²² and R²³ be an alkyl group or aryl group and it is more preferable that two or more of R²¹, R²² and R²³ be an alkyl group or aryl group. Also, R²¹, R²² and R²³ are preferably the same groups in the point that the hydrogen-bonding compound is available at a low cost.

Specific examples (exemplified compounds D-1 to D-12) of the hydrogen-bonding compound including the compounds represented by the general formula (D) will be shown below. However, the compounds which may be used in the invention are not limited to these examples.

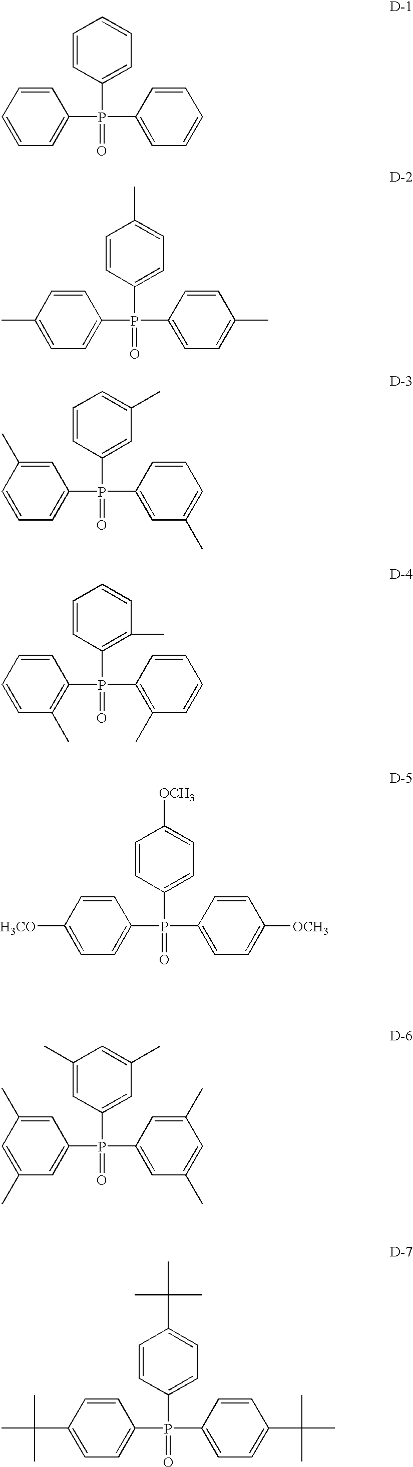

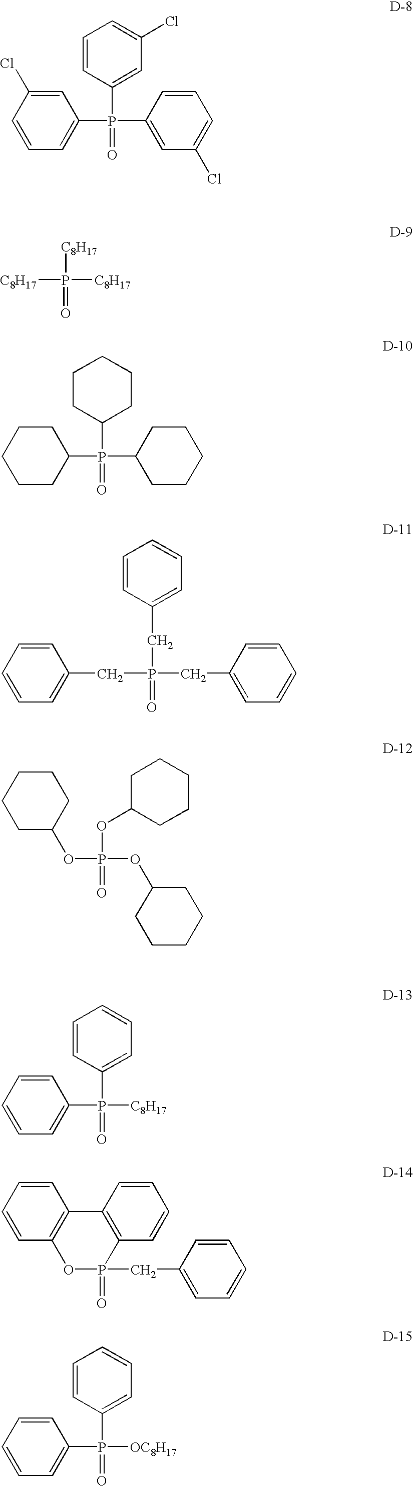

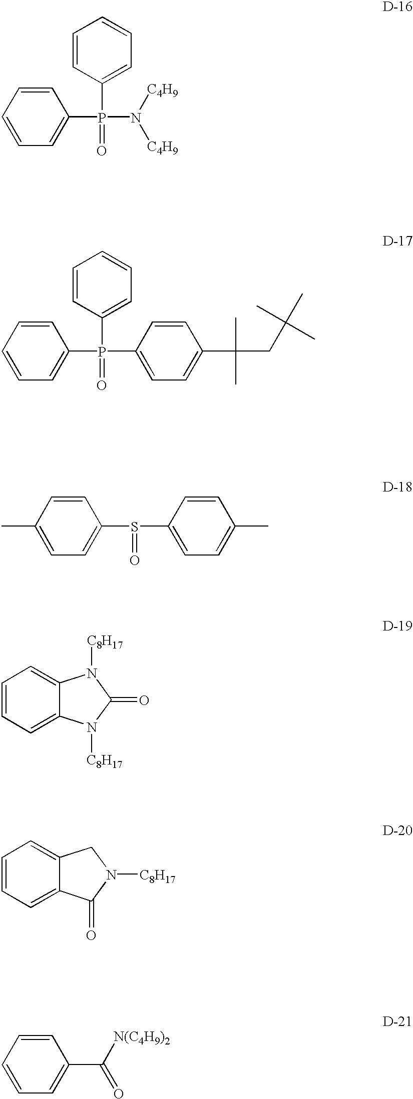

As specific examples of the hydrogen-bonding compound, those described in European Patent Application No. 1096310 and each specification of Japanese Patent Applications No. 2000-270498 and No. 2001-124796 besides the foregoing compounds are given.

The hydrogen-bonding compound in the invention may. be contained in the coating solution in a solution state, emulsion dispersion state and solid dispersion state in the same manner as in the case of the reducing agent.

It is to be noted that when the hydrogen-bonding compound is added in a solid dispersion state, the solid dispersion is preferably the solid dispersion of the invention.

The compound of the invention forms a complex by bydrogen bonding with a compound having a phenolic hydroxyl group and an amino group in a solution state and can be isolated as a complex in a crystal state though this depends on the combination of the reducing agent with the compound represented by the above general formula (D). It is particularly preferable to use the crystal powder isolated in this manner as the dispersion of a solid dispersion microparticle with the view of obtaining stable performance. Also, a method is preferably used in which the reducing agent is mixed with the aforementioned compound represented by the general formula (D) as a powder to form a complex when the mixture is dispersed using a proper dispersant and a sand grinder mill or the like.

The amount of the hydrogen-bonding compound represented by the general formula (D) in the invention is preferably in a range from 1 to 200 mol %, more preferably in a range from 10 to 150 mol % and still more preferably in a range from 20 to 100 mol % based on the reducing agent.

(Explanation of the Photosensitive Silver Halide)

There is no particular limitation to the halogen composition of the photosensitive silver halide (hereinafter referred to simply as “silver halide”) used in the invention. Silver chloride, silver chlorobromide, silver bromide, silver bromoiodide, silver chloroiodobromide and silver iodide may be used. Among these silver halides, silver bromide and silver bromoiodide are preferable. In the distribution of halogen composition in the particle, the halogen composition may be uniform or be changed stepwise or continuously. Also, silver halide particles having a core/shell structure are preferably used. Duplex to quintuple structures are preferable as the structure and it is more preferable to use particles having duplex to quadruple core/shell structures. Also, techniques for localizing silver bromide or silver iodide on the surfaces of silver chloride, silver bromide or silver chlorobromide particles are preferably used.

Methods of forming a photosensitive silver halide are well known in the those skilled in the art. For example, the methods described in Research Disclosure No. 17029, on June, 1978 and U.S. Pat. No. 3,700,458 may be used. Specifically, a method is used in which a silver supply compound and a halogen supply compound are added to a gelatin or other polymer solution to thereby prepare a photosensitive silver halide, which is then mixed with an organic silver salt. Also, the method described in JP-A No. 11-119374, Paragraph No. 0217 to No. 0224 and the methods described in Japanese Patent Application No. 11-98708 and JP-A No. 2000-347335 are preferable.

The particle size of the photosensitive silver halide is preferably small with the intention of restricting whitening turbidity after an image is formed. Specifically, the particle size is preferably 0.20 μm or less, more preferably 0.01 μm or more and 0.15 μm or less and more preferably 0.02 μm or more and 0.12 μm or less. The particle size so-called here means the diameter of a circle image converted so as to have the same area as the projected area (the projected area of the principal plane in the case of tabular particles) of a silver halide particle.

Examples of the shape of the photosensitive silver halide particle may include a cubic form, octahedron form, tabular form, sphere form, bar form and potato-like form and a cubic particle is particularly preferable in the invention. Light-sensitive silver halide particles with round corners are also preferably used. Although no particular limitation is imposed on the plane index (Miller index) of the external surface of the photosensitive silver halide particle, it is desirable that the ratio occupied by a {100} plane giving a high spectral sensitization effect when a spectral sensitizing dye is adsorbed be higher. The ratio is preferably 50% or more, more preferably 65% or more and still more preferably 80% or more. The ratio of the Miller index {100} plane may be found by the method described in T. Tani; J. Imaging Sci., 29, 165 (1985) and making use of the adsorption dependency of a {111} plane and a {100} plane in the adsorption of the sensitizing dye.

In the invention, silver halide particles in which a hexacyano metal complex is made to exist on the outermost surface of the particle are preferable. Examples of the hexacyano metal complex include [Fe(CN)₆]⁴⁻, [Fe(CN)₆]³⁻, [Ru(CN)_{6]}⁴⁻, [Os(CN)_{6]}⁴⁻, [Co(CN)₆]³⁻, [Rh(CN)₆]³⁻, [Ir(CN)₆]³⁻, [Cr(CN)₆]³⁻and [Re(CN)_{6]}³⁻. In the invention, hexacyano Fe complex is preferable.

Because the hexacyano metal complex is present in the form of an ion in an aqueous solution, the counter cation is not important. However, alkali metal ions such as a sodium ion, potassium ion, rubidium ion, cesium ion and lithium ion, ammonium ions and alkylammonium ions (e.g., a tetramethylammonium ion, tetraethylammonium ion, tetrapropylammonium ion and tetra(n-butyl)ammonium ion) are preferably used.

The hexacyano metal complex may be added after it is mixed with, besides water, a mixed solvent of water and a proper organic solvent (e.g., alcohols, ethers, glycols, ketones, esters and amides) which is miscible with water, or a gelatin.

The amount of the hexacyano metal complex is preferably 1×10⁻⁵ mol or more and 1×10⁻² mol or less and more preferably 1×10⁻⁴ mol or more and 1×10⁻³ mol or less per 1 mol of silver.

In order to allow the hexacyano metal complex to exist on the outermost surface of the silver halide particle, the hexacyano metal complex is directly added after the addition of an aqueous silver nitrate solution used for the formation of particles is finished before a charging step is finished during a water-washing step or during a dispersing step till before a chemical sensitization step in which chalcogen sensitization such as sulfur sensitization, selenium sensitization and tellurium sensitization or precious metal sensitization such as gold sensitization is carried out, or just before the chemical sensitization step. In order to prevent the growth of silver halide microparticles, the hexacyano metal complex is preferably added immediately after particles are formed and is therefore preferably added before the charging step is finished.

The addition of the hexacyano metal complex may be started from after silver nitrate to be added for forming particles has been added in an amount of 96 mass %, more preferably 98 mass % and particularly preferably 99 mass % of the total amount of the silver nitrate.

When the hexacyano metal complex is added after an aqueous silver nitrate solution is added and just before the formation of particles is completed, the hexacyano metal complex can be adsorbed to the outermost surface of the silver halide particle and almost all of the hexacyano metal complex forms a sparingly-soluble salt with a silver ion disposed on the surface of the particle. Because the silver salt of the hexacyano iron (II) is a more sparingly soluble than AgI, redissolution of microparticles can be prevented and it is therefore possible to produce silver halide microparticles having a smaller particle size.

The photosensitive silver halide particle of the invention may contain metals of group VIII to group X in the periodic table (shows I group to XVIII group) or complexes of these metals. As metals of group VIII to group X in the periodic table or center metals of complexes of these metals, rhodium, ruthenium and iridium are preferable. These metals complexes may be one type and a combination of two or more complexes of the same metals or different metals may be used. The content of the complex is preferably in a range from 1×10 ⁻⁹ mol to 1×10⁻³ mol per one mol of silver. These heavy metals, metal complexes and a method of adding these metals or metal complexes are described in JP-A Nos. 7-225449, 11-65021, Paragraphs No. 0018 to No. 0024 and JP-A No. 11-119374, Paragraphs No. 0227 to No. 0240.

Metal atoms (e.g., [Fe(CN)₆]⁴−) which may be contained in the silver halide particle used in the invention, a method of desalting a silver halide emulsion and a chemical sensitization method are described in JP-A No. 11-84574, Paragraphs No. 0046 to No. 0050, JP-A No. 11-65021, Paragraphs No. 0025 to No. 0031 and JP-A No. 11-119374, Paragraphs No. 0242 to No. 0250.

As the gelatin contained in the photosensitive silver halide emulsion used in the invention, various gelatins may be used. A low-molecular weight gelatin having a molecular weight of 500 to 60,000 is preferably used to keep good dispersion condition of the photosensitive silver halide emulsion in the organic silver salt-containing coating solution. Although the low-molecular weight gelatin may be used during the formation of particles or during dispersing after desalting, it is preferably used during dispersing after desalting.

As the sensitizing dye which may be applied to the photosensitive silver halide in the invention, sensitizing dyes which can spectrally sensitize a silver halide particle in a desired wavelength region when adsorbed to the silver halide particle and have spectral sensitivity suitable to the spectral characteristics of an exposure light source may be selected advantageously. There are descriptions concerning the sensitizing dye and a method of adding the dye in the following references: JP-A No. 11-65021 (Paragraphs No. 0103 to No. 0109), JP-A No. 10-186572 (the compounds represented by the general formula (II)), JP-A No. 11-119374 (the dyes represented by the general formula (I) and Paragraph No. 0106), U.S. Pat. Nos. 5,510,236, 3,871,887 (the dyes described in Example 5), JP-A Nos. 2-96131 and 59-48753 (the dyes disclosed), the European Patent Application Laid-Open No. 0803764A1 (page 19, line 38 to page 20, line 35), Japanese Patent Application Nos. 2000-86865, 2000-102560 and 2000-205399 and the like. These sensitizing dyes may be used either singly or in combinations of two or more. In the invention, the sensitizing dye is added to the silver halide emulsion preferably at a time after a desalting step till application and more preferably at a time after desalting till before the start of chemical ripening.

The sensitizing dye in the invention may be added in a desired amount in accordance with the qualities such as sensitivity and fogging: however, the amount of the sensitizing dye is preferably 10⁻⁶ to 1 mol and more preferably 10⁻⁴ to 10⁻¹ mol based on 1 mol of the silver halide of photo sensitive layer.

In the invention, a color-intensifying sensitizing agent may be used to improve spectral sensitization efficiency. Examples of the color-intensifying sensitizing agent include the compounds described in European Patent Application Laid-Open No. 587,338, U.S. Pat. Nos. 3,877,943, 4,873,184, JP-A No. 5-341432, JP-A No. 11-109547 and JP-A No. 10-111543.

The photosensitive silver halide particle in the invention has been preferably sensitized chemically by a sulfur sensitization method, selenium sensitization method or tellurium sensitization method. As compounds respectively used in a sulfur sensitization method, selenium sensitization method and tellurium sensitization method, known compounds, for example, the compounds described in JP-A No. 7-128768 may be used. In the invention, tellurium sensitization is particularly preferable and the compounds described in the literature shown in Paragraph No. 0030 of JP-A No. 11-65021 and the compounds represented by the general formulae (II), (III) an (IV) in JP-A No. 5-313284 are more preferable.

The chemical sensitization in the invention is practicable at any time before application after the formation of particles and possibly at any time after desalting and, for instance, (1) before spectral sensitization, (2) simultaneously with spectral sensitization, (3) after spectral sensitization and (4) just before application. Particularly, the chemical sensitization is preferably made after spectral sensitization.

A sulfur, selenium or tellurium sensitizing agent is used in an amount of about 10⁻⁸ to 10⁻² mol and preferably about 10⁻⁷ to 10⁻³ mol per 1 mol of the silver halide, though the amount differs depending on the type of silver halide particle, chemical ripening conditions and the like. Although no particular limitation to the condition of the chemical sensitization in the invention, the condition of the chemical sensitization is as follows: pH: about 5 to 8, pAg: about 6 to 11 and temperature: about 40 to 95° C.

A thiosulfonic acid compound may be added to the silver halide emulsion used in the invention according to the method described in the European Patent Application Laid-Open No. 293,917.

As the photosensitive silver halide emulsion in the photothermographic material of the invention, only one type may be used or a combination of two or more types (for example, those differing in average particle size, those differing in halogen composition, those differing in crystal habit and those differing in the condition of chemical sensitization) may be used. The gradation can be controlled by using plural photosensitive silver halides having different sensitivities. Examples of the technologies concerned include those described in each JP-A Nos. 57-119341, 53-106125, 47-3929, 48-55730, 46-5187, 50-73627 and 57-150841. As to a difference in sensitivity, it is preferable to make a difference of 0.2 log E or more between each emulsion.

The amount of the photosensitive silver halide to be added is preferably 0.03 to 0.6 g/m², more preferably 0.07 to 0.4 g/m² and most preferably 0.05 to 0.3 g/m² in terms of the amount of silver applied per 1 m² of the photosensitive material. The amount of the photosensitive silver halide based on 1 mol of the organic silver salt is preferably 0.01 mol or more and 0.5 mol or less, more preferably 0.02 mol or more and 0.3 mol or less and still more preferably 0.03 mol or more and 0.2 mol or less.

As to a method and condition for mixing the photosensitive silver halide and organic silver salt which are prepared separately, there are, for example, a method in which a silver halide particle and organic silver salt which have been respectively prepared are mixed with each other using a high speed stirrer, ball mill, sand mill, colloid mill, oscillation mill, homogenizer or the like and a method in which the photosensitive silver halide which has been prepared is mixed at any time during the preparation of the organic silver salt to prepare the organic silver salt. However, no particular limitation to the mixing method as far as the effect of the invention is sufficiently produced. When these two types of salt are mixed, it is preferable to mix two or more aqueous organic silver salt dispersion and two or more aqueous photosensitive silver salt dispersion with the view of controlling photographic characteristics.

The silver halide according to the invention is added to an image forming layer coating solution preferably at a time between just and 180 minutes and preferably 60 minutes and 10 seconds before the coating solution is applied. However, no particular limitation is imposed on the mixing method and condition as far as the effect of the invention is sufficiently produced. As specific mixing method, there are a method of mixing in a tank such that the average retention time calculated from the flow rate of addition and a feed rate to a coater is made to be a desired time and a method using a static mixer as described in N. Harnby, M. F. Edwards, A. W. Nienow, translated by TAKAHASHI Koji “Liquid Mixing Technologies” (published by The Nikkann Kogyo Shimbun, Ltd., 1989), Chapter 8.

(Explanation of the Binder)

As the binder of the organic silver salt-containing layer (namely, the image forming layer) according to the invention, any polymer may be used. Preferable examples of the binder include those which are transparent or semi-transparent and generally non-colored, for example, natural resins, polymers and copolymers, synthetic resins, polymers and copolymers and other media forming films such as gelatins, rubbers, poly(vinyl alcohols), hydroxyethyl celluloses, cellulose acetates, cellulose acetate butyrates, poly(vinyl pyrrolidones), casein, starch, poly(acrylic acids), poly(methylmethacrylic acids), poly(vinyl chlorides), poly(methacrylic acids), styrene-maleic acid anhydride copolymers, styrene-acrylonitrile copolymers, styrene-butadiene copolymers, poly(vinylacetals) (e.g., poly(vinylformal) and poly(vinylbutyral)), poly(esters), poly(urethanes), phenoxy resins, poly(vinylidene chlorides), poly(epoxides), poly(carbonates), poly(vinyl acetates), poly(olefins), cellulose esters and poly(amides). The binder may be formed by coating from a water or organic solvent solution or an emulsion.

In the invention, the glass transition temperature of the binder which may be used together in a layer containing the organic silver salt is preferably 10° C. or more and 80° C. or less (hereinafter referred to as a high-Tg binder as the case may be), more preferably 15° C. to 70° C. and still more preferably 20° C. or more and 65° C. or less.

In this specification, Tg was calculated using the following equation.

1/Tg=Σ(Xi/Tgi)

wherein it is assumed that the polymer is prepared by copolymerizing n monomer components (i=1 to n). Xi is the weight percentage (ΣXi=1) of the i(th) monomer and Tgi is the glass transition temperature (absolute temperature) of a homopolymer of the i(th) monomer. Here, Σ figures out the sum (i=1 to n). It is to be noted that as the value (Tgi) of the glass transition temperature of a homopolymer of each monomer, the values described in Polymer Handbook (3rd Edition) (J. Brandrup, E. H. Immergut (Wiley-Interscience, 1989)) were adopted.

As the binder, two or more types may be used together. Also, as the binder, a combination of one having a glass transition temperature of 20° C. or more and one having a glass transition temperature less than 20° C. may be used. When using polymers differing in Tg by blending these polymers, the weight average Tg of these polymers preferably falls in the above range.

In the invention, the organic silver salt-containing layer is preferably prepared by applying a coating solution (water-type coating solution) in which 30 mass % or more of the solvent is water, followed by drying to form a film.

In the invention, when the organic silver salt-containing layer is formed by applying a coating solution (water-type coating solution) in which 30 mass % or more of the solvent is water, followed by drying and further the binder of the organic silver salt-containing layer is soluble or dispersible in a water-type solvent (water solvent), the performance is improved, particularly, in the case where the binder is made of a polymer latex having an equilibrium moisture content of 2 mass % or less at 25° C. and 60% RH. A most preferable binder is a type controlled such that the ion conductivity is 2.5 mS/cm or less. As such a control method, a method in which after a polymer is synthesized, it is refined using a separating function membrane is exemplified.

The water type solvent so-called here in which the foregoing polymer is soluble or dispersible means water or a solvent prepared by compounding 70 mass % or less of a water miscible organic solvent in water. Examples of the water miscible organic solvent may include alcohol types such as methanol, ethanol and propyl alcohol, cellosolve types such as methyl cellosolve, ethyl cellosolve and butyl cellosolve, ethyl acetate and dimethylformamide.

It is to be noted that a system in which the polymer is not dissolved thermodynamically but put in a so-called dispersed state, the term “water type solvent” is also used here.

Also, the “equilibrium moisture content at 25° C. and 60% RH” may be given as follows using the weight W1 of a polymer put in humidity equilibrium under an atmosphere of 25° C. and 60% RH and the weight WO of the polymer put in an absolute dry condition at 25° C.

Equilibrium moisture content at 25° C. and 60% RH={(W1−W0)/W0}×100 (mass %)

As to the definition and measurement method of the moisture content, for example Polymer Enginnering Lecture 14, Polymer material Test Method (edited by Polymer Association, Chijinshokan Co., Ltd.) may serve as a reference.

The equilibrium moisture content of the binder polymer in the invention at 25° C. and 60% RH is 2 mass % or less, more preferably 0.01 mass % or more and 1.5 mass % or less and still more preferably 0.02 mass % or more and 1 mass % or less.

In the invention, a polymer dispersible in a water type solvent is particularly preferable. As examples of the dispersion state, any one of the cases where a latex in which microparticles of a water-insoluble polymer are dispersed or a polymer molecule is dispersed in a molecular state or with forming a micelle is acceptable. Particles dispersed in a latex are more preferable. The average particle diameter of the dispersed particles is in a range from 1 to 50000 nm, preferably in a range from 5 to 1000 nm, more preferably in a range from 10 to 500 nm and still more preferably in a range from 50 to 200 nm. There is no particular limitation to the distribution of particle diameter of the dispersed particles and either particles having a wide distribution of particle diameter or particles having a monodispersion distribution of particle diameter may be used. It is a preferable method of use to mix two or more types having a monodispersion distribution of particle diameter with the view of controlling the qualities of a coating solution.

As to preferable embodiments of the polymer dispersible in a water-type solvent in the invention, hydrophobic polymers such as acryl type polymers, poly(esters), rubbers (e.g., SBR resins), poly(urethanes), poly(vinyl chlorides), poly(vinyl acetates), poly(vinylidene chlorides) and poly(olefins) may be preferably used. These polymers may be straight-chain polymers, branched polymers, crosslinked polymers homopolymers obtained by polymerizing a single monomer or copolymers obtained by polymerizing two or more monomers. In the case of copolymers, these copolymers may be either random copolymers or block copolymers. The molecular weight of each of these polymers is 5000 to 1000000 and preferably 10000 to 200000 in terms of number average molecular weight. In the case of polymers having excessively small molecular weight, the dynamic strength of the emulsion layer is insufficient whereas in the case of polymers having excessively large molecular weight, poor coatability is brought about and therefore a molecular weight out of the above range is undesirable. Also, a crosslinkable polymer latex is used particularly preferably.

—Specific Examples of the Latex—

As specific examples of the polymer latex in the invention, the following compounds may be given. In the following, these examples are represented by raw material monomers, wherein the values in the parenthesis are mass % and the molecular weight is a number average molecular weight. When a polyfunctional monomer is used, the concept of a molecular weight cannot be applied because it forms a crosslinking structure. Therefore, such a case is described as “crosslinkable” and the description of a molecular weight is omitted. Tg represents a glass transition temperature.

P-1: Latex of -MMA(70)-EA(27)-MAA(3)-(molecular weight: 37000, Tg: 61° C.)

P-2: Latex of -MMA(70)-2EHA(20)-St(5)-AA(5)-(molecular weight: 40000, Tg: 59° C.)

P-3: Latex of -St(50)-Bu(47)-MAA(3)-(crosslinkable, Tg: −17° C.)

P-4: Latex of -St(68)-Bu(29)-AA(3)-(crosslinkable, Tg: 17° C.)

P-5: Latex of -St(71)-Bu(26)-AA(3)-(crosslinkable, Tg: 24° C.)

P-6: Latex of -St(70)-Bu(27)-IA(3)-(crosslinkable)

P-7: Latex of -St(75)-Bu(24)-AA(1)-(crosslinkable, Tg: 29° C.)

P-8: Latex of -St(60)-Bu(35)-DVB(3)-MAA(2)-(crosslinkable)

P-9: Latex of -St(70)-Bu(25)-DVB(2)-AA(3)-(crosslinkable)

P-10: Latex of -VC(50)-MMA(20)-EA(20)-AN(5)-AA(5)-(molecular weight: 80000)

P-11: Latex of -VDC(85)-MMA(5)-EA(5)-MAA(5)-(molecular weight: 67000)

P-12: Latex of -ET(90)-MMA(10)-(molecular weight: 12000)

P-13: Latex of -St(70)-2EHA(27)-AA(3)-(molecular weight: 130000, Tg: 43° C.)

P-14: Latex of -MMA(63)-EA(35)-AA(2)-(molecular weight: 33000, Tg: 47° C.)

P-15: Latex of -St(70.5)-Bu(26.5)-AA(3)-(crosslinkable, Tg: 23° C.)

P-16: Latex of -St(69.5)-Bu(27.5)-AA(3)-(crosslinkable, Tg: 20.5° C.)

The abbreviations of the above structures indicate the following monomers: MMA: methylmethacrylate, EA: ethylacrylate, MAA: methacrylic acid, 2EHA: 2-ethylhexylacrylate, St: styrene, Bu: butadiene, AA: acrylic acid, DVB: divinylbenzene, VC: vinyl chloride, AN: acrylonitrile, VDC: vinylidene chloride, Et: ethylene and IA: itaconic acid.

These polymer latexes as described above are also commercially available and the following polymers may be utilized. Examples of acrylic polymers may include Sebian A-4635, 4718 and 4601 (manufactured by Daicel Chemical Industries, Ltd.) and Nipol Lx 811, 814, 821, 820 and 857 (manufactured by Nippon Zeon Co., Ltd.). Examples of poly(esters) may include FINETEX ES650, 611, 675 and 850 (manufactured by Dainippon Ink and Chemicals, Incorporated) and WD-size and WMS (manufactured by Eastman Chemical Company). Examples of poly(urethanes) may include HYDRAN AP10, 20, 30 and 40 (manufactured by Dainippon Ink and Chemicals, Incorporated). Examples of rubbers may include LACSTAR 7310K, 3307B, 4700H and 7132C (manufactured by Dainippon Ink and Chemicals, Incorporated) and Nipol Lx 416, 410, 438C and 2507 (manufactured by Nippon Zeon Co., Ltd.). Examples of poly(vinyl chlorides) may include G351 and G576 (manufactured by Nippon Zeon Co., Ltd.). Examples of poly(vinylidene chlorides) may include L502 and L513 (manufactured by Asahi Chemical Industry Co., Ltd.). Examples of poly(olefins) may include Chemipearl S120 and SA100 (manufactured by Mitsui Petrochemical Industries, Ltd.).

These polymer latexes may be used either singly or by blending two or more according to the need.

-Preferable Patex-

As the polymer latex used in the invention, particularly latexes of styrene-butadiene copolymers are preferable. The ratio by weight of the monomer units of styrene to the monomer units of butadiene in the styrene-butadiene copolymer is 40:60 to 95:5. The proportion occupied by the monomer units of styrene and the monomer units of butadiene in the copolymer is preferably 60 to 99 mass %. Also, the polymer latex in the invention contains acrylic acid or methacrylic acid in an amount of preferably 1 to 6 mass % and more preferably 2 to 5 mass % based on the sum of styrene and butadiene. Also, the polymer latex in the invention preferably contains acrylic acid.

Preferable examples of the latex of a styrene-butadiene copolymer used in the invention include the foregoing P-3 to P-8, P-15 and commercially available product including LACSTAR-3307B, 7132C and Nipol Lx416.

A hydrophilic polymer such as gelatin, polyvinyl alcohol, methyl cellulose, hydroxypropyl cellulose or carboxymethyl cellulose may be compounded in the organic silver salt-containing layer of the photosensitive material of the invention according to the need. The amount of these hydrophilic polymers to be added is 30 mass % or less and more preferably 20 mass % or less based on the all binder of the organic silver salt-containing layer.

The organic silver salt-containing layer (namely, image forming layer) is preferably formed using the polymer latex. As to the amount of the binder in the organic silver salt-containing layer, the mass ratio of all binder/organic silver salt is in a range of 1/10 to 10/1, more preferably 1/3 to 5/1 and still more preferably 1/1 to 3/1.

Such an organic silver salt-containing layer is also usually a photosensitive layer (emulsion layer) in which a photosensitive silver halide which is a photosensitive silver salt is contained. In such a case, the mass ratio of total binder/silver halide is in a range from 400 to 5 and more preferably from 200 to 10.

The total amount of the binder in the image forming layer in the invention is in a range from 0.2 to 30 g/m², more preferably 1 to 15 g/m² and more preferably 2 to 10 g/m². A crosslinking agent for running a crosslinking reaction and a surfactant for improving coatability may be added to the image forming layer according to the invention.

(Preferable Solvent for a Coating Solution)

The solvent (here, a solvent and a dispersion medium are collectively called a solvent for the sake of simplicity) used in the coating solution for the organic silver salt-containing layer in the photosensitive material of the invention is preferably a water-type solvent containing 30 mass % or more of water. As the components other than water, optional water-miscible organic solvents such as methanol, ethanol, isopropyl alcohol, methyl cellosolve, ethyl cellosolve, dimethylformamide and ethyl acetate may be used. The content of water in the solvent used for the coating solution is 50 mass % or more and more preferably 70 mass % or more. Preferable examples of the composition of the solvent include, besides water, water/methanol=90/10, water/methanol=70/30, water/methanol/dimethylformamide=80/15/5, water/methanol/ethyl cellosolve=85/10/5 and water/methanol/isopropyl alcohol=85/10/5 (the values are mass %).

(Explanation of an Antifoggant and the Like)

Examples of an antifoggant, stabilizer and stabilizer precursor include the compounds described in JP-A No. 10-62899, Paragraph No. 0070, the patented products described in European Patent Application Laid-Open No. 0803764A1, page 20, line 57 to page 21, line 7, the compounds described in JP-A Nos. 9-281637 and 9-329864, the compounds described in U.S. Pat. No. 6083,681, U.S. Pat. No. 6,083,681 and EP No. 1048975. Also, the antifoggant preferably used in the invention is organic halides. Examples of these organic halides include those disclosed in JP-A No. 11-65021, Paragraphs No. 0111 to No. 0112. Particularly organic halogen compounds represented by the general formula (P) described in JP-A No. 2000-284399, the organic polyhalogen compounds represented by the general formula (II) described in JP-A No. 10-339934 and the organic polyhalogen compounds described in JP-A Nos. 2001-31644 and 2001-33911 are preferable.

-Explanation of Organic Polyhalogen Compounds-

Organic polyhalogen compounds preferable in the invention will be hereinafter explained in detail. These preferable polyhalogen compounds in the invention are those represented by the following general formula (H).

Q—(Y)ₙ—C(Z₁)(Z₂)X General formula (H)

In the general formula (H), Q represents an alkyl group, an aryl group or a heterocyclic group, Y represents a divalent connecting group, n denotes 0 or 1, Z₁ and Z₂ respectively represent a halogen atom and X represents a hydrogen atom or an electron attractive group.

In the general formula (H), Q preferably represents a phenyl group substituted with an electron attractive group having a positive Hammett's substituent constant σp. Journal of Medicinal Chemistry, 1973, Vol. 16, No. 11, 1207-1216 serves as a reference for the Hammett's substituent constant. Examples of such an electron attractive group include halogen atoms (a fluorine atom (σp value=0.06), chlorine atom (σp value =0.23), bromine atom (σp value=0.23) and iodine atom (σp value=0.18)), trihalomethyl groups (tribromomethyl (σp value=0.29), trichloromethyl (σp value=0.33), trifluoromethyl (σp value=0.54)), cyano groups (σp value=0.66), nitro groups (σp value=0.78), aliphatic•aryl or heterocyclic sulfonyl groups (e.g., methanesulfonyl (σp value=0.72)), aliphatic•aryl or heterocyclic acyl groups (e.g., acetyl (σp value=0.50) and benzoyl (σp value=0.43)), alkinyl groups (e.g., C≡CH (σp value=0.23)), aliphatic•aryl or heterocyclic oxycarbonyl groups (e.g., methoxycarbonyl (σp value=0.45) and phenoxycarbonyl (σp value=0.44)), carbamoyl groups (σp value=0.36), sulfamoyl groups (σp value=0.57), sulfoxide groups, heterocyclic groups and phosphoryl groups. The up value is in a range preferably from 0.2 to 2.0 and more preferably from 0.4 to 1.0. Particularly preferable examples as the electron attractive group are carbamoyl groups, alkoxycarbonyl groups, alkylsulfonyl groups and alkylphosphoryl groups. Among these groups, carbamoyl groups are most preferable.

In the general formula (H), X is preferably an electron attractive group, more preferably a halogen atom, aliphatic•aryl or heterocyclic sulfonyl group, aliphatic•aryl or heterocyclic acyl group, aliphatic•aryl or heterocyclic oxycarbonyl group, carbamoyl group or sulfamoyl group and particularly preferably a halogen atom. Among halogen atoms, a chlorine atom, bromine atom or iodine atom is preferable, a chlorine atom or bromine atom is more preferable and a bromine atom is particularly preferable.

In the general formula (H), Y preferably represents —C(═O)—, —SO—or —SO²—, more preferably —C(═O)— or —SO²— and particularly preferably —SO²— and n denotes 0 or 1 and preferably 1.

Specific examples (exemplified compounds H-1 to H-24) of the compound represented by the general formula (H) will be hereinafter explained; however, the compound represented by the general formula (H) which may be used in the invention is not limited to these examples.

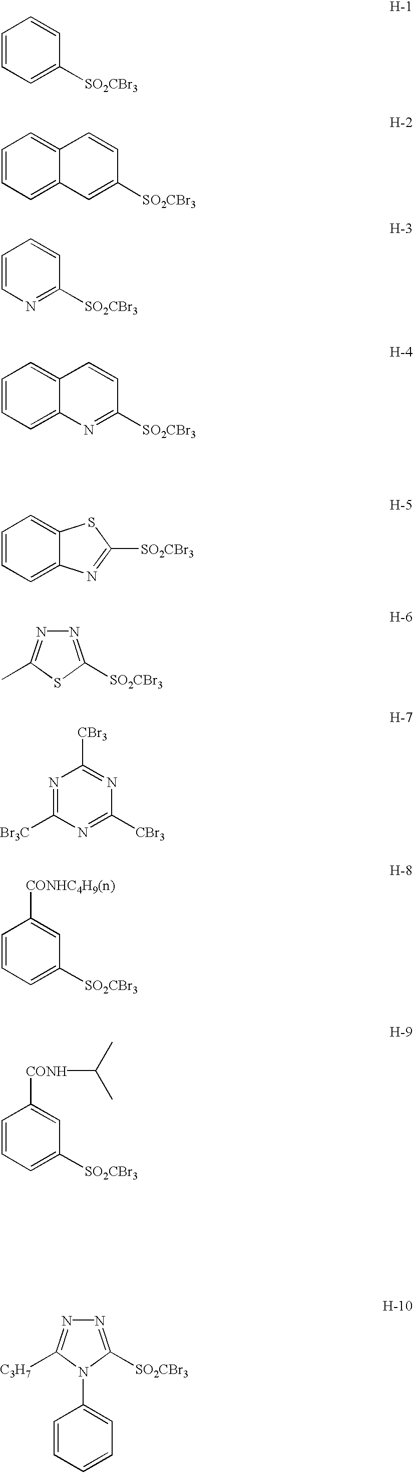

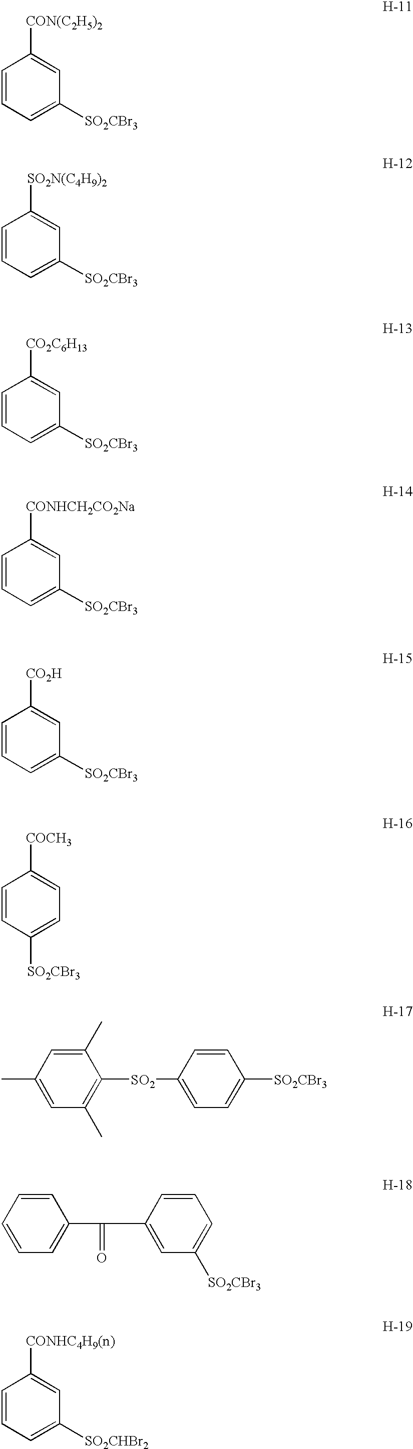

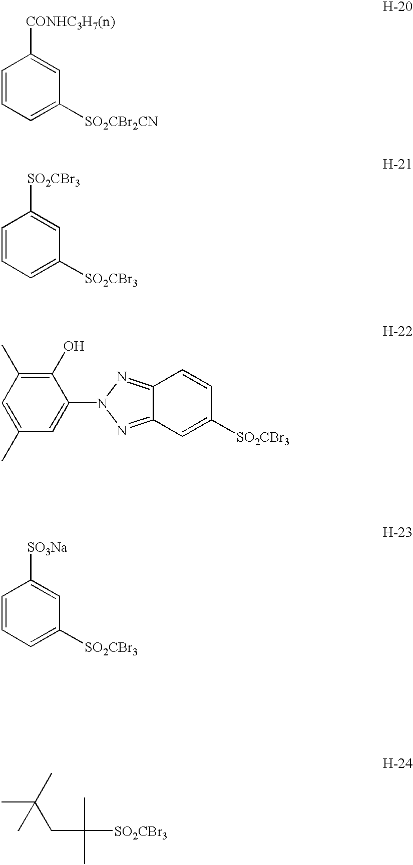

The polyhalogen compound represented by the general formula (H) in the invention is used in an amount ranging preferably from 10⁻⁴ to 1 mol, more preferably 10⁻³ to 0.5 mol and still more preferably 1×10⁻² to 0.2 mol per one mol of the nonphotosensitive silver salt of the image forming layer.

In the invention, as examples of a method for containing an antifoggant in the photosensitive material, the methods described in the method for containing the foregoing reducing agent are given. Also, the organic polyhalogen compound is preferably added in the form of a solid dispersion, more preferably in the form of the solid dispersion in the invention.

-Other Antifoggants-

Examples of other antifoggants include mercury (II) salts described in JP-A No. 11-65021, Paragraph No. 0113, benzoic acids described in the same publication, Paragraph No. 0114, salicylic acid derivatives described in JP-A No. 2000-206642, formalin scavenger compounds represented by the formula (S) in JP-A No. 2000-221634, triazine compounds according to claim 9 described in JP-A No. 11-352624, compounds represented by the general formula (III) described in JP-A No. 6-11791 and 4-hydroxy-6-methyl-1,3,3a,7-tetrazaindene.

The photothermographic material in the invention may contain an azolium salt with the intention of preventing fogging. Examples of the azolium salt include the compounds represented by the general formula (XI) described in JP-A No. 59-193447, the compounds described in JP-B No. 55-12581 and the compounds represented by the general formula (II) described in JP-A No. 60-153039. Although the azolium salt may be added to any position of the photosensitive material, it is preferable to add it to a layer on the side provided with the photosensitive layer and more preferably to the organic silver salt-containing layer. As to the time when the azolium salt is added, it may be added in any step for preparing the coating solution. When the azolium salt is added to the organic silver salt-containing layer, it is preferably added at any time after the organic silver salt is prepared and just before application, though it may be added in any step between the course of the preparation of the organic silver salt and the course of the preparation of the coating solution. The azolium salt may be added in any of the forms of a powder, solution and fine particle dispersion. Also, it may be added as a solution prepared by mixing it with additives such as sensitizing dyes, reducing agents and tinting agents. The amount of the azolium salt to be added in the invention is preferably 1×10⁻⁶ mol or more and 2 mol or less and more preferably 1×10⁻³ mol or more and 0.5 mol or less per 1 mol of silver though it may be any.

Mercapto compounds, disulfide compounds and thion compounds may be contained in the photothermographic material of the invention to control developing, for example, to restrain or to promote developing, to improve spectral sensitization efficiency and to improve the preservability before and after developing. These compounds are described in JP-A No. 10-62899, Paragraphs No. 0067 to 0069 and as compounds represented by the general formula (I) including specific examples of these compounds listed in Paragraphs No. 0033 to 0052 in JP-A No. 10-186572 and also in European Patent Application Laid-open No. 0803764A1, page 20, line 36 to line 56. Among these compounds, mercapto-substituted hetero-aromatic compounds as described in JP-A Nos. 9-297367, 9-304875 and 2001-100358 are preferable.

(Explanation of a Tinting Agent)

The photothermographic material of the invention preferably contains a tinting agent. The tinting agent is described in JP-A No. 10-62899, Paragraphs No. 0054 to No. 0055, the European Patent Application Laid-Open No. 0803764A1, page 21, line 23 to line 48, JP-A No. 2000-356317 and Japanese Patent Application No. 2000-187298. Particularly, phthalazinones (phthalazinone, phthalazinone derivatives or their metal salts; for example, 4-(1-naphthyl)phthalazinone, 6-chlorophthalazinone, 5,7-dimethoxyphthalazinone and 2,3-dihydro-1,4-phthalazinedione); combinations of phthalazinones and phthalic acids (for example, phthalic acid, 4-methylphthalic acid, 4-nitrophthalic acid, diammonium phthalate, sodium phthalate, potassium phthalate and tetrachlorophthalic acid anhydride); phthalazines (phthalazine, phthalazine derivatives or their metal salts; for example, 4-(1-naphthyl)phthalazine, 6-isopropylphthalazine, 6-t-butylphthalazine, 6-chlorophthalazine, 5,7-dimethoxyphthalazine and 2,3-dihydrophthalazine); and combinations of phthalazines and phthalic acids are preferable. Among them, a combination of 6-isopropylphthalazine and phthalic acid or 4-methylphthalic acid is preferable.

In the photothermographic material of the invention, the tinting agent is preferably contained in the coating solution as the solid dispersion of the invention.

(Other Additives)

Plasticizers and lubricants which may be used for the photosensitive layer of the invention are described in JP-A No. 11-65021, Paragraph No. 0117. A super-high contrasting agent used for the formation of super-high contrast images, a method for adding it and its amount are described in JP-A No. 11-65021, Paragraph No. 0118 and JP-A No. 11-223898, Paragraphs No. 0136 to No. 0193, as compounds represented by the formula (H), the formulae (1) to (3) and the formulae (A) and (B) in JP-A No. 2000-284399 and as compounds represented by the general formulae (III) to (V) (specific compounds: Compound 21 to Compound 24) in JP-A No. 11-91652. High-contrasting promoters are described in JP-A No. 11-65021, Paragraph No. 0102 and JP-A No. 11-223898, Paragraphs No. 0194 to No. 0195.

In the case of using formic acid or a formate as a strong foggant, it is preferably added to the side on which the image forming layer containing a photosensitive silver halide is formed in an amount of 5 mmol or less and preferably 1 mmol or less per 1 mol of silver.

In the case of using the super-high contrasting agent in the photothermographic material of the invention, it is preferable to use an acid produced by hydrating diphosphorous pentaoxide or its salt together. Examples of the acid produced by hydrating diphosphorous pentaoxide or its salt may include methaphosphoric acid (salts), pyrophosphoric acid (salts), orthophosphoric acid (salts), triphosphoric acid (salts), tetraphosphoric acid (salts) and hexamethaphosphoric acid (salts). Examples of the acid which are produced by hydrating diphosphorous pentaoxide or its salt and particularly preferably used may include orthophosphoric acid (salts) and hexamethaphosphoric acid (salts). Specific examples of the salt are sodium orthophosphate, dihydrogensodium orthophosphate, sodium hexamethaphosphate and ammonium hexamethaphosphate.

The amount (coating amount per 1 m² of the photosensitive material) of the acid produced by hydrating diphosphorous pentaoxide or its salt to be used is preferably 0.1 to 500 mg/m² and more preferably 0.5 to 100 mg/m² though it may be a proper amount in accordance with the performances such as sensitivity and fogging.

(Explanation of a Layer Structure)

The photothermographic material of the invention may be provided with a surface protective layer for the purpose of, for example, preventing the adhesion of the image forming layer. The surface protective layer may be either a monolayer or a multilayer. There are descriptions concerning the surface protective layer in JP-A No. 11-65021, Paragraph No. 0119 to 0120 and Japanese Patent Application No. 2000-171936.

Although a gelatin is preferable as the binder of the surface protective layer in the invention, it is preferable to use or combine polyvinyl alcohol (PVA). As the gelatin, an inert gelatin (e.g., Nitta Gelatin 750), gelatin phthalate (e.g., Nitta Gelatin 801) or the like may be used. As examples of the PVA, those described in JP-A No. 2000-171936, Paragraphs No. 0009 to 0020 are given and a completely saponified product PVA-105, partially saponified products PVA-205 and PVA-335, a modified polyvinyl alcohol MP-203 (trademarks, manufactured by Kuraray Co., Ltd.) and the like are preferably given. The amount (per 1 m² of the support) of polyvinyl alcohol to be applied in the protective layer (per one layer) is preferably 0.3 to 4.0 g/m² and more preferably 0.3 to 2.0 g/m².

In the case of using the photothermographic material of the invention in printing uses involving a problem concerning a dimensional change, a polymer latex is preferably used in a surface protective layer and a back layer. There are descriptions concerning such a polymer latex in “Synthetic Resin Emulsion (edited by OKUDA Taira and INAGAKI Hiroshi, issued by Polymer Publishing Society (1978)”, “Application of Synthetic Latex (edited by SUGIMURA Takaaki, KATAOKA Yasuo, SUZUKI Souichi and KASAHARA Keiji, issued by Polymer Publishing Society (1993)”, “Chemicals of Synthetic Latex (written by MUROI Souichi, issued by Polymer Publishing Society (1970)” and the like. Specific examples of the polymer latex include a latex of a methylmethacrylate (33.5 mass %)/ethylacrylate (50 mass %)/methacrylic acid (16.5 mass %) copolymer, latex of methylmethacrylate (47.5 mass %)/butadiene (47.5 mass %)/itaconic acid (5 mass %) copolymer, latex of ethylacrylate/methacrylic acid copolymer, latex of methylmethacrylate (58.9 mass %)/2-ethylhexylacrylate (25.4 mass %)/styrene (8.6 mass %)/2-hydroxyethylmethacrylate (5.1 mass %)/acrylic acid (2.0 mass %) copolymer and latex of methylmethacrylate (64.0 mass %)/styrene (9.0 mass %)/butylacrylate (20.0 mass %)/2-hydroxyethylmethacrylate (5.0 mass %)/acrylic acid (2.0 mass %) copolymer. Moreover, a combination of polymer latexes described in Japanese Patent Application No. 11-6872, technologies described in Japanese Patent Application No. 11-143058, Paragraphs No. 0021 to No. 0025, technologies described in Japanese Patent Application No. 11-6872, Paragraphs No. 0027 to No. 0028 and technologies described in Japanese Patent Application No. 10-199626, Paragraphs No. 0023 to No. 0041 may be applied to the binder of the surface protective layer. The ratio of the polymer latex in the surface protective layer is preferably 10 mass % or more and 90 mass % or less and particularly preferably 20 mass % or more and 80 mass % or less based on all binder.

The amount (per 1 m² of the support) of all binder (including a water-soluble polymer and latex polymer) to be applied in the surface protective layer (per one layer) is preferably 0.3 to 5.0 g/m² and more preferably 0.3 to 2.0 g/m².

The temperature for the preparation of the image forming layer coating solution in the invention is preferably 30° C. or more and 65° C. or less, more preferably 35° C. or more and less than 60° C. and still more preferably 35° C. or more and 55° C. or less. Also, the image forming layer coating solution just after the polymer latex is added is preferably kept at a temperature of 30° C. or more and 65° C. or less.

The image forming layer in the invention is constituted of one or more layers on the support. When the image forming layer is constituted of one layer, this layer contains an organic silver salt, a photosensitive silver halide, a reducing agent and a binder, and if necessary, additional desirable materials such as a tinting agent, a coating adjuvant and other auxiliary agents. When the image forming layer is constituted of two or more layers, it is necessary that an organic silver salt and a photosensitive silver halide are contained in the first image forming layer (usually, a layer adjacent to the support) and several other components are contained in the second image forming layer or in both layers. In the structure of a multicolor photosensitive heat developing photographic material (photothermographic material), the combination of these two layers may be contained every color, and also, all components may be contained in a single layer as described in U.S. Pat. No. 4,708,928. In the case of a multi dye multicolor photosensitive heat developing photographic material (photothermographic material), emulsion layers are usually kept isolated from each other by interposing functional or nonfunctional barrier layers between each photosensitive layer as described in U.S. Pat. No. 4,460,681.

In the photosensitive layer according to the invention, various dyes and pigments (e.g., C.I. Pigment Blue 60, C.I. Pigment Blue 64, C.I. Pigment Blue 15:6) may be used from the viewpoint of the improvement of the tone, prevention of the generation of interference fringe during exposure using a laser and prevention of irradiation. These dyes and pigments are described in detail in WO98/36322, JP-A Nos. 10-268465 and 11-338098.

In the photothermographic material of the invention, an antihalation layer may be disposed on the side far from a light source with respect to the photosensitive layer.

The photothermographic material is generally provided with a nonphotosensitive layer in addition to a photosensitive layer. The nonphotosensitive layer may be classified into the following layers based on its arrangement: (1) a protective layer disposed on (on the side far from the support) the photosensitive layer, (2) an intermediate layer disposed between plural photosensitive layers and between the photosensitive layer and the protective layer, (3) an undercoat layer disposed between the photosensitive layer and the support and (4) a back layer disposed on the side opposite to the photosensitive layer. A filter layer is disposed as the layer of (1) or (2) in the photosensitive material. The antihalation layer is disposed as the layer of (3) or (4) in the photosensitive layer.

There are descriptions concerning the antihalation layer in, for example, JP-A No. 11-65021, Paragraphs No. 0123 to No. 0124, JP-A Nos. 11-223898, 9-230531, 10-36695, 10-104779, 11-231457, 11-352625 and 11-352626.

An antihalation dye having absorption in the wavelength of exposure light is contained in the antihalation layer. When the wavelength of exposure light is in the infrared region, an infrared absorbing dye may be used. In this case, a dye having no absorption in the visible range is preferable.

In the case of preventing halation by using a dye having absorption in the visible range, it is not preferable that the color of the dye be substantially left after an image is formed, it is preferable to use measures for discoloring by the heat of heat developing and it is particularly preferable to make the nonphotosensitive layer function as an antihalation layer by adding a thermally discoloring dye and a basic precursor thereto. There are descriptions concerning these technologies in JP-A No. 11-231457.

The amount of the discoloring dye to be added is determined based on its use. Generally, the dye is used in such an amount that the optical density (absorbance) measured at an intended wavelength exceeds 0.1. The optical density is preferably 0.15 to 2 and more preferably 0.2 to 1. The amount of the dye to be used for obtaining such an optical density is generally about 0.001 to 1 g/m².

If the dye is discolored in this manner, the optical density after heat developing can be lowered to 0.1 or less. Two or more discoloring dyes may be used together in thermally discoloring type recording materials and photothermographic materials. Like the above, two or more base precursors may be used together.

In thermal discoloration using such a discoloring dye and a basic precursor, it is preferable to use a material (e.g., diphenylsulfone or 4-chlorophenyl(phenyl)sulfone) which lowers the melting point by 3° C. (deg) or more if it is mixed with a base precursor as described in JP-A No. 11-352626, 2-naphthyl benzoate or the like in view of thermally discoloring ability.

In the invention, a colorant having an absorption maximum at 300 to 450 nm may be added with the view of improving silver tone and a change in an image with time. There are descriptions concerning such a colorant in JP-A Nos. 62-210458, 63-104046, 63-103235, 63-208846, 63-306436, 63-314535, 01-61745 and 2001-100363.

Such a colorant is added in an amount ranging between 0.1 mg/m² and 1 g/m². A layer to which the colorant is added is preferably the back layer disposed on the side opposite to the photosensitive layer.

The photothermographic material of the invention is preferably a single-sided photosensitive material provide with at least one photosensitive layer containing a silver halide emulsion on at least one side of the support and a back layer on the other side.

(Explanation of a Matting Agent)

In the invention, it is preferable to add a matting agent to improve carrying ability. There are descriptions concerning the matting agent in JP-A No. 11-65021, Paragraphs No. 0126 to No. 0127. The amount of the matting agent is preferably 1 to 400 mg/m² and more preferably 5 to 300 mg/m² when it is indicated by a coating amount per 1 m² of the photosensitive material.

The shape of the matting agent is preferably a defined shape and a spherical shape is used more preferably though it may be either a defined shape or an undefined shape. Also, the average particle diameter of the matting agent is preferably 0.5 to 10 μm, more preferably 1.0 to 8.0 μm and still more preferably 2.0 to 6.0 μm. Further, the coefficient of variation in the distribution of size is preferably 50% or less, more preferably 40% or less and still more preferably 30% or less. Here, the coefficient of variation means the value calculated from the following equation: {(standard deviation in particle diameter)/(average of particle diameter)}×100. Also, it is preferable to use two matting agents which have a small coefficient of variation and of which the ratio of the average particle diameters is 3 or more.

Although the degree of matting on the surface of the emulsion may be any as far as no star dust failure takes place, the Beck smoothness of the surface is preferably 30 seconds or more and 2000 seconds or less and particularly preferably 40 seconds or more and 1500 seconds or less. The Beck smoothness can be easily found with reference to Japanese Industrial Standard (JIS) P8119 “Test Method of Smoothness of Paper and Board by Beck tester” and TAPPI Standard Method T479.

With regard to the degree of matting of the back layer in the invention, the Beck smoothness is preferably 1200 seconds or less and 10 seconds or more, more preferably 800 seconds or less and 20 seconds or more and still more preferably 500 seconds or less and 40 seconds or more.

In the invention, the matting agent is preferably contained in the outermost surface layer or a layer which functions as the outermost surface layer or a layer close to the external surface and also preferably contained in a layer working as a so-called protective layer.

There are descriptions as to the back layer which may be applied to the invention in JP-A No. 11-65021, Paragraphs No. 0128 to 0130.

The film surface pH of the photothermographic material of the invention is preferably 7.0 or less and more preferably 6.6 or less before heat developing treatment. The lower limit is about 3 though there is no particular limitation to it. The pH is most preferably in a range from 4 to 6.2. As to the control of the film surface pH, it is preferable to use an organic acid such as a phthalic acid derivative, a nonvolatile acid such as sulfuric acid or a volatile base such as ammonia from the viewpoint of lowering the film surface pH. Particularly, ammonia is easily vaporized so that it can be removed before a coating process and heat developing and is there preferable to accomplish low film surface pH.

Also, a combination of a nonvolatile base such as sodium hydroxide, potassium hydroxide or lithium hydroxide and ammonia is preferably used. There are descriptions as to a method of measuring the film surface pH in Japanese Patent Application No. 11-87297, Paragraph No. 0123.

A hardener may be used in each layer such as the photosensitive layer, protective layer and back layer in the photothermographic material of the invention. As to examples of the hardener, there is each method described in T. H. James “THE THEORY OF THE PHOTOGRAPHIC PROCESS FOURTH EDITION” (published by Macmillan Publishing Co., Inc, 1977), page 77 to page 87, showing examples of the hardener including chrome arum, 2-4-dichloro-6-hydroxy-s-triazine sodium salt, N,N-ethylenebis(vinylsulfonacetamide) and N,N-propylenebis(vinylsulfonacetamide). Other than the above, polyvalent metal ions described in the same document, page 78 etc., polyisocyanates described in U.S. Pat. No. 4,281,060 and JP-A No. 6-208193, epoxy compounds described in U.S. Pat. No. 4,791,042 and vinylsulfone type compounds described in JP-A No. 62-89048 are preferably used.

The hardener is added in a solution state and this solution is added to a protective layer coating solution at any time between 180 minutes and just before a coating operation and preferably between 60 minutes and 10 seconds before a coating operation. However, no particular limitation is imposed on mixing methods and mixing conditions as far as the effect of the invention is sufficiently produced. As specific mixing method, there are a method in which the hardener is mixed in a tank where the average residence time calculated from the flow rate of the hardener to be added and the rate of a solution fed to a coater accords to a desired time and a method using a static mixer as described in N. Harnby, M. F. Edwards, A. W. Nienow, translated by TAKAHASHI Koji “Liquid Mixing Technologies” (published by The Nikkann Kogyo Shimbun, Ltd., 1989), Chapter 8 and the like.

There are descriptions concerning the following materials which may be applied to the photothermographic material of the invention: a surfactant in Paragraph No. 0132, a solvent in Paragraph No. 0133, a support in Paragraph No. 0134 and an antistatic or conductive layer in Paragraph No. 0135 and there are also descriptions concerning a method for obtaining a color image in Paragraph No. 0136 of JP-A No. 11-65021 and a lubricant in Paragraphs No. 0061 to No. 0064 of JP-A No. 11-84573 and in Paragraphs No. 0049 to No. 0062 of JP-A No. 11-106881.

In the photothermographic material of the invention, it is preferable to dispose a conductive layer containing a metal oxide. As the conductive materials of the conductive layer, metal oxides increased in conductivity by introducing oxygen defects and dissimilar metal atoms thereinto are preferably used. As examples of the metal oxide, ZnO, TiO₂ and SnO₂ are preferable. Al and In are preferably added to ZnO₂, Sb, Nb, P, halogen atoms and the like are preferably added to SnO₂ and Nb, Ta and the like are preferably added to TiO₂. Particularly SnO₂ to which Sb is added is preferable. The amount of the dissimilar atom is in a range preferably from 0.01 to 30 mol % and more preferably from 0.1 to 10 mol %. Although the shape of the metal oxide may be any of a globular form, needle form and tabular form, needle particles having a major axis/minor axis ratio of 2.0 or more and preferably 3.0 to 50 are preferable. The amount of the metal oxide to be used is in a range from 1 mg/m² to 1000 mg/m², more preferably 10 mg/m² to 500 mg/m² and still more preferably 20 mg/m² to 200 mg/m². The conductive layer in the photothermographic material of the invention is preferably disposed between the support and the back layer though it may be disposed on any of both sides of the emulsion and both sides of the backside. Specific examples of the conductive layer are described in JP-A Nos. 7-295146 and 11-223901.

In the photothermographic material of the invention, it is preferable to use a fluorine type surfactant. Specific examples of the fluorine type surfactant include compounds described in JP-A Nos. 10-197985, 2000-19680 and 2000-214554. Also, high molecular fluorine type surfactants as described in JP-A No. 9-281636 are preferably used. In the invention, the use of fluorine type surfactants as described in JP-A No. 2000-206560 is particularly preferable.

(Explanation of the Support)

The support in the photothermographic material of the invention is preferably transparent though it may be transparent or non-transparent.

As a transparent support, a polyester and particularly polyethylene terephthalate which is processed by heat treating at a temperature ranging from 130 to 185° C. is preferably used to relieve an internal strain remaining in a film during biaxial stretching and to eliminate a thermal shrinkage strain caused during heat developing treatment. In the case of photothermographic materials for medical uses, the transparent support may be colored using a blue dye (e.g., the dye-1 described in Examples of JP-A No. 8-240877) or non-colored. It is preferable to apply technologies for the undercoating of, for example, water-soluble polyesters as described in JP-A No. 11-84574, styrene butadiene copolymers as described in JP-A No. 10-186565 and vinylidene chloride copolymers as described in JP-A No. 2000-39684 and Japanese Patent Application No. 11-106881, Paragraphs No. 0063 to No. 0080. Also, technologies as described in JP-A Nos. 56-143430, 56-143431, 58-62646, 56-120519, 11-84573, Paragraphs No. 0040 to No. 0051, U.S. Pat. No. 5,575,957 and JP-A No. 11-223898, Paragraphs No. 0078 to No. 0084 may be applied to an antistatic layer or undercoating.

(Others)

The photothermographic material of the invention is preferably a monosheet type (a type enabling the formation of an image on the photothermographic material without using other sheets such as an image receptor material).

An antioxidant, stabilizer, plasticizer, ultraviolet absorber and coating adjuvant may be further added to the photothermographic material of the invention. Various additives are added to either the photosensitive layer or the nonphotosensitive layer. WO98/36322, EP803764A1, JP-A Nos. 10-186567 and 10-18568 may serve as references for these additives.

<Production of the Photothermographic Material>

The photothermographic material of the invention may be applied using any method. Specifically, various coating operations are used which include extrusion coating, slide coating, curtain coating, dip coating, knife coating, flow coating or extrusion coating using a hopper of a type as described in U.S. Pat. No. 2,681,294. Extrusion coating as described in Stephen F. Kistler, Petert M. Schweizer “LIQUID FILM COATING” (published by CHAPMAN & HALL, 1977), page 399 to page 536 or slide coating is preferably used and slide coating is used particularly preferably. Examples of the shape of a slide coater used for slide coating are described in FIG. 11b. 1 on page 427 in the above document. Also, as desired, two layers or more layers can be formed by coating at the same time according to a method as described in the same document, page 399 to page 536 or methods as described in U.S. Patent No. 2,761,791 and U.K. Patent No. 837,095.

In the photothermographic material of the invention, the organic silver salt-containing layer coating solution is preferably a thixotropic fluid. The JP-A No. 11-52509 may serve as a reference for the technologies concerned. The viscosity of the organic silver salt-containing layer coating solution of the invention at a shear rate of 0.1 S⁻¹ is preferably 400 mPa·s or more and 100,000 mPa·s or less and more preferably 500 mPa·s or more and 20,000 mPa·s or less. Also, the viscosity at a shear rate of 1000 S⁻¹ is preferably 1 mPa·s or more and 200 mPa·s or less and more preferably 5 mPa·s or more and 80 mPa·s or less.

Examples of technologies which may be used for the photothermographic material of the invention include those described in EP803764A1, EP883022A1, WO98/36322 and each JP-A Nos. 56-62648, 58-62644,9-43766, 9-281637, 9-297367, 9-304869,9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420and Japanese Patent Applications Nos. 2000-187298, 2000-10229, 2000-47345, 2000-206642, 2000-98530, 2000-98531, 2000-112059, 2000-112060, 2000-112104, 2000-112064 and 2000-171936.

(Explanation of a Packaging Material)

The photosensitive material of the invention is preferably packaged with a packaging material having a low oxygen permeability and/or moisture permeability to suppress a variation in photographic characteristics during live storage or to improve curling and winding tendency. The oxygen permeability is preferably 50 ml/atm·m²·day or less, more preferably 10 ml/atm·m²·day or less and still more preferably 1.0 ml/atm·m²·day or less at 25° C. The moisture permeability is preferably 10 g/atm·m²·day or less, more preferably 5 g/atm·m²·day or less and still more preferably 1 g/atm·m²·day.

Specific examples of the aforementioned packaging material having a low oxygen permeability and/or a low moisture permeability include packaging materials described in each specification of JP-A Nos. 8-254793 and 2000-206653.

(Explanation of Heat Developing)

Although the photothermographic material of the invention may be developed using any method, it is usually developed by raising the temperature of the photothermographic material exposed imagewise. The developing temperature is preferably 80 to 250° C., more preferably 100 to 140° C. and still more preferably 100 to 130° C. The developing time is preferably 1 to 60 seconds, more preferably 3 to 30 seconds, still more preferably 5 to 25 seconds and particularly preferably 7 to 15 seconds.

As a heat developing system, a plate heater system is preferable though any of a drum type heater and plate type heater may be used. As a heat developing system using the preheater system, a method as described in JP-A No. 11-133572 is preferably used. This system is a heat developing apparatus in which a photothermographic material formed with a latent image is brought into contact with a heating means in a heat developing section to obtain a visible image, the heating means comprising a plate heater and plural pressure rollers being arranged opposite to each other between the pressure rollers and the plate heater along one side of the plate heater, wherein the photothermographic material is made to pass between the pressure rollers and the plate heater to carry out heat developing. It is desirable that the plate heater be divided into 2 to 6 stages and the temperature of the end section be lowered by about 1 to 10° C. An example is given in which 4 plate heater sets which can be independently controlled are used and respectively controlled such that each temperature is 112° C., 119° C., 121° C. and 120° C. Such a method is also described in JP-A No. 54-30032. In this method, water and organic solvents contained in the photothermographic material are excluded externally from the system and also, a change in the shape of the support of the photothermographic material as the result of rapid heating of the photothermographic material can be restricted.

Although the photosensitive material may be exposed to light by using any method, laser light is preferable as the exposure light source. As the laser light in the invention, a gas laser (Ar⁺, He—Ne), YAG laser, dye laser, semiconductor laser or the like is preferable. Also, a semiconductor laser and a second harmonic generating element may be used. A gas or semiconductor laser emitting infrared-near-infrared light is preferable.

As a medical laser imager provided with an exposure section and a heat developing section, Fuji Medical Dry Laser Imager FM-DP L may be exemplified. There are descriptions concerning FM-DP L in Fuji Medical Review No. 8, page 39 to 55. It is needless to say that these technologies may be applied to a laser imager of the photothermographic material of the invention. These technologies also allow the photothermographic material of the invention to be applied to that for a laser imager in the “AD network” proposed by Fuji Medical System as a network system adapted to the DICOM standard.

The photothermographic material of the invention forms a monochrome image of a silver image and is preferably used as photothermographic materials for medical diagnosis, photothermographic materials for industrial photographs, photothermographic materials for printing use and photothermographic materials for COM.

### EXAMPLES

The present invention will be explained in detail by way of examples, which are, however, are not intended to be limiting of the invention.

### Example 1

Solid Dispersion

<<Preparation of a Solid Dispersion-1 of an Organic Polyhalogen Compound>>

10 kg of an organic polyhalogen compound-1 (exemplified compound (H-8)) was added to a solution, prepared by mixing 20 kg of an aqueous 10 mass % solution of modified polyvinyl alcohol (Poval MP203, manufactured by Kuraray Co., Ltd.), 0.4 kg of an aqueous 20 mass % solution of sodium triisopropylnaphthalenesulfonate and 4 kg of water at ambient temperature by stirring using a propeller, over about 20 minutes to prepare a slurry solution. This slurry was fed by a diaphragm pump to a horizontal sand mill (UVM-2: manufactured by I.mecs) filled with zirconia beads having an average diameter of 0.5 mm and was dispersed in the horizontal sand mill for 5 hours in a path system. The dispersed slurry was subjected to filtration using a Filter FE-10 (made of polypropylene, pore diameter of the filter: 10.0 μm) and then the dispersion was treated under heat at 40° C. for 5 hours. Thereafter, the dispersion was so adjusted that the concentration of the organic polyhalogen compound was 30 mass % by adding 0.2 g of benzoisothiazolinone sodium salt and water. The dispersion was then subjected to filtration using a Filter FC-3 (made of polypropylene, pore diameter of the filter: 3.0 μm) manufactured by Fuji Photo Film Co., Ltd. to remove foreign substances such as dust and the filtrate was stored.

The details (median diameter, the viscosities (10° C. and 25° C.) of the solid dispersion, the specific gravity of the dispersoid and the average settling velocity (e.g., 10° C. and 25° C.) of the dispersoid) of the resulting solid dispersion-1 of an organic polyhalogen compound (hereinafter referred to as “organic polyhalogen compound dispersion-1” as the case may be) are shown in Table 1 and Table 2.

<<Preparation of Solid Dispersions-2 to 24 of an Organic Polyhalogen Compound>>

Solid dispersions-2 to 24 were produced in the same manner as in the preparation of the solid dispersion-1 of an organic polyhalogen compound except that in the preparation of the solid dispersion-1 of an organic poluhalogen compound, the median diameter was changed by changing the dispersing time, the viscosity of the solid dispersion was changed by changing the type and concentration of the organic polyhalogen compound or dispersant and the specific gravity of the dispersoid was changed by changing the type of organic polyhalogen compound as shown in Table 1. The details of the resulting solid dispersion are shown in Table 1 and Table 2.

<Evaluation of the Solid Dispersions>

The resulting solid dispersions-1 to 24 were each placed in a 30-cm-long glass column and stored in the following storing conditions (1) to (4). Thereafter, the upper portion and lower portion of the dispersion were sampled in an amount of 3 mg each and the concentration of each portion was measured to evaluate according to the following standard.

<Storing Condition>

Storing condition (1): stored in a refrigerated condition (8° C.) for one month

Storing condition (2): stored in a refrigerated condition (8° C.) for three months

Storing condition (3): stored at ambient temperature for one month Storing condition (4): stored at ambient temperature for three month.

<Standard>

◯: A difference in concentration between the upper portion and the lower portion in the container is within 2% and no precipitate is observed.

Δ: A difference in concentration between the upper portion and the lower portion in the container is within 2 to 5% and a little precipitate is observed, which, however, gives rise to no practical problem.

X: A difference in concentration between the upper portion and the lower portion is 5% or more and precipitates are clearly observed in the container.

Table 1

| | | | Concentration | | Amount of | | | | | |
|---|---|---|---|---|---|---|---|---|---|---|
| | | | of The | | The Dispersant | | Specific | | | |
| Solid | | Dispersing | Polyhalogen | | (%) Based on | Median | Gravity of | Viscosity | Viscosity | |
| Dispersion | Exemplified | Time | Compound | Type of | The Polyhalogen | Diameter | The | η₁₀) | (η₂₅ ) | |
| No. | Compound | (Hours) | (Mass %) | Dispersant | Compound | (μm) | Dispersoid | (Pa · s) | (Pa · s) | Remarks |
| 1 | H-8 | 5 | 30 | MP-203 | 20 | 0.52 | 2.034 | 0.200 | 0.100 | Invention |
| 2 | H-8 | 2 | 30 | MP-203 | 20 | 0.75 | 2.034 | 0.196 | 0.098 | Invention |
| 3 | H-8 | 10 | 30 | MP-203 | 20 | 0.48 | 2.034 | 0.202 | 0.102 | Invention |
| 4 | H-8 | 20 | 30 | MP-203 | 20 | 0.32 | 2.034 | 0.198 | 0.105 | Invention |
| 5 | H-8 | 1 | 30 | MP-203 | 20 | 1.50 | 2.034 | 0.201 | 0.100 | Comparative |
| Example | | | | | | | | | | |
| 6 | H-8 | 2 | 25 | MP-203 | 20 | 0.78 | 2.034 | 0.048 | 0.028 | Comparative |
| Example | | | | | | | | | | |
| 7 | H-8 | 5 | 25 | MP-203 | 20 | 0.53 | 2.034 | 0.050 | 0.029 | Example |
| | | | | | | | | | | Comparative |
| 8 | H-8 | 10 | 25 | MP-203 | 20 | 0.50 | 2.034 | 0.054 | 0.027 | Comparative |
| | | | | | | | | | | Example |
| 9 | H-8 | 20 | 25 | MP-203 | 20 | 0.42 | 2.034 | 0.060 | 0.030 | Invention |
| 10 | H-8 | 5 | 25 | MP-203 | 25 | 0.53 | 2.034 | 0.175 | 0.090 | Invention |
| 11 | H-8 | 5 | 30 | MP-203 | 10 | 0.53 | 2.034 | 0.045 | 0.022 | Comparative |
| | | | | | | | | | | Example |
| 12 | H-8 | 5 | 25 | PVA-217 | 20 | 0.41 | 2.034 | 0.230 | 0.120 | Invention |
| 13 | H-8 | 5 | 30 | PVA-217 | 10 | 0.55 | 2.034 | 0.198 | 0.098 | Invention |
| 14 | H-8 | 5 | 30 | PVA-205 | 20 | 0.51 | 2.034 | 0.220 | 0.110 | Invention |
| 15 | H-8 | 5 | 30 | PVA-205 | 10 | 0.65 | 2.034 | 0.170 | 0.084 | Invention |
| 16 | H-8 | 5 | 30 | HEC(※1) | 20 | 0.49 | 2.034 | 0.212 | 0.112 | Invention |
| 17 | H-8 | 5 | 30 PAAm(※2) | 25 | 0.65 | 2.034 | 0.162 | 0.080 | Invention | |
| 18 | H-2 | 5 | 30 | MP-203 | 20 | 0.55 | 2.08 | 0.185 | 0.092 | Invention |
| 19 | H-4 | 5 | 30 | MP-203 | 20 | 0.54 | 2.075 | 0.174 | 0.087 | Invention |
| 20 | H-7 | 20 | 30 | MP-203 | 20 | 0.35 | 2.322 | 0.183 | 0.095 | Invention |
| 21 | H-12 | 10 | 30 | MP-203 | 20 | 0.46 | 1.995 | 0.165 | 0.092 | Invention |
| 22 | H-3 | 10 | 30 | MP-203 | 20 | 0.56 | 2.012 | 0.101 | 0.101 | Invention |
| 23 | H-21 | 10 | 30 | MP-203 | 20 | 0.53 | 2.212 | 0.184 | 0.097 | Invention |
| 24 | H-1 | 10 | 26 | MP-203 | 20 | 0.54 | 2.022 | 0.090 | 0.040 | Invention |

※1: Hydroxyethyl Cellulose
※2: Polyacrylamide

TABLE 2

| | | | Storage | Storage | Storage | Storage | |
|---|---|---|---|---|---|---|---|
| | Average | Average | Condition\mathring{1} | Condition\mathring{2} | Condition\mathring{3} | Condition\mathring{4} | |
| Solid | Settling | Settling | Refrigerated, | Refrigerated, | Ambient | Ambient | |
| Dispersion | Velocity | Velocity | One | Three | Temperature, | Temperature, | |
| No. | (V₁₀) | (V25) | Month | Month | One Month | Three Month | Remarks |
| 1 | 7.61 × 10⁻⁷ | 1.52 × 10⁻⁶ | ◯ | ◯ | ◯ | ◯ | Invention |
| 2 | 1.62 × 10⁻⁶ | 3.23 × 10⁻⁶ | ◯ | ◯ | ◯ | Δ | Invention |
| 3 | 6.42 × 10⁻⁷ | 1.27 × 10⁻⁶ | ◯ | ◯ | ◯ | ◯ | Invention |
| 4 | 2.91 × 10⁻⁷ | 5.49 × 10⁻⁷ | ◯ | ◯ | ◯ | ◯ | Invention |
| 5 | 6.30 × 10⁻⁶ | 1.27 × 10⁻⁵ | ◯ | Δ | Δ | X | Comparative |
| | | | | | | | Example |
| 6 | 7.14 × 10⁻⁶ | 1.22 × 10⁻⁵ | Δ | X | X | x | Comparative |
| | | | | | | | Example |
| 7 | 3.16 × 10⁻⁶ | 5.45 × 10⁻⁶ | ◯ | Δ | Δ | X | Comparative |
| | | | | | | | Example |
| 8 | 2.61 × 10⁻⁶ | 5.21 × 10⁻⁶ | ◯ | Δ | Δ | X | Comparative |
| | | | | | | | Example |
| 9 | 1.66 × 10⁻⁶ | 3.31 × 10⁻⁶ | ◯ | ◯ | ◯ | Δ | Invention |
| 10 | 9.04 × 10⁻⁷ | 1.76 × 10⁻⁶ | ◯ | ◯ | ◯ | ◯ | Invention |
| 11 | 3.51 × 10⁻⁶ | 7.19 × 10⁻⁶ | Δ | X | Δ | X | Comparative |
| | | | | | | | Example |
| 12 | 4.11 × 10⁻⁷ | 7.89 × 10⁻⁷ | ◯ | ◯ | ◯ | ◯ | Invention |
| 13 | 8.60 × 10⁻⁷ | 1.74 × 10⁻⁶ | ◯ | ◯ | ◯ | ◯ | Invention |
| 14 | 6.66 × 10⁻⁷ | 1.33 × 10⁻⁶ | ◯ | ◯ | ◯ | ◯ | Invention |
| 15 | 1.40 × 10⁻⁶ | 2.83 × 10⁻⁶ | ◯ | ◯ | ◯ | ◯ | Invention |
| 16 | 6.38 × 10⁻⁷ | 1.21 × 10⁻⁶ | ◯ | ◯ | ◯ | ◯ | Invention |
| 17 | 1.47 × 10⁻⁶ | 2.97 × 10⁻⁶ | ◯ | Δ | ◯ | Δ | Invention |
| 18 | 9.61 × 10⁻⁷ | 1.93 × 10⁻⁶ | ◯ | ◯ | ◯ | ◯ | Invention |
| 19 | 9.81 × 10⁻⁷ | 1.96 × 10⁻⁶ | ◯ | ◯ | ◯ | ◯ | Invention |
| 20 | 4.82 × 10⁻⁷ | 9.28 × 10⁻⁷ | ◯ | ◯ | ◯ | ◯ | Invention |
| 21 | 6.95 × 10⁻⁷ | 1.25 × 10⁻⁸ | ◯ | ◯ | ◯ | ◯ | Invention |
| 22 | 1.71 × 10⁻⁶ | 1.71 × 10⁻⁶ | ◯ | ◯ | ◯ | ◯ | Invention |
| 23 | 1.01 × 10⁻⁶ | 1.91 × 10⁻⁶ | ◯ | ◯ | ◯ | ◯ | Invention |
| 24 | 1.80 × 10⁻⁶ | 4.06 × 10⁻⁶ | ◯ | Δ | ◯ | Δ | Invention |

As shown in Table 2, it was found that the solid dispersions of a polyhalogen compound, the dispersoid of which had an average settling velocity (v₂₆) of 5.0×10⁻⁶ mm/sec or less at 26° C. and the solid dispersions of a polyhalogen compound, the dispersoid of which had an average settling velocity (v₁₀) of 2.5×10⁻⁶ mm/sec or less at 10° C. were decreased in concentration in the storing container and had high stability with time.

### Example 2

Photothermographic Material

(Production of a PET Support)

PET having an intrinsic viscosity IV of 0.66 (measured at 25° C. in phenol/tetrachloroethane (6/4, mass ratio) was obtained using terephthalic acid and ethylene glycol according to a usual method. After this PET was pelletized, it was dried at 130° C. for 4 hours and extruded from a T-type die after it was melted at 300° C., followed by cooling acutely, to manufacture an non-oriented film having such a thickness that the film thickness after the film was thermally fixed was 175 μm.

The resulting film was vertically stretched 3.3 times by using rolls differing in peripheral speed and horizontally stretched 4.5 times by using a tenter. Each temperature at these stretching operations was 110° C. and 130° C. After that, the film was thermally fixed at 240° C. for 20 seconds and then relaxed by 4% at the same temperature in a horizontal direction. The portion of the film which portion was chucked by the tenter was slit, then subjected to knurl processing of both ends and rolled under a pressure of 4 kg/cm² to obtain a roll 175 μm in thickness.

(Surface Corona Treatment)

Both surfaces of the support were treated at ambient temperature at 20 m/min. by using a solid state corona processor 6 KVA model by Piror. It was found that the support was processed by a treatment of 0.375 kV·A·min./m². At this time, treating frequency was 9.6 kHz and the gap clearance between the electrode and the dielectric roll was 1.6 mm.

(Production of the Undercoated Support)

| (1) Production of an undercoat layer coating solution | | |
|---|---|---|
| General formulation (1) (for an undercoat layer on the side of | | |
| the photosensitive layer) | | |
| PES resin A-520 (30 mass % solution) manufactured by | 59 | g |
| Takamatsu Oil & Fat Co., Ltd. | | |
| 10 mass % solution of polyethylene glycol monononyl phenyl | 5.4 | g |
| ether (average ethylene oxide number = 8.5) | | |
| MP-1000 (polymer microparticle, average particle diameter: | 0.91 | g |
| 0.4 μm) manufactured by Soken Chemical & | | |
| Engineering Co., Ltd. | | |
| Distilled water | 935 | ml |
| General formulation (2) (for a backside first layer) | | |
| Styrene/butadiene copolymer latex (solid content: | 158 | g |
| 40 mass %, ratio by weight of styrene/butadiene = 68/32 | | |
| 8 mass % solution of 2,4-dichloro-6-hydroxy-S-triazine | 20 | g |
| sodium salt | | |
| Aqueous 1 mass % solution of sodium laurylbenzenesulfonate | 10 | ml |
| Distilled water | 854 | ml |
| General formulation (3) (backside second layer) | | |
| SnO₂/SbO (mass ratio: 9/1, average particle diameter: | 84 | g |
| 0.038 μm, 17 mass % dispersion) | | |
| Gelatin (aqueous 10 mass % solution) | 89.2 | g |
| Metorose TC-5 (aqueous 2 mass % solution) manufactured by | 8.6 | g |
| Shin-Etsu Chemical Co., Ltd.) | | |
| MP-1000 manufactured by Soken Chemical & | 0.01 | g |
| Engineering Co., Ltd. | | |
| Aqueous 1 mass % solution of sodium | 10 | ml |
| dodecylbenzenesulfonate | | |
| NaOH (1 mass %) | 6 | ml |
| Proxel (manufactured by ICI) | 1 | ml |
| Distilled water | 805 | ml |

Both surfaces of the above biaxially stretched polyethylene terephthalate support 175 μm in thickness were processed by the aforementioned corona discharge treatment. Then, one surface (photosensitive layer side) was coated with the foregoing undercoat coating solution having the general formulation (1) by a wire bar such that the wet coating amount was 6.6 ml/m² (per one surface) followed by drying at 180° C. for 5 minutes. In succession, the opposite surface (backside) was coated with the foregoing undercoat coating solution having the general formulation (2) by a wire bar such that the wet coating amount was 5.7 ml/m² followed by drying at 180° C. for 5 minutes and further, this opposite surface (backside) was coated with the foregoing undercoat coating solution having the general formulation (3) by a wire bar such that the wet coating amount was 7.7 ml/m² followed by drying at 180° C. for 6 minutes, to produce an undercoated support.

(Preparation of a Backside Coating Solution)

(Preparation of a Solid Microparticle Dispersion Solution (a) of a Base Precursor)

64 g of a base precursor compound-1, 28 g of diphenylsulfone and 10 g of a surfactant Demol N manufactured by Kao Corporation were mixed with 220 ml of distilled water. The mixed solution was dispersed by a sand mill (¼ Gallon Sand Grinder Mill, manufactured by I.mecs) using beads to obtain a solid microparticle dispersion solution (a) of a base precursor compound which particle had an average particle diameter of 0.2 μm.

(Preparation of a Dispersion Solution of Dye Solid Microparticles)

9.6 g of a cyanine dye compound-1 and 5.8 g of sodium p-dodecylbenzenesulfonate were mixed with 305 ml of distilled water. The mixed solution was dispersed by a sand mill (¼ Gallon Sand Grinder Mill, manufactured by I.mecs) using beads to obtain a solid microparticle dispersion solution of dye solid microparticles which particle had an average particle diameter of 0.2 μm.

(Preparation of an Antihalation Layer Coating Solution)

17 g of a gelatin, 9.6 g of polyacrylamide, 56 g of the foregoing solid microparticle dispersion solution (a) of a base precursor, 50 g of the foregoing dye solid microparticle dispersion solution, 1.5 g of a monodispersing polymethylmethacrylate microparticle (average particle size: 8 μm, standard deviation of particle diameter: 0.4), 0.03 g of benzoisothiazolinone, 2.2 g of sodium polyethylenesulfonate, 0.1 g of a blue dye compound-1, 0.1 g of a yellow dye compound-1 and 844 ml of water were mixed with each other to prepare an antihalation layer coating solution.

(Preparation of a Backside Protective Layer Coating Solution)

In a container kept at 40° C., 50 g of a gelatin, 0.2 g of sodium polystyrenesulfonate, 2.4 g of N,N-ethylenebis(vinylsulfonacetamide), 1 g of sodium t-octylphenoxyethoxyethanesulfonate, 30 mg of benzoisothiazolinone, 37 mg of a fluorine type surfactant (F-1: N-perfluorooctylsulfonyl-N-propylalanine potassium salt), 150 mg of a fluorine type surfactant (F-2: polyethylene glycol mono(N-perfluorooctylsulfonyl -N-propyl-2-aminoethyl) ether (degree of average polymerization of ethylene oxide: 15)), 64 mg of a fluorine type surfactant (F-3), 32 mg of a fluorine type surfactant (F-4), 8.8 g of an acrylic acid/ethylacrylate copolymer (copolymerization ratio by weight: 5/95), 0.6 g of Aerosol OT (manufactured by American Syanamido), 1.8 g of a liquid paraffin emulsion as a liquid paraffin and 950 ml of water were mixed with each other to prepare a backside protective layer coating solution.

(Preparation of the Silver Halide Emulsion)

<<Preparation of a Silver Halide Emulsion 1>>

3.1 ml of a 1 mass % potassium bromide solution was added to 1421 ml of distilled water, to which 3.5 ml of sulfuric acid having a concentration of 0.5 mol/L and 31.7 g of gelatin phthalate were added. While the resulting solution was kept at a liquid temperature of 30° C. under stirring in a stainless reaction pot, 95.4 ml of a solution A prepared by diluting 22.22 g of silver nitrate with distilled water and 97.4 ml of a solution B prepared by diluting 15.3 g of potassium bromide and 0.8 g of potassium iodide with distilled water were all added to the solution at a constant rate over 45 seconds. Then, 10 ml of an aqueous 3.5 mass % hydrogen peroxide solution was added and further 10.8 ml of an aqueous 10 mass % benzimidazole solution was added to the solution. Moreover, to the resulting solution were added 317.5 ml of a solution C prepared by diluting 51.86 g of silver nitrate with distilled water and 400 ml of a solution D prepared by diluting 44.2 g of potassium bromide and 2.2 g of potassium iodide with distilled water, wherein the solution C was all added at a constant rate over 20 minutes and the solution D was added by a control double jet method with keeping a pAg of 8.1. Potassium hexachloroiridate (III) was all added in an amount of 1×10⁻⁴ mol per 1 mol of silver 10 minutes after the solutions C and D were added. Also, an aqueous potassium hexacyanide iron (II) solution was all added in an amount of 3×10⁻⁴ mol per 1 mol of silver five seconds after the addition of the solution C was finished. Thereafter, the resulting solution was adjusted to pH 3.8 by using sulfuric acid having a concentration of 0.5 mol/L. Then, the stirring was stopped and precipitation/desalting/water-washing steps were carried out. The washed solution was adjusted to pH 5.9 by using sodium hydroxide having a concentration of 1 mol/L to produce a silver halide dispersion having a pAg of 8.0.

While the above silver halide dispersion was kept at 38° C. under stirring, 5 ml of a methanol solution containing 0.34 mass % of 1,2-benzoisothiazolin-3-one was added to the dispersion. After 40 minutes, a methanol solution containing a spectral sensitizing dye A and a spectral sensitizing dye B (1:1 ratio by mol) was added to the dispersion in an amount of 1.2×10⁻³ mol per 1 mol of silver as the total amount of the spectral sensitizing dyes A and B. Then, the dispersion was raised to 47° C. after one minute. Sodium benzenethiosulfonate was added in the form of a methanol solution in an amount of 7.6×10⁻⁵ mol per 1 mol of silver 20 minutes after the rise of temperature. Further, a tellurium sensitizer B was added in the form of a methanol solution in an amount of 2.9×10⁻⁴ mol per 1 mol of silver after 5 minutes and the dispersion was ripened for 91 minutes. 1.3 ml of a methanol solution containing 0.8 mass % of N,N′-dihydroxy-N″-diethylmelamine was added. After 4 minutes, 5-methyl-2-mercaptobenzimidazole was added in the form of a methanol solution in an amount of 4.8×10⁻³ mol per 1 mol of silver and 1-phenyl-2-heptyl-5-mercapto-1,3,4-triazole was added in the form of a methanol solution in an amount of 5.4×10⁻³ mol per 1 mol of silver to produce a silver halide emulsion 1.

The particle in the resulting silver halide emulsion was a silver bromoiodide particle containing 3.5 mol % of iodine uniformly and having the following characteristics: average sphere equivalent diameter: 0.042 μm and coefficient of variation in sphere equivalent diameter: 20%. The particle size and the like were found from the average of 1000 particles by using an electron microscope. The ratio of the {100} plane of this particle was found to be 80% by using the Kubelka-Munk method.

<<Preparation of a Silver Halide Emulsion 2>>

A silver halide emulsion 2 was prepared in the same manner as in the case of the silver halide emulsion 1 except that in the preparation of the silver halide emulsion 1, the liquid temperature when forming particles was altered to 47° C. from 30° C., the solution B was altered to one prepared in a volume of 97.4 ml by diluting 15.9 g of potassium bromide with distilled water, the solution D was altered to one prepared in a volume of 400 ml by diluting 45.8 g of potassium bromide with distilled water, the time required for adding the solution C was altered to 30 minutes and potassium hexacyano iron (II) was removed. Precipitation/desalting/water-washing/dispersing steps were carried out in the same manner as in the preparation of the silver halide emulsion 1. Further, spectral sensitization, chemical sensitization and the addition of 5-methyl-2-mercaptobenzimidazole and 1-phenyl-2-heptyl-5-mercapto-1,3,4-triazole were carried out in the same manner as in the preparation of the emulsion 1 except that the amount of the methanol solution containing the spectral sensitizing dye A and the spectral sensitizing dye B (1:1 ratio by mol) was altered to 7.5×10⁻⁴ mol per 1 mol of silver as the total amount of the spectral sensitizing dyes A and B, the amount of the tellurium sensitizer B was altered to 1.1×10⁻⁴ mol per 1 mol of silver and the amount of 1-phenyl-2-heptyl-5-mercapto-1,3,4-triazole was altered to 3.3×10⁻³ mol per 1 mol of silver, to obtain a silver halide emulsion 2. The emulsion particle of the silver halide emulsion 2 was a pure silver bromide cubic particle having the following characteristics: average sphere equivalent diameter: 0.080 μm and coefficient variation in sphere equivalent diameter: 20%.

<<Preparation of a Silver Halide Emulsion 3>>

A silver halide emulsion 3 was prepared in the same manner as in the case of the silver halide emulsion 1 except that in the preparation of the silver halide emulsion 1, the liquid temperature when forming particles was altered to 27° C. from 30° C. Precipitation/desalting/water-washing/dispersing steps were carried out in the same manner as in the preparation of the silver halide emulsion 1. Further, a silver halide emulsion 3 was obtained in the same manner as in the preparation of the silver halide emulsion 1 except that the amount of the spectral sensitizing dye A and the spectral sensitizing dye B (1:1 ratio by mol) as a solid dispersion (aqueous gelatin solution) was altered to 6×10⁻³ mol per 1 mol of silver as the total amount of the spectral sensitizing dyes A and B and the amount of the tellurium sensitizer B was altered to 5.2×10⁻⁴ mol per 1 mol of silver. The emulsion particle of the silver halide emulsion 3 was a silver bromoiodide containing 3.5 mol % of iodine uniformly and having the following characteristics: average sphere equivalent diameter: 0.034 μm and coefficient variation in sphere equivalent diameter: 20%.

<<Preparation of a Mixed Emulsion A for a Coating Solution>>

70 mass % of the silver halide emulsion 1, 15 mass % of the silver halide emulsion 2 and 15 mass % of the silver halide emulsion 3 were dissolved. Benzothiazolium iodide was added in the form of an aqueous 1 mass % solution to the mixture in an amount of 7×10⁻³ mol per 1 mol of silver. Further, water was added such that the content of silver halide per 1 kg of a mixed emulsion for a coating solution was 38.2 g as silver.

(Preparation of an Organic Silver Salt Dispersion)

87.6 kg of behenic acid (trademark: Edenor C22-85R, manufactured by Henkel), 423 L of distilled water, 49.2 L of an aqueous 5 mol/L NaOH solution and 120 L of t-butyl alcohol were mixed with each other and the mixture was reacted at 75° C. under stirring for one hour to obtain a sodium behenate solution. Separately, 206.2 L (pH 4.0) of an aqueous solution containing 40.4 kg of silver nitrate was prepared and kept at 10° C. A reaction container charged with 635 L of distilled water and 30 L of t-butyl alcohol was kept at 30° C. To this mixture were added all amount of the foregoing sodium behenate solution and all amount of the foregoing aqueous silver nitrate solution at constant rates over 93 minutes and 15 seconds and 90 minutes respectively, wherein only the aqueous silver nitrate solution was added for 11 minutes after the addition thereof was started, then the addition of the sodium behenate solution was started and only the sodium behenate solution was added for 14 minutes 15 seconds after the addition of the aqueous silver nitrate solution was finished. At this time, the temperature in the reaction container was set to 30° C. and the liquid temperature was made constant by external temperature control. Also, a pipe in a system for adding the sodium behenate solution was thermally insulated by circulating hot water through the outer side of a double tube to control such that the liquid temperature at the outlet of the distal end of an addition nozzle was 75° C. Also, a pipe in a system for adding the aqueous silver nitrate solution was thermally insulated by circulating cool water through the outer side of a double tube. The position where the sodium behenate solution was added and the position where the aqueous silver nitrate solution was added were arranged so as to be symmetric with respect to the axis of the stirrer and also adjusted to such an altitude that these positions are not contact with the reaction solution.

After the addition of the sodium behenate solution was finished, the reaction solution was stirred at the same temperature for 20 minutes and allowed to stand. Then, the temperature of the solution was raised to 35° C. over 30 minutes and then ripened for 210 minutes. The solid was removed by centrifugal filtration immediately after the ripening was finished. The resulting solid was washed with water until the conductivity of the filtered water became 30 μS/cm. An organic silver salt was thus obtained. The resulting solid was not dried and stored as a wet cake.

The structure of the resulting silver behenate was evaluated to find that the particle was a scale crystal having the following characteristics: a=0.14 μm, b=0.4 μm, c=0.6 μm in average, average aspect ratio: 5.2, average sphere equivalent diameter: 0.52 μm and coefficient of variation in sphere equivalent diameter: 15%. (a, b and c were those defined in this specification.)

19.3 kg of polyvinyl alcohol (trademark: PVA-217) and water were added to the wet cake equivalent to a dry solid weighing 260 kg such that the total weight was 1000 kg. Thereafter, the mixture was made into a slurry by using a dissolver blade and further the slurry was predispersed using a pipeline mixer (PM-10 model, manufactured by Mizuho Kogyo).

Next, the predispersed raw solution was treated three times by a dispersing machine (trademark: Microfluidizer M-610, manufactured by Microfluidex International Corporation, using a Z-type interaction chamber) which was adjusted to a pressure of 1260 kg/cm², to obtain a silver behenate dispersion. The cooling operation was carried out in the following manner: a corrugated tube type heat exchanger was attached to each of the front and rear of the interaction chamber to regulate the temperature of a cooling medium thereby setting the dispersion temperature to 18° C.

(Preparation of the Reducing Agent Dispersion)

<<Preparation of a Reducing Agent Complex-1 Dispersion>>

10 kg of water was added to 10 kg of a reducing agent complex-1 (complex of 6,6′-di-t-butyl-4,4′-dimethyl-2,2′-butylidenediphenol and triphenylphosphine oxide (1:1)), 0.12 kg of triphenylphosphine oxide and 16 kg of an aqueous 10 mass % modified polyvinyl alcohol (Poval MP203, manufactured by Kuraray Co., Ltd.) solution and these components were thoroughly mixed to make a slurry. This slurry was fed by a diaphragm pump to a horizontal sand mill (UVM-2: manufactured by I.mecs) filled with zirconia beads having an average diameter of 0.5 mm and was dispersed in the horizontal sand mill for 4.5 hours. Thereafter, the dispersion was so adjusted that the concentration of the reducing agent became 22 mass % by adding 0.2 g of benzoisothiazolinone sodium salt and water, to obtain a reducing agent complex-1 dispersion. The reducing agent complex particle contained in the resulting reducing agent complex dispersion had a median diameter of 0.45 μm and a maximum particle diameter of 1.4 μm or less. The dispersion was then subjected to filtration using a filter made of polypropylene and having a pore diameter of 3.0 μm to remove foreign substances such as dust and the filtrate was stored.

<<Preparation of a Reducing Agent Complex-2 Dispersion>>

10 kg of water was added to 10 kg of a reducing agent complex-2 (6,6′-di-t-butyl-4,4′-dimethyl-2,2′-butylidenediphenol) and 16 kg of an aqueous 10 mass % modified polyvinyl alcohol (Poval MP203, manufactured by Kuraray Co., Ltd.) solution and these components were thoroughly mixed to make a slurry. This slurry was fed by a diaphragm pump to a horizontal sand mill (UVM-2: manufactured by I.mecs) filled with zirconia beads having an average diameter of 0.5 mm and was dispersed in the horizontal sand mill for 3.5 hours. Thereafter, the dispersion was so adjusted that the concentration of the reducing agent became 25 mass % by adding 0.2 g of benzoisothiazolinone sodium salt and water, to obtain a reducing agent-2 dispersion. The reducing agent particle contained in the resulting reducing agent dispersion had a median diameter of 0.40 μm and a maximum particle diameter of 1.5 μm or less. The dispersion was then subjected to filtration using a filter made of polypropylene and having a pore diameter of 3.0 μm to remove foreign substances such as dust and the filtrate was stored.

(Preparation of a Hydrogen-Bonding Compound-1 Dispersion)

10 kg of water was added to 10 kg of a hydrogen-bonding compound-1 (tri(4-t-butylphenyl)phosphine oxide) and 16 kg of an aqueous 10 mass % modified polyvinyl alcohol (Poval MP203, manufactured by Kuraray Co., Ltd.) solution and these components were thoroughly mixed to make a slurry. This slurry was fed by a diaphragm pump to a horizontal sand mill (UVM-2: manufactured by I.mecs) filled with zirconia beads having an average diameter of 0.5 mm and was dispersed in the horizontal sand mill for 3.5 hours. Thereafter, the dispersion was so adjusted that the concentration of the hydrogen-bonding compound became 25 mass % by adding 0.2 g of benzoisothiazolinone sodium salt and water, to obtain a hydrogen-bonding compound-1 dispersion. The hydrogen-bonding compound particle contained in the resulting hydrogen-bonding compound dispersion had a median diameter of 0.35 μm and a maximum particle diameter of 1.5 μm or less. The dispersion was then subjected to filtration using a filter made of polypropylene and having a pore diameter of 3.0 μm to remove foreign substances such as dust and the filtrate was stored.

(Preparation of the Developing Promoter Dispersion)

<<Preparation of a Developing Promoter-1 Dispersion>>

10 kg of water was added to 10 kg of a developing promoter-1 and 20 kg of an aqueous 10 mass % modified polyvinyl alcohol (Poval MP203, manufactured by Kuraray Co., Ltd.) solution and these components were thoroughly mixed to make a slurry. This slurry was fed by a diaphragm pump to a horizontal sand mill (UVM-2: manufactured by I.mecs) filled with zirconia beads having an average diameter of 0.5 mm and was dispersed in the horizontal sand mill for 3.5 hours. Thereafter, the dispersion was so adjusted that the concentration of the developing promoter became 20 mass % by adding 0.2 g of benzoisothiazolinone sodium salt and water, to obtain a developing promoter-1 dispersion. The developing promoter particle contained in the resulting developing promoter dispersion had a median diameter of 0.48 μm and a maximum particle diameter of 1.4 μm or less. The dispersion was then subjected to filtration using a filter made of polypropylene and having a pore diameter of 3.0 μm to remove foreign substances such as dust and the filtrate was stored.

<<Preparation of a Developing Promoter-2 Dispersion>>

The solid dispersion of the developing promoter-2 was dispersed in the same manner as in the case of the developing promoter-1 to obtain a 20 mass % dispersion solution.

<<Preparation of a Developing promoter-3 Dispersion>>

The solid dispersion of the developing promoter-3 was dispersed in the same manner as in the case of the developing promoter-1 to obtain a 20 mass % dispersion solution.

(Preparation of a Tinting Agent Dispersion)

The solid dispersion of a tinting agent-1 was dispersed in the same manner as in the case of the developing promoter-1 to obtain a 20 mass % dispersion solution.

(Preparation of a Polyhalogen Compound Dispersion)

The solid dispersion-1 of an organic polyhalogen compound (hereinafter referred to as “organic polyhalogen compound-1 dispersion”) prepared in Example 1 and the solid dispersion-24 of an organic polyhalogen compound (hereinafter referred to as “organic polyhalogen compound-24 dispersion”) prepared in Example 1 were used.

<<Preparation of a Phthalazine Compound-1 Solution>>

8 kg of modified polyvinyl alcohol MP203 manufactured by Kuraray Co., Ltd. was dissolved in 174.57 kg of water. Next, 3.15 kg of an aqueous 20 mass % sodium triisopropylnaphthalenesulfonate and 14.28 kg of an aqueous 70 mass % phthalazine compound-1 (6-isopropylphthalazine) were added to the mixture to prepare a 5 mass % phthalazine compound-1 solution.

(Preparation of a Mercapto Compound)

<<Preparation of an Aqueous Mercapto Compound-1 Solution>>

7 g of a mercapto compound-1 (1-(3-sulfophenyl)-5-mercaptotetrazole sodium salt) was dissolved in 993 g of water to prepare an aqueous 0.7 mass % mercapto compound-1 solution.

<<Preparation of an Aqueous Mercapto Compound-2 Solution>>

20 g of a mercapto compound-2 (1-(3-methylureido)-5-mercaptotetrazole sodium salt) was dissolved in 980 g of water to prepare an aqueous 2.0 mass % mercapto compound-2 solution.

<<Preparation of a Pigment-1 Dispersion>>

250 g of water was added to 64 g of C.I. Pigment Blue 60 and 6.4 g of Demol N manufactured by Kao Corporation and these components were thoroughly mixed to make a slurry. 800 g of zirconia beads having an average diameter of 0.5 mm was prepared and placed in a vessel together with the slurry and the slurry was dispersed using a dispersing machine (¼G Sand Grinder Mill: manufactured by I.mecs) for 25 hours to obtain a pigment-1 dispersion. The average particle diameter of the pigment particle contained in the resulting pigment dispersion was 0.21 μm.

<<Preparation of a SBR Latex Solution>>

A SBR latex having a Tg of 22° C. was prepared in the following manner.

Using ammonium persulfate as a polymerization initiator and an anionic surfactant as an emulsifier, 70.0 mass of styrene, 27.0 mass of butadiene and 3.0 mass of acrylic acid were emulsion-polymerized, followed by aging at 80° C. for 8 hours. Thereafter, the reaction product was cooled to 40° C. and adjusted to pH 7.0 by using aqueous ammonia. Further, Sandet BL manufactured by Sanyo Chemical Industries, Ltd. was added in an amount of 0.22%. Further, the reaction product was adjusted to pH 8.3 by adding an aqueous 5% sodium hydroxide solution and further to pH 8.4 by adding aqueous ammonia. The molar ratio of the Na+ion to NH₄+ion used at this time was 1:2.3. Moreover, to 1 kg of the solution was added 0.15 ml of an aqueous 7% benzoisothiazolinone sodium salt solution to prepare a SBR latex solution.

(SBR latex: -St(70.0)-Bu(27.0)-AA(3.0)-latex, Tg: 22° C.;

average particle diameter: 0.1 μm, concentration: 43 mass %, equilibrium moisture content at 25° C. and 60% RH: 0.6 mass %, ion conductivity: 4.2 mS/cm (the ion conductivity was measured using a Conductometer CM-30S manufactured by DKK-TOA Corporation and the raw latex solution (43 mass %) at 25° C.), pH: 8.4

A SBR latex differing in Tg may be prepared in the same manner by properly changing the ratio of styrene and butadiene.

<<Preparation of an Emulsion Layer Photosensitive Layer) Coating Solution-1>>

1000 g of the organic silver salt dispersion obtained above, 276 ml of water, 33.2 g of the pigment-1 dispersion, 21 g of the organic polyhalogen compound-24 dispersion, 58 g of the organic polyhalogen compound-1 dispersion, 173 g of the phthalazine compound-1 solution, 1082 g of the SBR latex (Tg: 22° C.) solution, 299 g of the reducing agent complex-1 dispersion, 6 g of the developing promoter-1 dispersion, 9 ml of the aqueous mercapto compound-1 solution and 27 ml of the aqueous mercapto compound-2 solution were added in this order and then 117 g of the silver halide mixed emulsion A was added just before application. These components were thoroughly mixed to prepare an emulsion layer coating solution, which was fed to a coating die as it was and applied.

The viscosity of the above emulsion layer coating solution was measured using a B-type viscometer manufactured by Tokyo Keiki K. K., to find that it was 25 [mPa·s] at 40° C. (No. 1 rotor, 60 rpm).

The viscosity of the coating solution when measured using a RFS Fluid Spectrometer manufactured by Leometrix Far-East) was 230, 60, 46, 24 and 18 [mPa·s] at shear rates of 0.1, 1, 10, 100 and 1000 [1/sec. ] respectively.

The amount of zirconium in the coating solution was 0.38 mg per 1 g of silver.

<<Preparation of an Emulsion Layer (Photosensitive Layer) Coating Solution-2>>

1000 g of the organic silver salt dispersion obtained above, 276 ml of water, 32.8 g of the pigment-1 dispersion, 21 g of the organic polyhalogen compound-24 dispersion, 58 g of the organic polyhalogen compound-1 dispersion, 173 g of the phthalazine compound-1 solution, 1082 g of the SBR latex (Tg: 20° C.) solution, 155 g of the reducing agent-2 dispersion, 55 g of the hydrogen-bonding compound-1 dispersion, 6 g of the developing promoter-1 dispersion, 2 g of the developing promoter-2 dispersion, 3 g of the developing promoter-3 dispersion, 2 g of the tinting agent-1 dispersion and 6 ml of the aqueous mercapto compound-2 solution were added in this order and then 117 g of the silver halide mixed emulsion A was added just before application. These components were thoroughly mixed to prepare an emulsion layer coating solution, which was fed to a coating die as it was and applied.

The viscosity of the above emulsion layer coating solution was measured using a B-type viscometer manufactured by Tokyo Keiki, to find that it was 40 [mPa·s] at 40° C. (No. 1 rotor, 60 rpm).

The viscosity of the coating solution when measured using a RFS Fluid Spectrometer manufactured by Leometrix Far-East) was 530, 144, 96, 51 and 28 [mPa·s] at shear rates of 0.1, 1, 10, 100 and 1000 [1/sec.] respectively.

The amount of zirconium in the coating solution was 0.25 mg per 1 g of silver.

<<Preparation of an Emulsion Surface Intermediate Layer Coating Solution>>

To 1000 g of polyvinyl alcohol PVA-205 (manufactured by Kuraray Co., Ltd.), 272 g of a 5 mass % pigment dispersion and 4200 ml of a 19 mass % solution of a methylmethacrylate/styrene/butylacrylate/hydroxyethylmethacrylate/acrylic acid copolymer (copolymerization ratio by weight: 64/9/20/5/2) were added 27 ml of an aqueous 5 mass % Aerosol OT (American Syanamido) solution, 135 ml of an aqueous 20 mass % diammonium phthalate solution and water in such an amount that the total amount became 10000 g. The mixture was adjusted to pH 7.5 by addition of NaOH to prepare an intermediate layer coating solution, which was fed to a coating die at such a rate that the coating amount was 9.1 ml/m².

The viscosity of the coating solution was 58 [mPa·s] at 40° C. (No. 1 rotor, 60 rpm) when measured using a B-type viscometer.

<<Preparation of an Emulsion Surface Protective Layer First Layer Coating Solution>>

64 g of an inert gelatin was dissolved in water, to which were added 80 g of a 27.5 mass % solution of a methylmethacrylate/styrene/butylacrylate/hydroxyethylmethacrylate/acrylic acid copolymer (copolymerization ratio by weight: 64/9/20/5/2) latex, 23 ml of a methanol solution containing 10 mass % of 4-methylphthalic acid, 23 ml of an aqueous 10 mass % solution of phthalic acid, 28 ml of sulfuric acid having a concentration of 0.5 mol/L, 5 ml of an aqueous 5 mass % solution of Aerosol OT (manufactured by American Syanamido), 0.5 g of phenoxy ethanol, 0.1 g of benzoisothiazolinone and water in such an amount that the total amount became 750 g to prepare a coating solution. The coating solution mixed with 26 ml of 4 mass % chrome arum by using a static mixer just before application was fed to a coating die at such a rate that the coating amount was 18.6 ml/m².

The viscosity of the coating solution was 20 [mPa·s] at 40° C. (No. 1 rotor, 60 rpm) when measured using a B-type viscometer.

<<Preparation of an Emulsion Surface Protective Layer Second Layer Coating Solution>>

80 g of an inert gelatin was dissolved in water, to which were added 102 g of a 27.5 mass % solution of a methylmethacrylate/styrene/butylacrylate/hydroxyethylmethacrylate/acrylic acid copolymer (copolymerization ratio by weight: 64/9/20/5/2) latex, 3.2 ml of a 5 mass % solution of a fluorine type surfactant (F-1: N-perfluorooctylsulfonyl-N-propylalanine potassium salt), 32 ml of an aqueous 2 mass % solution of a fluorine type surfactant (F-2: polyethylene glycol mono(N-perfluorooctylsulfonyl-N-propyl-2-aminoethyl) ether [degree of average polymerization of ethylene oxide=15]), 23 ml of an aqueous 5 mass % solution of Aerosol OT (manufactured by American Syanamido), 4 g of a polymethylmethacrylate microparticle (average particle diameter: 0.7 μm), 21 g of a polymethylmethacrylate microparticle (average particle diameter: 4.5 μm), 1.6 g of 4-methylphthalic acid, 4.8 g of phthalic acid, 44 ml of sulfuric acid having a concentration of 0.5 mol/L, 10 mg of benzoisothiazolinone and water in such an amount that the total amount became 650 g. Then, 445 ml of an aqueous solution containing 4 mass % chrome arum and 0.67 mass % of phthalic acid was mixed with the mixture by using a static mixer just before application to prepare a surface protective layer coating solution, which was fed to a coating die at such a rate that the coating amount was 8.3 ml/m².

The viscosity of the coating solution was 19 [mPa·s] at 40° C. (No. 1 rotor, 60 rpm) when measured using a B-type viscometer.

<<Preparation of a Photothermographic Material-A>>

The antihalation layer coating solution and the backside protective layer coating solution were applied by simultaneously multilayer application on the backside of the above undercoated support such that the amount of the solid of the solid microparticle dye of the antihalation layer coating solution was 0.04 g/m² and the amount of the gelatin of the backside protective layer coating solution was 1.7 g/m², followed by drying to form a back layer.

On the side opposite to the backside, an emulsion layer, intermediate layer, protective layer first layer and protective layer second layer were formed in this order from an undercoat surface by simultaneous multilayer application in a slide beads coating system to manufacture a sample of a photothermographic material. At this time, the emulsion layer and the intermediate layer were controlled at 31° C., the protective layer first layer was controlled at 36° C. and the protective layer first layer was controlled at 37° C.

The amount (g/m²) of each compound of the emulsion layer to be applied was as follows.

| | |
|---|---|
| Silver behenate | 5.55 |
| Pigment (C.I. Pigment Blue 60) | 0.036 |
| Organic polyhalogen compound dispersion-24 | 0.12 |
| Organic polyhalogen compound dispersion-1 | 0.37 |
| Phthalazine compound-1 | 0.19 |
| SBR latex | 9.97 |
| Reducing agent complex-1 | 1.41 |
| Developing promoter-1 | 0.024 |
| Mercapto compound-1 | 0.002 |
| Mercapto compound-2 | 0.012 |
| Silver halide (as Ag) | 0.091 |

The coating and drying conditions are as follows.

The coating was carried out at a speed of 160 m/min, the gap between the distal end of the coating die and the support was set to 0.10 to 0.30 mm and the pressure in the vacuum chamber was set to a pressure lower than the atmospheric pressure by 196 to 882 Pa. The support was deelectrified by an ionic wind before coating.

In succession, the coating solution was cooled by a wind having a dry bulb temperature of 10 to 20° C. in a chilling zone. Then, the support was carried by a non-contact system and the coating film was dried using a dry air having a dry bulb temperature of 23 to 45° C. and a wet bulb temperature of 15 to 21° C. in a helical non-contact type drier.

After dried, the support was humidified at 25° C. under a humidity of 40 to 60% RH and then, the film surface was heated to 70 to 90° C. After heated, the film surface was cooled down to 25° C.

The degree of matting of the produced photothermographic material was 550 seconds in terms of Beck smoothness on the side of the photosensitive layer and 130 seconds on the backside. Also, the pH of the film surface on the side of the photosensitive layer was measured to find that it was 6.0.

<<Preparation of a Photothermographic Material-B>>

A photothermographic material-B was produced in the same manner as in the case of the photothermographic material-A except that in the photothermographic material-A, the emulsion layer coating solution-1 was changed to the emulsion layer coating solution-2, the yellow dye compound-1 was excluded from the antihalation layer and the fluorine type surfactants contained in the backside protective layer and the emulsion surface protective layer were altered to F-5, F-6, F-7 and F-8 from F-1, F-2, F-3 and F-4.

The amount (g/m²) of each compound of the emulsion layer to be applied was as follows.

| | |
|---|---|
| Silver behenate | 5.55 |
| Pigment (C.I. Pigment Blue 60) | 0.036 |
| Organic polyhalogen compound dispersion-24 | 0.12 |
| Organic polyhalogen compound dispersion-1 | 0.37 |
| Phthalazine compound-1 | 0.19 |
| SBR latex | 9.67 |
| Reducing agent-2 | 0.81 |
| Hydrogen-bondable compound-1 | 0.30 |
| Developing promoter-1 | 0.024 |
| Developing promoter-2 | 0.010 |
| Developing promoter-3 | 0.015 |
| Tinting agent-1 | 0.010 |
| Mercapto compound-2 | 0.002 |
| Silver halide (as Ag) | 0.091 |

<<Preparation of a Photothermographic Materials-C-1 to C-24>>

Photothermographic materials-C-1 to C-24 were produced in the same manner as in the case of the photothermographic material-A except that in the photothermographic material-A, the solid dispersion-1 of the organic polyhalogen compound of the emulsion layer coating solution-1 was altered to solid dispersions of an organic polyhalogen compound which dispersions were sampled from the bottom of a storing container after the solid dispersion-1 was stored and aged in the storing condition (4) (ambient temperature, three months) shown in Table I in Example 1.

<<Preparation of Photothermographic Materials-D-1 to D-24>>

Photothermographic materials-D-1 to D-24 were produced in the same manner as in the case of the photothermographic material-B except that in the photothermographic material-B, the solid dispersion-1 of the organic polyhalogen compound of the emulsion layer coating solution-1 was altered to solid dispersions (the under portion in the storing container was used) of an organic polyhalogen compound which dispersions were stored and aged in the storing condition (3) (ambient temperature, one month) shown in Table 1 in Example 1.

Each chemical structure of compounds used in the examples in the invention will be explained. 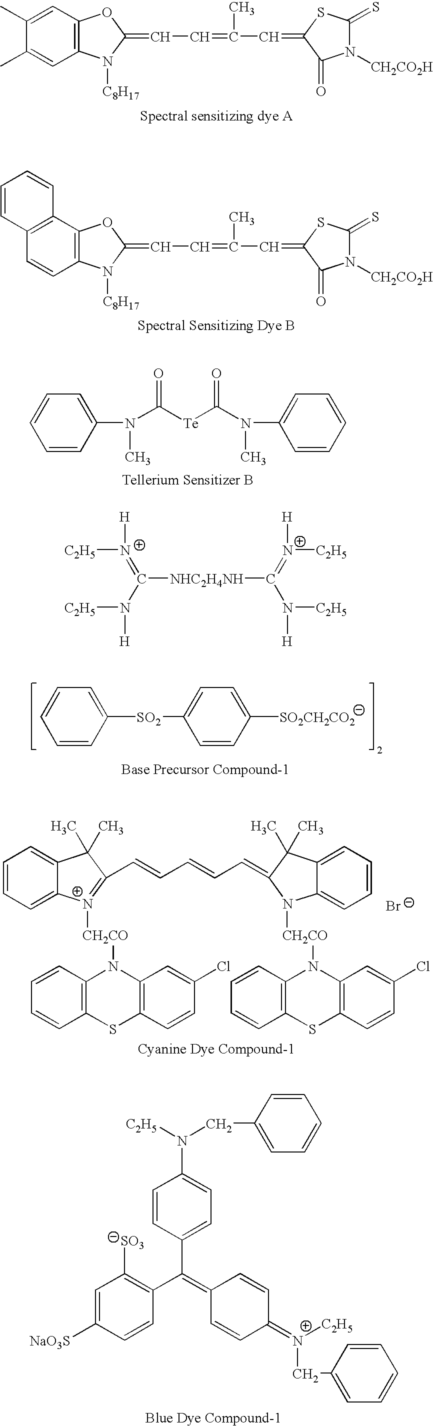 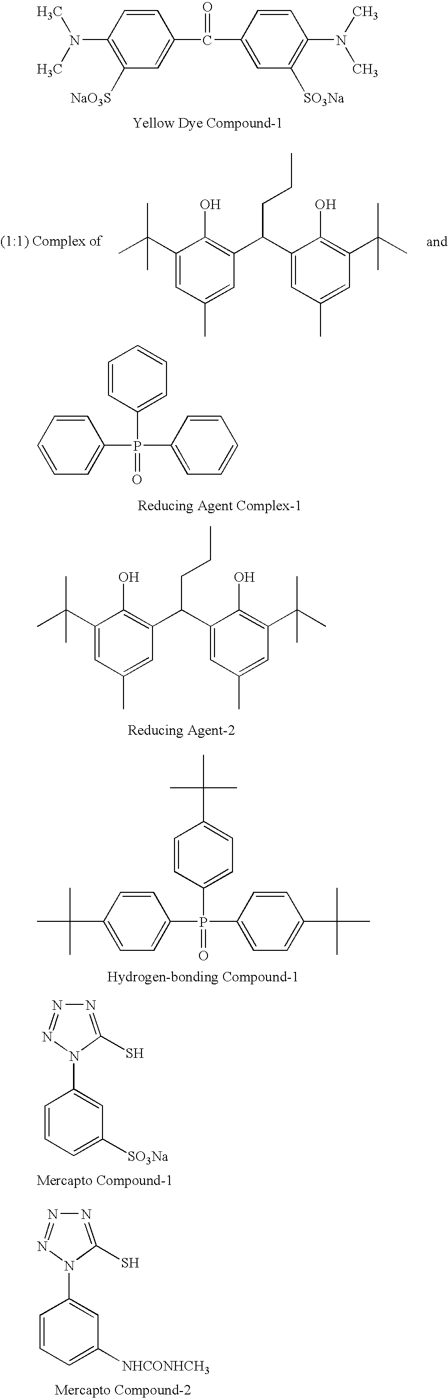 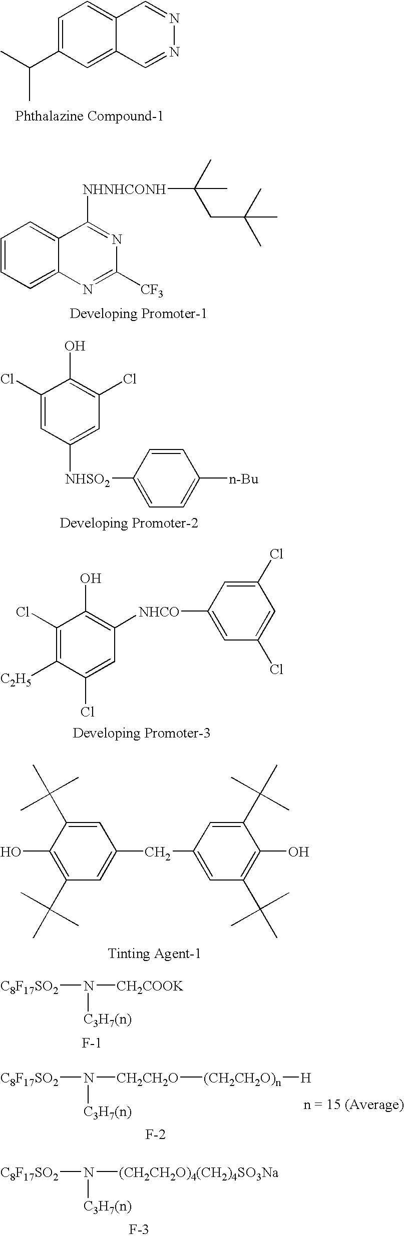 C₈F₁₇SO₃K F-4

CF₃—(CF₂)ₙ—CH₂CH₂SCH₂CH₂CO₂Li F-5

Mixture (n=5 to 11)

CF₃—(CF₂)ₙ—CH₂CH₂O—(CH₂CH₂O)ₘ—H F-6

Mixture (n=5 to 11, m=5 to 15)

CF₃—(CF₂)ₙ—CH₂CH₂SO₃Na F-7

Mixture (n=5 to 11)

C₆F₁₃CH₂CH₂SO₃Li

(Evaluation of Photographic Performance)

Each resulting sample was cut down to a half-cut size, packaged with the following packaging material under an atmosphere of 25° C. and 50% RH and stored at ambient temperature for 2 weeks. Then, the sample was evaluated as follows. The results are shown in Table 3 and Table 4.

(Packaging Material)

PET 10 μm/PE 12 μm/aluminum foil 9 μm/Ny 15 μm/polyethylene 50 μcontaining 3% carbon

Oxygen permeability: 0 ml/atm·m²·25° C.·day and moisture permeability: 0 g/atm·m²·25° C.·day

The sample was exposed and heat-developed (using 4 panel heaters set to 112° C.-119° C.-121° C.-121° C. for 24 seconds in total in the case of the photothermographic material-A and the photothermographic materials-C-1 to C-24 and for 14 seconds in total in the case of the photothermographic material-B and the photothermographic materials-D-1 to D-24) in a Fuji Medical Dry Laser Imager FM-DP L (a 660 nm semiconductor having a maximum output of 60 mW (IIIB) was mounted). The evaluation of the resulting image was made using a densitometer.

<Sensitivity>

The sensitivity of the photothermographic material-C-1 was defined as 100 in Table 3 and the sensitivity of the photothermographic material-D-1 was defined as 100 in Table 4 to show the relative sensitivities of each sample. Relative sensitivities of 98 to 102 were judged to fall in an allowable range.

<Density>

The maximum density of the photothermographic material-C-1 was defined as 100 in Table 3 and the maximum density of the photothermographic material-D-1 was defined as 100 in Table 4 to show the relative densities of each sample. Relative densities of 98 to 102 were judged to be within an allowable range.

<Surface condition>

The photosensitive material with the above coated material exposed to light was heat-developed (at about 120° C.) and streaks which occurred on the resulting solid image were evaluated visually according to the following standard.

◯: Almost no coating streak (two streaks or less) is observed and there is no practical problem.

Δ: The number of coating streaks is two or more and within 5 and some practical problems will arise.

X: The number of coating streaks is 5 or more and practical problems surely arise.

In the above standard, ◯ was judged to be within an allowable range.

TABLE 3

| Photothermographic | Solid | | | Surface | |
|---|---|---|---|---|---|
| Material No. | Dispersion | Sensitivity | Density | Condition | Remarks |
| C-1 | 1 | 100 | 100 | ◯ | Invention |
| C-2 | 2 | 99 | 99 | ◯ | Invention |
| C-3 | 3 | 100 | 100 | ◯ | Invention |
| C-4 | 4 | 101 | 101 | ◯ | Invention |
| | | | | | Comparative |
| C-5 | 5 | 95 | 96 | Δ | Example |
| | | | | | Comparative |
| C-6 | 6 | 96 | 96 | Δ | Example |
| C- 7 | 7 | 95 | 94 | X | Comparative |
| | | | | | Example |
| C- 8 | 8 | 93 | 96 | X | Comparative |
| | | | | | Example |
| C- 9 | 9 | 101 | 100 | ◯ | Invention |
| C-10 | 10 | 100 | 100 | ◯ | Invention |
| C-11 | 11 | 92 | 90 | ◯ | Comparative |
| | | | | | Example |
| C-12 | 12 | 99 | 100 | ◯ | Invention |
| C-13 | 13 | 100 | 100 | ◯ | Invention |
| C-14 | 14 | 100 | 100 | ◯ | Invention |
| C-15 | 15 | 99 | 99 | ◯ | Invention |
| C-16 | 16 | 100 | 100 | ◯ | Invention |
| C-17 | 17 | 99 | 99 | ◯ | Invention |
| C-18 | 18 | 100 | 100 | ◯ | Invention |
| C-19 | 19 | 101 | 100 | ◯ | Invention |
| C-20 | 20 | 100 | 100 | ◯ | Invention |
| C-21 | 21 | 100 | 100 | ◯ | Invention |
| C-22 | 22 | 100 | 101 | ◯ | Invention |
| C-23 | 23 | 99 | 100 | ◯ | Invention |
| C-24 | 24 | 99 | 98 | ◯ | Invention |

TABLE 4

| Photothermographic | Solid | | | Surface | |
|---|---|---|---|---|---|
| Material No. | Dispersion | Sensitivity | Density | Condition | Remarks |
| D-1 | 1 | 100 | 100 | ◯ | Invention |
| D-2 | 2 | 99 | 99 | ◯ | Invention |
| D-3 | 3 | 100 | 101 | ◯ | Invention |
| D-4 | 4 | 100 | 100 | ◯ | Invention |
| D-5 | 5 | 96 | 97 | Δ | Comparative |
| | | | | | Example |
| D-6 | 6 | 95 | 95 | Δ | Comparative |
| | | | | | Example |
| D-7 | 7 | 93 | 92 | X | Comparative |
| | | | | | Example |
| D-8 | 8 | 91 | 95 | X | Comparative |
| | | | | | Example |
| D-9 | 9 | 101 | 100 | ◯ | Invention |
| D-10 | 10 | 100 | 101 | ◯ | Invention |
| D-11 | 11 | 92 | 90 | ◯ | Comparative |
| | | | | | Example |
| D-12 | 12 | 99 | 100 | ◯ | Invention |
| D-13 | 13 | 100 | 100 | ◯ | Invention |
| D-14 | 14 | 99 | 101 | ◯ | Invention |
| D-15 | 15 | 100 | 99 | ◯ | Invention |
| D-16 | 16 | 100 | 100 | ◯ | Invention |
| D-17 | 17 | 99 | 100 | ◯ | Invention |
| D-18 | 18 | 100 | 99 | ◯ | Invention |
| D-19 | 19 | 101 | 100 | ◯ | Invention |
| D-20 | 20 | 100 | 99 | ◯ | Invention |
| D-21 | 21 | 99 | 100 | ◯ | Invention |
| D-22 | 22 | 100 | 101 | ◯ | Invention |
| D-23 | 23 | 99 | 100 | ◯ | Invention |
| D-24 | 24 | 99 | 98 | ◯ | Invention |

As shown in Table 3 and Table 4, it was understood that even in the case where a photothermographic material was produced using a solid dispersion of a polyhalogen compound having the characteristics that the average settling velocity (v₂₆) of the dispersoid at 26° C. was 5.0×10⁻⁶ mm/sec or less and the average settling velocity (v₁₀) of the dispersoid at 10° C. was 2.5×10⁻⁶ mm/sec or less after the solid dispersion was aged, a photothermographic material could be obtained which was reduced in each dispersion of photographic sensitivity and variation of density and free from a deterioration in surface condition.

### Example 3

Solid Dispersions of Compounds other than a Polyhalogen Compound

<<Preparation of Dispersions of Reducing Agent Compounds-101 to 110>>

Reducing agent solid dispersions 101 to 110 were produced in the same manner as in the case of the reducing agent-2 dispersion except that in Example 2, the reducing agent compounds shown in Table 5 were used in place of the reducing agent-2 of the reducing agent-2 dispersion, the dispersion time was changed as shown in Table 5 to thereby change the median diameter, the type and concentration of the reducing agent compound or dispersant were changed to thereby change the viscosity of the dispersant and the type of reducing agent compound was changed to thereby change the specific gravity of the dispersoid.

The details (average settling velocitys (e.g., v₂₆ and v₁₀)) of the solid dispersion the reducing agent obtained in this manner are shown in Table 5 and Table 6.

TABLE 5

| | | | Concentration | | Amount of | | | | | |
|---|---|---|---|---|---|---|---|---|---|---|
| | | | of The | | The Dispersant | | Specific | | | |
| Solid | Dispersing | | Reducing | | To Be Used (%) | Median | Gravity of | Viscosity | Viscosity | |
| Dispersion | Time | Exemplified | Agent | Type of | To The Reducing | Diameter | The | (η₁₀) | (η₂₅) | |
| No. | (Hours) | Compound | Compound | Dispersant | Agent | (μm) | Dispersoid | (Pa · S) | (Pa · S) | Remarks |
| 101 | 5 | R-1 | 25 | MP-203 | 25 | 0.6 | 1.127 | 0.080 | 0.165 | Invention |
| 102 | 2 | R-1 | 25 | MP-203 | 25 | 1.0 | 1.127 | 0.080 | 0.098 | Invention |
| 103 | 10 | R-1 | 25 | MP-203 | 25 | 0.4 | 1.127 | 0.080 | 0.102 | Invention |
| 104 | 20 | R-1 | 25 | MP-203 | 20 | 0.25 | 1.127 | 0.095 | 0.105 | Invention |
| | | | | | | | | | | Comparative |
| 105 | 10 | R-1 | 30 | MP-203 | 20 | 1.5 | 1.127 | 0.030 | 0.020 | Example |
| | | | | | | | | | | Comparative |
| 106 | 5 | R-1 | 30 | MP-203 | 10 | 0.75 | 1.127 | 0.015 | 0.008 | Example |
| 107 | 5 | R-3 | 25 | MP-203 | 20 | 0.5 | 1.132 | 0.100 | 0.050 | Invention |
| 108 | 5 | R-7 | 20 | MP-203 | 20 | 0.6 | 1.122 | 0.100 | 0.056 | Invention |
| 109 | 5 | R-11 | 30 | MP-203 | 20 | 0.54 | 1.118 | 0.115 | 0.060 | Invention |
| 110 | 5 | R-20 | 22 | MP-203 | 20 | 0.55 | 1.113 | 0.140 | 0.074 | Invention |

TABLE 6

| | | | Storage | Storage | Storage | Storage | |
|---|---|---|---|---|---|---|---|
| | | | Condition\mathring{1} | Condition\mathring{2} | Condition\mathring{3} | Condition\mathring{4} | |
| | Average | Average | | | Ambient | Ambient | |
| Solid | Settling | Settling | Refrigerated, | Refrigerated, | Temperature, | Temperature, | |
| Dispersion | velocity | velocity | One | Three | One | Three | |
| No. | (V₁₀) | (V₂₅) | Month | Temperature | Month | Month | Remarks |
| 101 | 3.11 × 10⁻⁷ | 1.51 × 10⁻⁷ | ◯ | ◯ | ◯ | ◯ | Invention |
| 102 | 8.64 × 10⁻⁷ | 7.06 × 10⁻⁷ | ◯ | ◯ | ◯ | Δ | Invention |
| 103 | 1.38 × 10⁻⁷ | 1.08 × 10⁻⁷ | ◯ | ◯ | ◯ | ◯ | Invention |
| 104 | 4.55 × 10⁻⁸ | 4.12 × 10⁻⁸ | ◯ | ◯ | ◯ | ◯ | Invention |
| | | | | | | | Comparative |
| 105 | 5.19 × 10⁻⁶ | 7.78 × 10⁻⁶ | ◯ | X | Δ | X | Example |
| 106 | 2.59 × 10⁻⁶ | 519 × 10⁻⁶ | Δ | X | X | X | Comparative |
| | | | | | | | Example |
| 107 | 1.80 × 10⁻⁷ | 3.59 × 10⁻⁷ | ◯ | ◯ | ◯ | ◯ | Invention |
| 108 | 2.39 × 10⁻⁷ | 4.27 × 10⁻⁷ | ◯ | ◯ | ◯ | ◯ | Invention |
| 109 | 1.63 × 10⁻⁷ | 3.12 × 10⁻⁷ | ◯ | ◯ | ◯ | ◯ | Invention |
| 110 | 1.33 × 10⁻⁷ | 2.51 × 10⁻⁷ | ◯ | ◯ | ◯ | ◯ | Invention |

As shown in Table 5 and Table 6, it was found that the solid dispersions of a reducing agent dispersion, the dispersoid of which had an average settling velocity (v₂₆) of 5.0×10⁻⁶ mm/sec or less at 26° C. and the solid dispersions of a reducing agent dispersion, the dispersoid of which had an average settling velocity (v₁₀) of 2.5×10⁻⁶ mm/sec or less at 10° C. were decreased in a variation in concentration in the storing container and had high stability.

<<Preparation of Dispersions of Hydrogen-Bonding Compounds-201 to 210>>

Hydrogen-bondable compound dispersions 201 to 210 were dispersed in the same manner as in the preparation of the hydrogen-bonding compound dispersion-1 except that the hydrogen-bonding compounds shown in Table 7 were used in place of the hydrogen-bonding compound-1 of Example 2 and as shown in Table 7, the median diameter was changed by changing the dispersing time, the viscosity of the dispersion was changed by changing the type and concentration of the hydrogen-bonding compound or dispersant and the specific gravity of the dispersoid was changed by changing the type of hydrogen-bonding compound.

The details (e.g., median diameter, viscosity (10° C. and 25° C.) of the solid dispersion, specific gravity of the dispersoid, and average settling velocity (10° C. and 25° C.) of the dispersoid) of the resulting solid dispersions of the hydrogen-bonding compounds are shown in Table 7 and Table 8.

TABLE 7

| | | | Concentration | | Amount of | | | | | |
|---|---|---|---|---|---|---|---|---|---|---|
| | | | of The | | The Dispersant | | | | | |
| | | | Hydrogen- | | (%) Based On | | Specific | | | |
| Solid | Dispersing | | Bonding | | The Hydrogen- | Median | Gravity of | Viscosity | Viscosity | |
| Dispersion | Time | Exemplified | Compound | Type of | Bonding | Diameter | The | (η₁₀) | (η₂₅ ) | |
| No. | (Hours) | Compound | (Mass %) | Dispersant | Compound | (μm) | Dispersoid | (Pa · S) | (Pa · S) | Remarks |
| 201 | 5 | D-1 | 20 | MP-203 | 20 | 0.4 | 1.348 | 0.150 | 0.080 | Invention |
| 202 | 3 | D-1 | 20 | MP-203 | 20 | 0.66 | 1.348 | 0.145 | 0.077 | Invention |
| 203 | 10 | D-1 | 20 | MP-203 | 20 | 0.32 | 1.348 | 0.165 | 0.078 | Invention |
| 204 | 2 | D-1 | 20 | MP-203 | 1.5 | 1.348 | 0.166 | 0.080 | Comparative | |
| | | | | | | | | | | Example |
| 205 | 5 | D-1 | 20 | MP-203 | 10 | 0.70 | 1.348 | 0.035 | 0.018 | Comparative |
| | | | | | | | | | | Example |
| 206 | 5 | D-2 | 20 | MP-203 | 25 | 0.7 | 1.34 | 0.189 | 0.092 | Invention |
| 207 | 5 | D-7 | 22 | MP-203 | 20 | 0.6 | 1.343 | 0.156 | 0.086 | Invention |
| 208 | 7 | D-9 | 22 | MP-203 | 20 | 0.42 | 1.285 | 0.180 | 0.097 | Invention |
| 209 | 5 | D-12 | 22 | MP-203 | 15 | 0.38 | 1.211 | 0.082 | 0.040 | Invention |
| 210 | 6 | D-20 | 22 | MP-203 | 15 | 0.36 | 1.125 | 0.086 | 0.041 | Invention |

TABLE 8

| | | | Storage | Storage | Storage | Storage | |
|---|---|---|---|---|---|---|---|
| | | | Condition\mathring{1} | Condition\mathring{2} | Condition\mathring{3} | Condition\mathring{4} | |
| | Average | Average | | | Ambient | Ambient | |
| Solid | Settling | Settling | Refrigerated, | Refrigerated, | Temperature | Temperature | |
| Dispersion | velocity | velocity | One | Three | One | Three | |
| No. | (V₁₀) | (V₂₅) | Month | Month | Month | Month | Remarks |
| 201 | 2.45 × 10^{31 7} | 4.59 × 10^{31 7} | ◯ | ◯ | ◯ | ◯ | Invention |
| 202 | 5.69 × 10^{31 7} | 1.07 × 10^{31 6} | ◯ | ◯ | ◯ | ◯ | Invention |
| 203 | 1.18 × 10^{31 7} | 2.49 × 10^{31 7} | ◯ | ◯ | ◯ | ◯ | Invention |
| 204 | 2.57 × 10^{31 6} | 5.33 × 10^{31 6} | ◯ | Δ | Δ | X | Comparative |
| | | | | | | | Example |
| 205 | 2.65 × 10^{31 6} | 5.16 × 10^{31 6} | ◯ | Δ | Δ | X | Comparative |
| | | | | | | | Example |
| 206 | 4.80 × 10^{31 7} | 9.86 × 10^{31 7} | ◯ | ◯ | ◯ | ◯ | Invention |
| 207 | 4.31 × 10^{31 7} | 7.82 × 10^{31 7} | ◯ | ◯ | ◯ | ◯ | Invention |
| 208 | 1.52 × 10^{31 7} | 2.82 × 10^{31 7} | ◯ | ◯ | ◯ | ◯ | Invention |
| 209 | 2.02 × 10^{31 7} | 4.15 × 10^{31 7} | ◯ | ◯ | ◯ | ◯ | Invention |
| 210 | 1.03 × 10^{31 7} | 2.15 × 10^{31 7} | ◯ | ◯ | ◯ | ◯ | Invention |

As shown in Table 7 and Table 8, it was found that the solid dispersions of a hydrogen-bonding compound, the dispersoid of which had an average settling velocity (v₂₆) of 5.0×10⁻⁶ mm/see or less at 26° C. and the solid dispersions of a hydrogen-bonding compound, the dispersoid of which had an average settling velocity (v₁₀) of 2.5×10⁻⁶ mm/sec or less at 10° C. were decreased in a variation in concentration in the storing container and had high stability. (Example 4) Preparation of a photothermographic material using a solid dispersion of a compound other than polyhalogen compounds

<<Preparation of Photothermographic Materials-E-1 to E-10>>

Photothermographic materials-E-1 to E-10 were produced in the same manner as in the case of the photothermographic material-B except that in the photothermographic material-B, the reducing agent compound dispersion of the emulsion layer coating solution-1 was altered to the reducing agent compound dispersions (the under portion in the storing container was used) stored and aged in the storing condition (3) shown in Table 5 and Table 6 in Example 3.

<<Preparation of Photothermographic Materials-F-1 to F-10>>

Photothermographic materials-F-1 to F-10 were produced in the same manner as in the case of the photothermographic material-B except that in the photothermographic material-B, the hydrogen-bonding compound dispersion of the emulsion layer coating solution-1 was altered to the hydrogen-bonding compound dispersions (the under portion in the storing container was used) stored and aged in the storing condition (3) shown in Table 7 and Table 8 in Example 3.

The evaluation of the photothermographic material was made in the same manner as in Example 2. The results are shown in Table 9 and Table 10.

TABLE 9

| Photothermographic | Solid | | | Surface | |
|---|---|---|---|---|---|
| Material No. | Dispersion | Sensitivity | Density | Condition | Remarks |
| E-1 | 101 | 100 | 100 | ◯ | Invention |
| E-2 | 102 | 100 | 100 | ◯ | Invention |
| E-3 | 103 | 100 | 100 | ◯ | Invention |
| E-4 | 104 | 100 | 100 | ◯ | Invention |
| E-5 | 105 | 110 | 108 | Δ | Comparative |
| | | | | | Example |
| E-6 | 106 | 112 | 110 | X | Comparative |
| | | | | | Example |
| E-7 | 107 | 100 | 100 | ◯ | Invention |
| E-8 | 108 | 100 | 100 | ◯ | Invention |
| E-9 | 109 | 101 | 101 | ◯ | Invention |
| F-10 | 110 | 100 | 100 | ◯ | Invention |

As shown in Table 9, it was understood that even in the case where a photothermographic material was produced using a solid dispersion of a reducing agent compound having the characteristics that the average settling velocity (v₂₆) of the dispersoid at 26° C. was 5.0×10⁻⁶ mm/sec or less and the average settling velocity (v₁₀) of the dispersoid at 10° C. was 2.5×10⁻⁶ mm/sec or less after the solid dispersion was aged, a photothermographic material could be obtained which had superb coating surface condition and was reduced in each dispersion of photographic sensitivity and variation of density.

TABLE 10

| Photothermographic | Solid | | | Surface | |
|---|---|---|---|---|---|
| Material No. | Dispersion | Sensitivity | Density | Condition | Remarks |
| F-1 | 201 | 100 | 100 | ◯ | Invention |
| F-2 | 202 | 100 | 100 | ◯ | Invention |
| F-3 | 203 | 100 | 100 | ◯ | Invention |
| F-4 | 204 | 90 | 97 | Δ | Comparative |
| | | | | | Example |
| F-5 | 205 | 96 | 95 | Δ | Comparative |
| | | | | | Example |
| F-6 | 206 | 100 | 100 | ◯ | Invention |
| F-7 | 207 | 100 | 100 | ◯ | Invention |
| F-8 | 208 | 100 | 100 | ◯ | Invention |
| F-9 | 209 | 101 | 101 | ◯ | Invention |
| F-10 | 210 | 100 | 100 | ◯ | Invention |

As shown in Table 10, it was understood that even in the case where a photothermographic material was produced using a solid dispersion of a hydrogen-bonding compound having the characteristics that the average settling velocity (v₂₆) of the dispersoid at 26° C. was 5.0×10⁻⁶ mm/sec or less and the average settling velocity (v₁₀) of the dispersoid at 10° C. was 2.5×10⁻⁶ mm/sec or less after the solid dispersion was aged, a photothermographic material could be obtained which had superb coating surface condition and was reduced in each dispersion of photographic sensitivity and variation of density.

The invention can provide a solid dispersion of a compound for use in photography which dispersion has high stability with time, a method of storing the solid dispersion and a photothermographic material which has a superb coating surface condition and is superior in photographic sensitivity and density.

What is claimed is:

1. A solid dispersion of a compound for use in photography, the dispersion comprising:
a dispersoid including an organic compound; and
a dispersion medium,
wherein the average settling velocity (v₂₅) of the dispersoid at 25° C., which velocity is represented by the following equation (1), is no more than 5.0×10⁻⁶ mm/sec:
v₂₅=2r²g(ρs₂₅−ρ₂₅)/9η₂₅ Equation (1)
wherein r represents the median diameter of the dispersoid, g represents the gravitational acceleration, ρs₂₅ represents the specific gravity of the dispersoid at 25° C., ρ₂₅ represents the specific gravity of the dispersion medium at 25° C. and η₂₅ represents the viscosity of the solid dispersion at 25° C.

2. A solid dispersion of a compound for use in photography according to claim 1, wherein the specific gravity (ρs25) of the dispersoid in equation (1) is at least 1.1.

3. A solid dispersion of a compound for use in photography according to claim 1, wherein the median diameter (r) in equation (1) is no more than 1.5 μm.

4. A solid dispersion of a compound for use in photography according to claim 1, wherein the specific gravity (ρ₂₅) of the dispersion medium is at least 0.8 and no more than 1.2 and the specific gravity (ρs₂₅) of the dispersoid is no less than the specific gravity (ρ₂₅) of the dispersion medium in equation (1).

5. A solid dispersion of a compound for use in photography according to claim 1, wherein the viscosity η₂₅ of the solid dispersion in equation (1) is at least 0.05 Pa·s.

6. A solid dispersion of a compound for use in photography according to claim 1, wherein the organic compound is a polyhalogen compound.

7. A method of storing a solid dispersion of a compound for use in photography, the method comprising:
storing the solid dispersion of a compound for use in photography at ambient temperature, wherein the dispersion comprises a dispersoid including an organic compound, and a dispersion medium, and the average settling velocity (v₂₅) of the dispersoid at 25° C., which velocity is represented by the following equation (1), is no more than 5.0×10⁻⁶ mm/sec:
v₂₅=2r²g(ρs₂₅−ρ₂₅)/9η₂₅ Equation (1)
wherein r represents the median diameter of the dispersoid, g represents the gravitational acceleration, ρs₂₅ represents the specific gravity of the dispersoid at 25° C., ρ₂₅ represents the specific gravity of the dispersion medium at 25° C. and η₂₅ represents the viscosity of the solid dispersion at 25° C.

8. A solid dispersion of a compound for use in photography, the dispersion comprising:
a dispersoid including an organic compound; and
a dispersion medium,
wherein the average settling velocity (v₁₀) of the dispersoid at 10° C., which velocity is represented by the following equation (2), is 2.5×10⁻⁶ mm/sec or less:
v₁₀=2r²g(ρs₁₀−ρ₁₀)/9η₁₀ Equation (2)
wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

9. A solid dispersion of a compound for use in photography according to claim 8, wherein the specific gravity (ρs₁₀) of the dispersoid in equation (2) is at least 1.1.

10. A solid dispersion of a compound for use in photography according to claim 8, wherein the median diameter (r) in equation (2) is no more than 1.5 μm.

11. A solid dispersion of a compound for use in photography according to claim 8, wherein the specific gravity (ρ₁₀) of the dispersion medium is at least 0.8 and no more than 1.2, and the specific gravity (ρs₁₀) of the dispersoid is no less than the specific gravity (ρ₁₀) of the dispersion medium in equation (2).

12. A solid dispersion of a compound for use in photography according to claim 8, wherein the viscosity η₁₀ of the solid dispersion in equation (2) is at least 0.1 Pa·s.

13. A solid dispersion of a compound for use in photography according to claim 8, wherein the organic compound is a polyhalogen compound.

14. A method of storing a solid dispersion of a compound for use in photography, the method comprising:
storing the solid dispersion of a compound for use in photography under a refrigerated condition, wherein the dispersion comprises a dispersoid including an organic compound and a dispersion medium, and the average settling velocity (v₁₀) of the dispersoid at 10° C., which velocity is represented by the following equation (2), is no more than 2.5×10⁻⁶ mm/sec:
v₁₀=2r²g(ρs₁₀−ρ₁₀)/9η₁₀ equation (1)
wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

15. A photothermographic material comprising:
a support; and
at least one layer disposed on the support and containing at least a photosensitive silver halide, a nonphotosensitive organic silver salt, a reducing agent for reducing a silver ion and a binder,
wherein at least one layer disposed on the support is formed by applying and drying a coating solution containing at least one solid dispersion of a compound for use in photography containing a dispersoid, which includes an organic compound, and a dispersion medium, and the average settling velocity (v₂₅) of the dispersoid at 25° C., which velocity is represented by the following equation (1), is no more than 5.0×10⁻⁶ mm/sec:
v₂₅=2r²g(ρs₂₅−ρ₂₅)/9η₂₅ Equation (1)
wherein r represents the median diameter of the dispersoid, g represents the gravitational acceleration, ρs₂₅ represents the specific gravity of the dispersoid at 25° C., ρ₂₅ represents the specific gravity of the dispersion medium at 25° C. and η₂₅ represents the viscosity of the solid dispersion at 25° C.

16. A photothermographic material according to claim 15, wherein the specific gravity (ρs₂₅) of the dispersoid in equation (1) is at least 1.1.

17. A photothermographic material according to claim 15, wherein the organic compound is a polyhalogen compound.

18. A photothermographic material according to claim 15, wherein the binder is a latex and the coating solution is an aqueous type coating solution.

19. A photothermographic material comprising:
a support,
and at least one layer disposed on the support and containing at least a photosensitive silver halide, a nonphotosensitive organic silver salt, a reducing agent for reducing a silver ion and a binder,
wherein at least one layer disposed on the support is formed by applying and drying a coating solution containing at least one solid dispersion of a compound for use in photography containing a dispersoid, which includes an organic compound, and a dispersion medium, and the average settling velocity (v₁₀) of the dispersoid at 10° C., which velocity is represented by the following equation (2), is no more than 2.5×10⁻⁶ mm/sec:
v₁₀=2r²g(ρs₁₀−ρ₁₀)/9η₁₀ Equation (2)
wherein r represents the median diameter of the dispersoid, g represents the gravitational acceleration, ρs₁₀ represents the specific gravity of the dispersoid at 10° C., ρ₁₀ represents the specific gravity of the dispersion medium at 10° C. and η₁₀ represents the viscosity of the solid dispersion at 10° C.

20. A photothermographic material according to claim 19, wherein the specific gravity (ρs₁₀) of the dispersoid in equation (2) is at least 1.1.

21. A photothermographic material according to claim 19, wherein the organic compound is a polyhalogen compound.

22. A photothermographic material according to claim 19, wherein the binder is a latex and the coating solution is a water-type coating solution.
